(19) United States
(12) Patent Application Publication
(10) Pub. No.: US 2010/0088939 A1
(43) Pub. Date: Apr. 15, 2010

(54) TAG AND METHOD FOR MANUFACTURING THE SAME

(75) Inventor: Yoshihiro Maniwa, Gunma (JP)

Correspondence Address: CHERNOFF, VILHAUER, MCCLUNG & STENZEL, LLP, 601 SW Second Avenue, Suite 1600, Portland, OR, 97204, US

(73) Assignee: MAX CO., LTD., Tokyo (JP)

(21) Appl. No.: 12/443,217

(22) PCT Filed: Sep. 26, 2007
(86) PCT No.: PCT/JP2007/068709

§ 371 Date: Mar. 27, 2009

(30) Foreign Application Priority Data
Sep. 29, 2006 (JP) 2006-269196
Mar. 30, 2007 (JP) 2007-094261
Sep. 5, 2007 (JP) 2007-230694

(51) Int. Cl. G09F 3/14; B65D 33/28; B65B 51/08; B23P 11/00

(52) U.S. Cl. 40/663; 53/138.8; 29/428

(57) ABSTRACT

On an information-showing portion 10A of a tag 1A shown in FIG. 1, information is written. A mounting portion 11A has at two positions catching holes 11m which catch a linear binder which is fasted by being wound around a mounted target such as a bag and is bound to the mounted target together with the binder by fastening the binder passed through the catching holes 11m at the two positions to the mounted target. A coupling portion 12A is made by forming a concave portion 12m by notching part of a side of the information-showing portion 10A and integrally couples the mounting portion 11A and the information-showing portion 10A to each other through its width smaller than that of the information-showing portion 10A. According to such a configuration, an orientation of the tag 1A in a condition where it is attached to the mounted target may be more stable and at this time, it is possible to recognize the information securely.

### TECHNICAL FIELD

The present invention relates to a tag for providing a variety of kinds of information, which is attached with a linear binder that is fastened to a bag with being wound around its squeezed top, bag neck, a bundle of wire rods or the like, and a method for manufacturing the same.

### BACKGROUND ART

Conventionally, in order to close a bag at the top or bundle wire rods, a binder that is commonly referred to as a twist tie has been used which is comprised of a fine iron core or the like having plasticity and is covered into the shape of a tape.

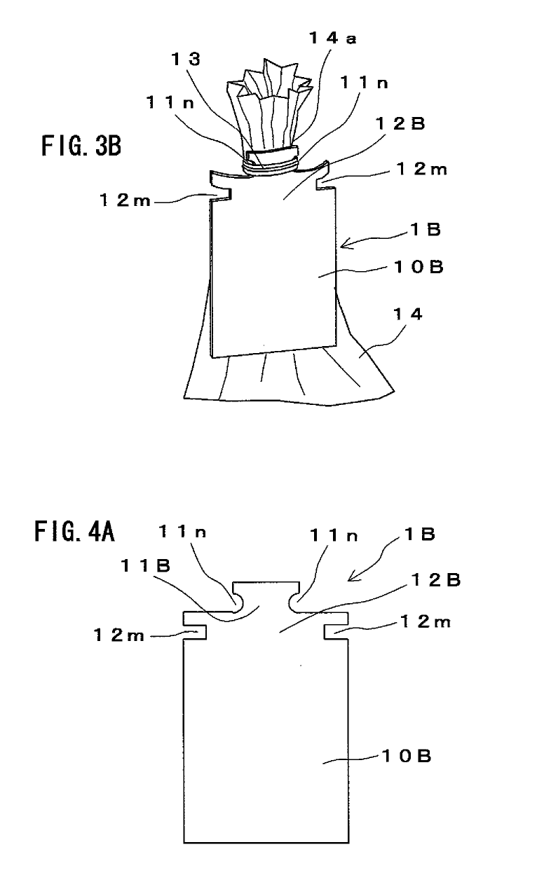

There also have been such techniques as to attach a tag having various kinds of information indicated on it, by using such a binder (see, for example, Japanese Patent Publication No. Sho 41-8517 (FIGS. 3a to 3c), which corresponds to U.S. Pat. No. 3,354,915).

The conventional tag has such a configuration that a plate-shaped member such as paper or plastic has one hole formed in it and a binder is twisted to attach a bag or the like after the binder has been wound around it with the binder being passed through the hole.

### DISCLOSURE OF THE INVENTION

### Problems to be Solved by the Invention

In the case of a conventional tag having one hole through which a binder passes, if it is attached to a bag etc. with the binder, an orientation of the tag would readily change around the hole. Therefore, there has been a problem that it is difficult to keep the orientation of the tag constant. If the tag orientation is not kept constant, such a problem also occurs that it has uncomfortable appearances as a product and it is difficult to see information indicated on the tag.

In order to improve the stability of a tag in a condition where it is attached to a bag etc., such a technique may be thought of as to form two holes through which a binder passes. However, if the binder passed through the two holes is twisted, the tag would bind around the bag etc. together with the binder, so that the tag may also be warped and bent greatly according to the shape of the bag etc. Therefore, there occurs such a problem that the information may have poor visibility and the overall appearances may be uncomfortable of the tag itself and a container or the like having a neck portion, such as a bag (for example, wrapping bag for merchandise) and a bottle. There would be also such a problem that if braille is inscribed as one example of information on the tag, it is difficult to read the braille when the tag is curved.

In order to solve the above-mentioned problems, a tag claimed in claim 1 according to this invention is characterized in that the tag comprises an information-showing portion on which information is written, a mounting portion that has at two positions catching portions which catch a linear binder which is fasted by being wound around a mounted target and that is bound to the mounted target together with the binder by fastening the binder passed through the catching portions at the two positions to the mounted target, and a coupling portion that is made by forming a concave portion by notching part of a side of the information-showing portion and that integrally couples the mounting portion and the information-showing portion to each other through its width smaller than that of the information-showing portion.

According to the tag of the present invention, the binder passed through the catching portions at the two positions in the mounting portion is wound around the mounted target and fastened. Since the binder is passed through the catching portions at the two positions and attached to the mounted target, the orientation of the tag in a condition where it is attached to the mounted target maybe more stable than a case where it is attached through catching portion at one position. At this time, the mounting portion of the tag is fastened to the mounted target by the binder so that it is curved as wound around the mounted target.

On the other hand, the information-showing portion of the tag is coupled to the mounting portion via the coupling portion having its width decreased due to a concave portion formed in its side partially, so that the information-showing portion may not be curved even if the mounting portion is curved. Therefore, it is possible to attach the tag to the mounted target without deforming this information-showing portion to a great extent. This makes it possible to recognize the information securely and also improve the appearances of a bag or a product to which the tag is attached. Furthermore, by using the concave portion for forming the coupling portion as an alignment portion to pass the binder through any of the catching portions, it is possible to mechanize the attachment of the tag by use of the binder.

Further, the tag of the present invention is formed so that a total sum of an angle between the side of the concave portion on the side of the information-showing portion and the side of the concave portion on the coupling portion and an angle between the side of the concave portion on the side of the mounting portion and the side of the concave portion on the coupling portion is greater than 180 degrees.

Accordingly, when feeding out one of the tags stacked in a tag storage portion, if the side of the concave portion of the tag on the side of the information-showing portion and the side on the side of the mounting portion intersect and come in sliding contact with each other, these two sides slide without interfering or meshing with each other. Therefore, the concave portion in the tag fed out first may not be caught in the concave portion in the tag to be fed out next, thus making it possible to feed out only one of the stacked tags smoothly.

In order to solve the above-mentioned problems, a method for manufacturing a tag claimed in claim 8 according to this invention is characterized in that the method comprises the steps of forming a mold for a tag comprising an information-showing portion on which information is written, a mounting portion that is coupled to the information-showing portion, that has at two positions catching portions each having a slit which catch a linear binder which is fasted by being wound around a mounted target, and that is bound to the mounted target together with the binder by fastening the binder passed through the catching portions at the two positions to the mounted target, and punching out the tag from an original fabric sheet which provides a material for the tag, by using the formed mold for the tag.

In the method for manufacturing the tag according to the present invention, after punching of tags, the punch-out residues of the catching portions f the tags and the original fabric sheet can be coupled using a slit. This facilitates the disposal of the punch-out residues of the catching portions. Further, the punch-out residues of the catching portions are pulled by the original fabric sheet, so that the catching portions can be punched securely.

In order to solve the above-mentioned problems, a tag claimed in claim 9 according to this invention is characterized in that the tag comprises an information-showing portion on which information is written, a mounting portion that has at two positions catching portions which catch a linear binder which is fasted by being wound around a mounted target and that is bound to the mounted target together with the binder by fastening the binder passed through the catching portions at the two positions to the mounted target, a coupling portion that integrally couples the mounting portion and the information-showing portion to each other, and an engagement portion that engages with tag guide means of a binding machine which contains a claw portion as well as a binder passage through which the binder passes, the engagement portion performing positioning in cooperation with the claw portion, the binder passage interconnecting between the catching portions at the two positions, and which twists and fastens the binder formed by passing it through the catching portions at the two positions.

In the tag according to the present invention, the positioning is carried out in cooperation with the claw portion of the tag guide means of the binding machine and the engagement portion of this tag, and the binder passage interconnects between the catching portions at the two positions. Then, the binder is passed through the catching portions at the two positions and wound around a mounted target, thereby being fastened. Therefore, it is possible to mechanize the attachment of tags by use of a binder.

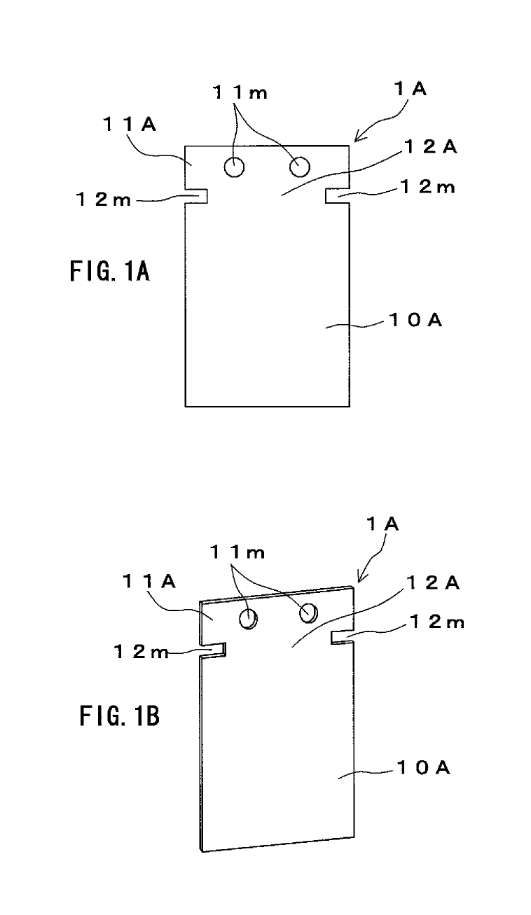

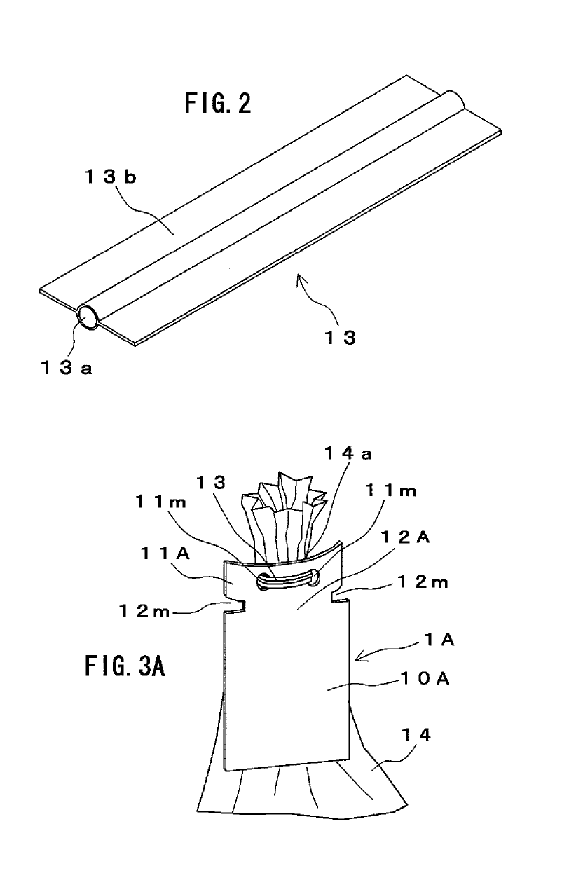

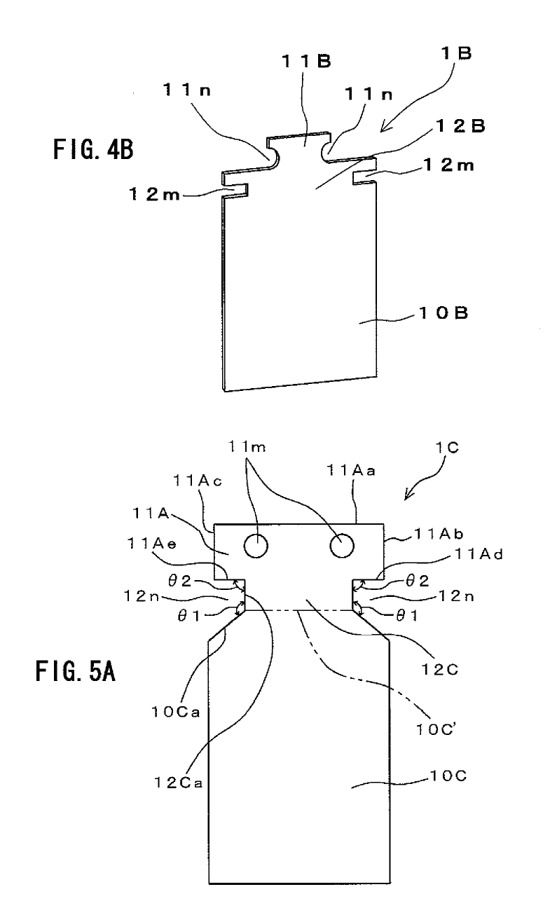

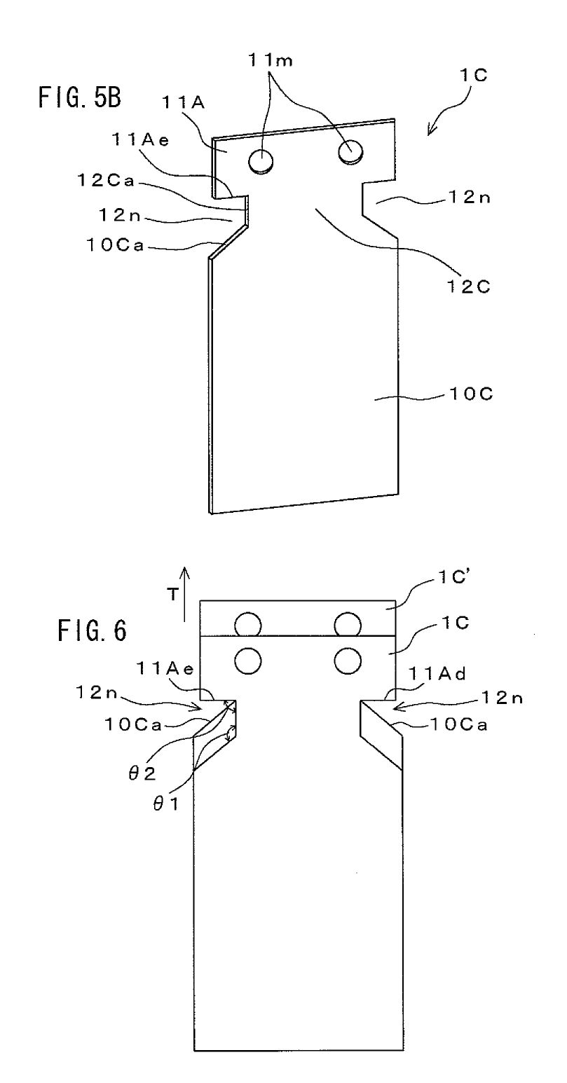

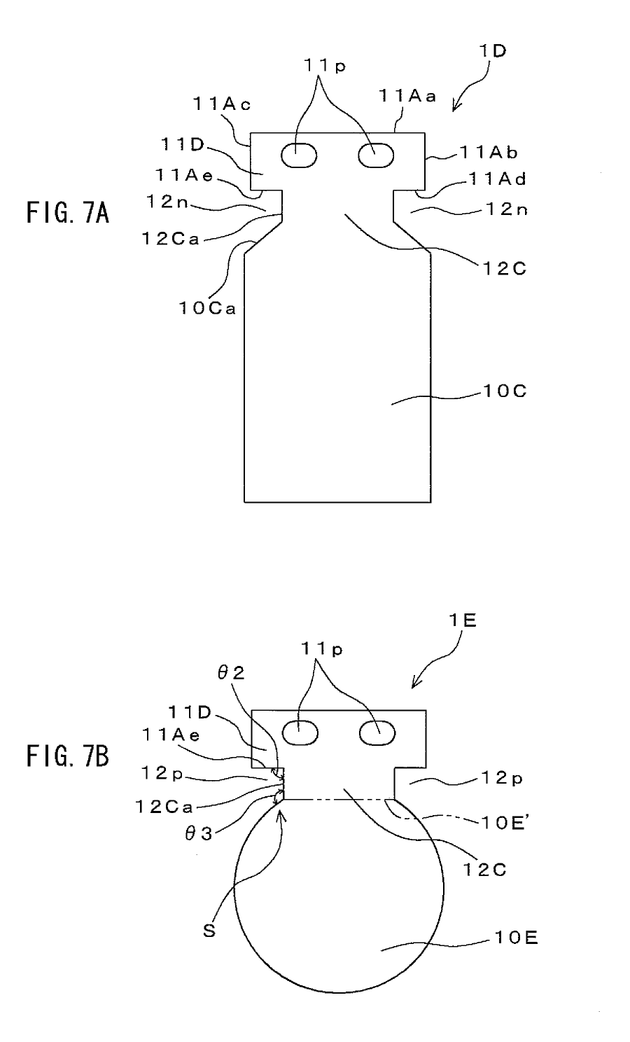

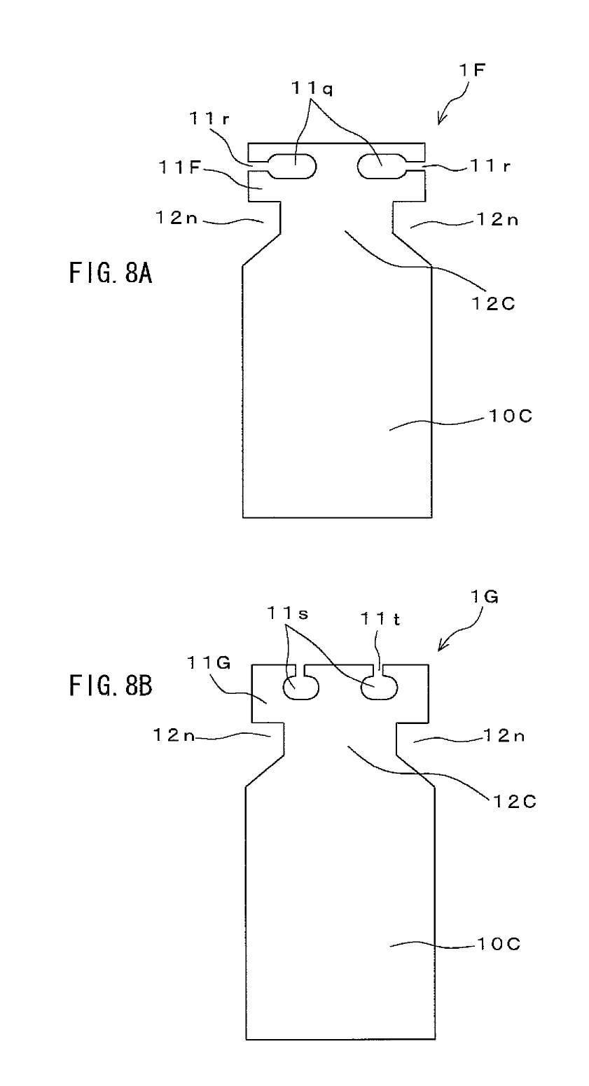

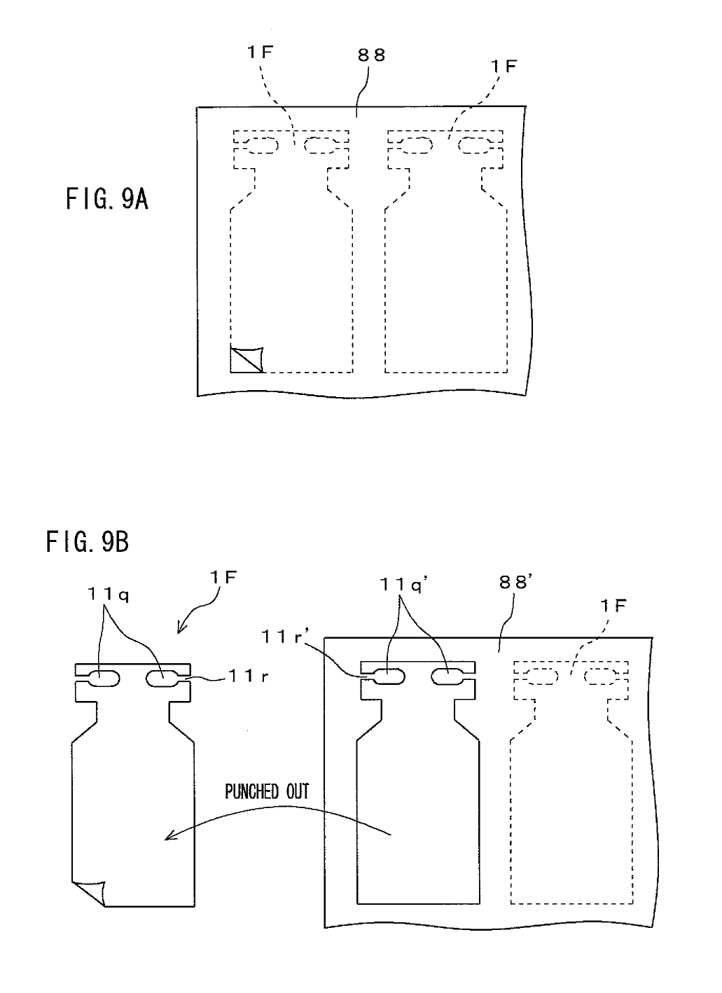

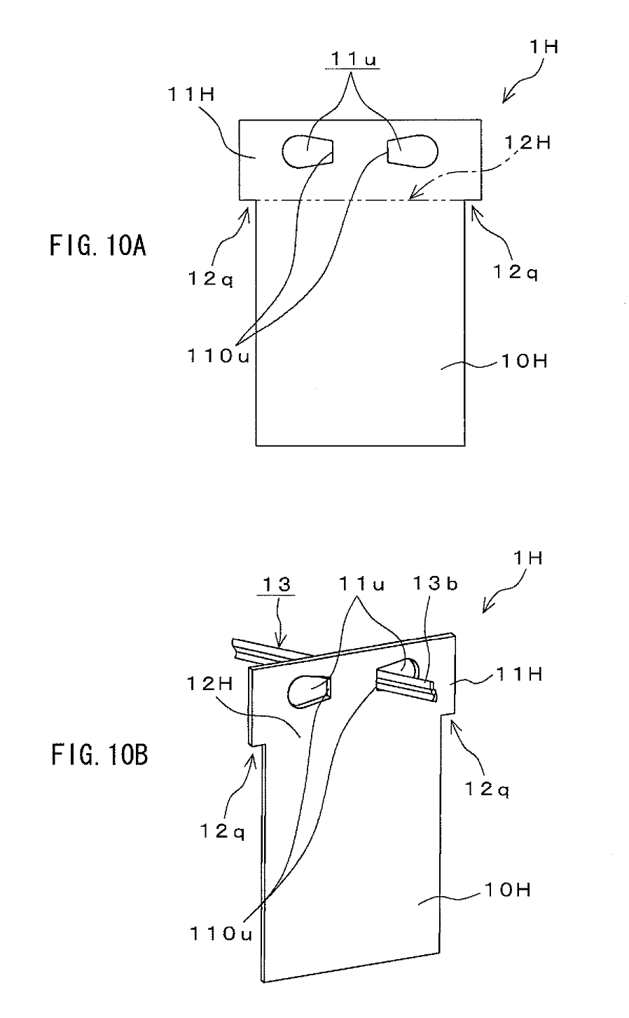

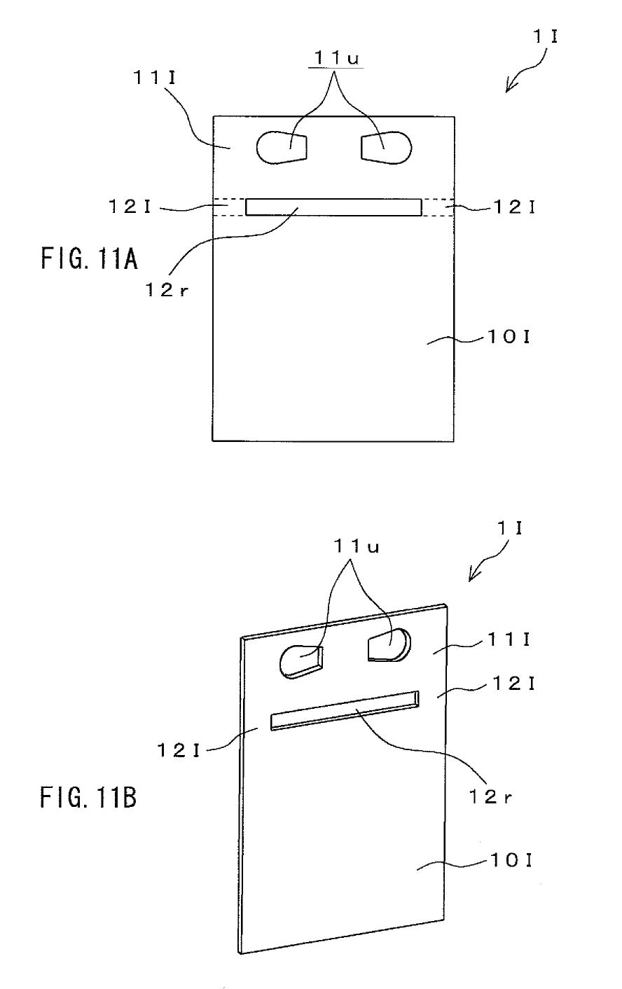

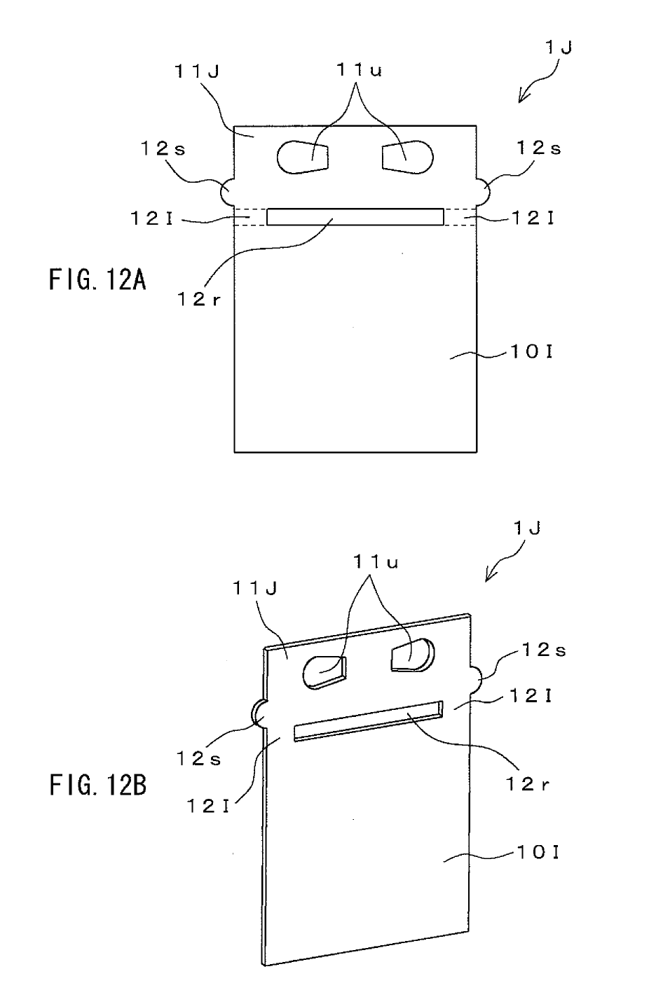

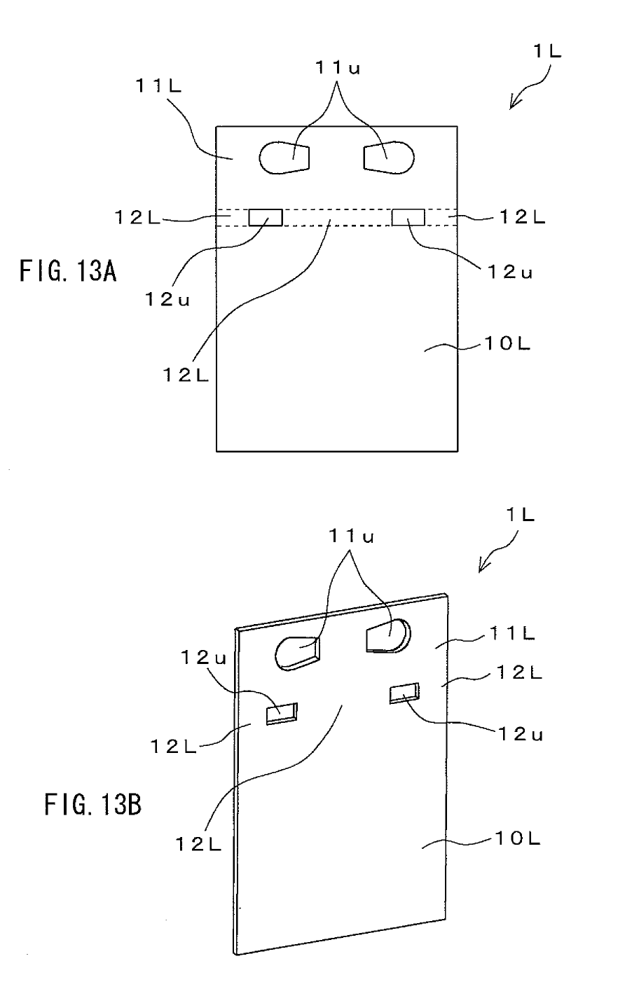

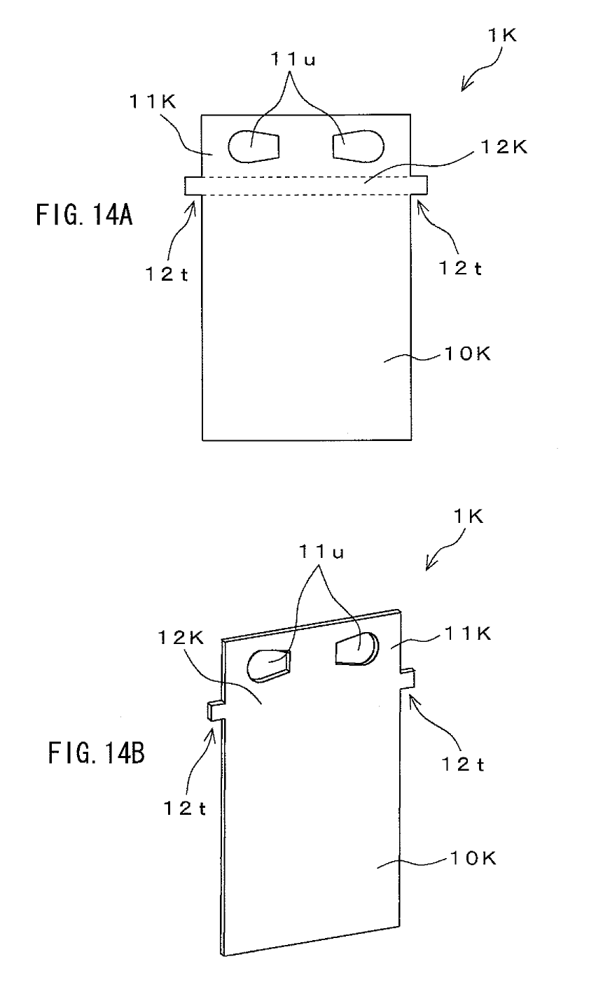

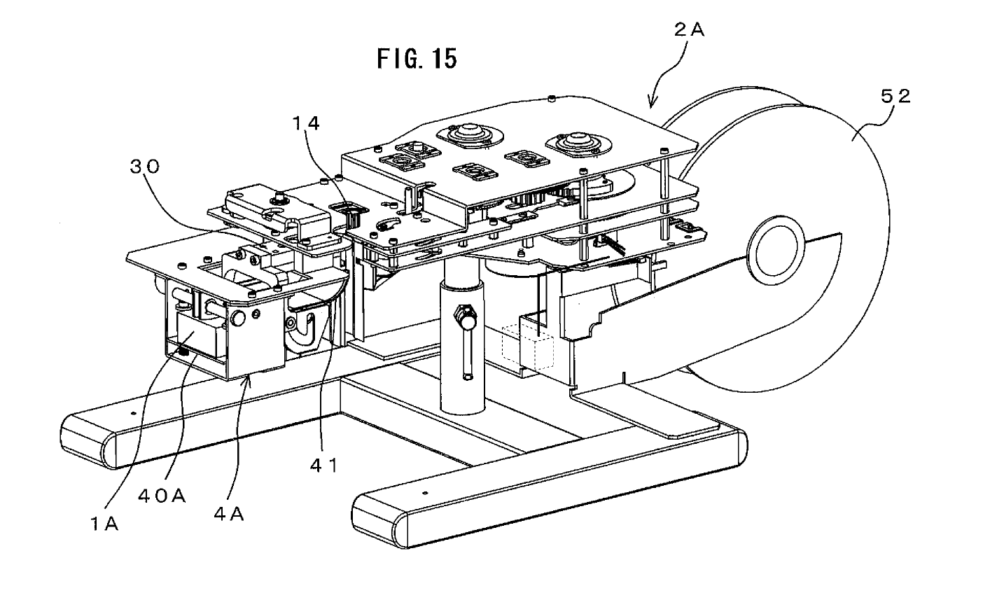

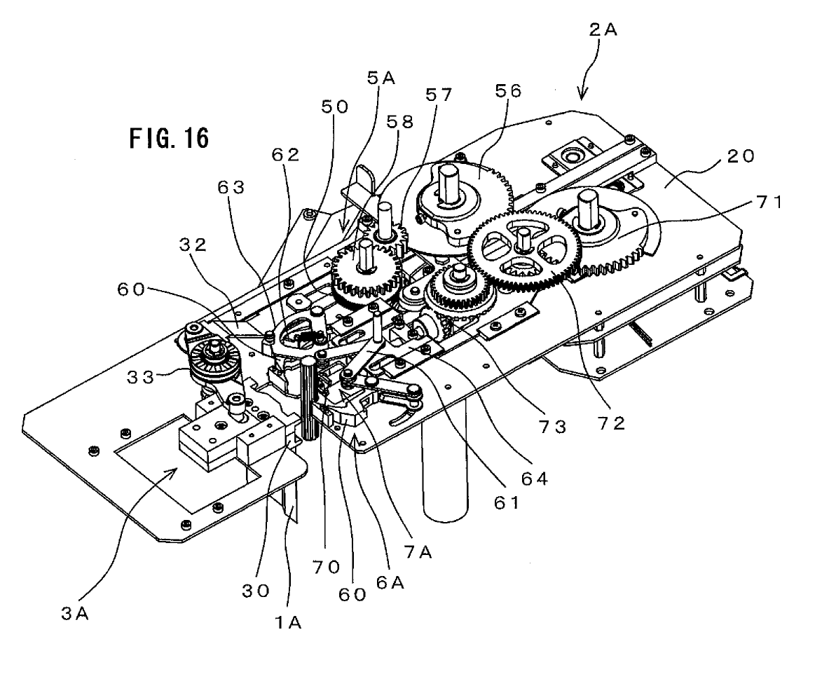

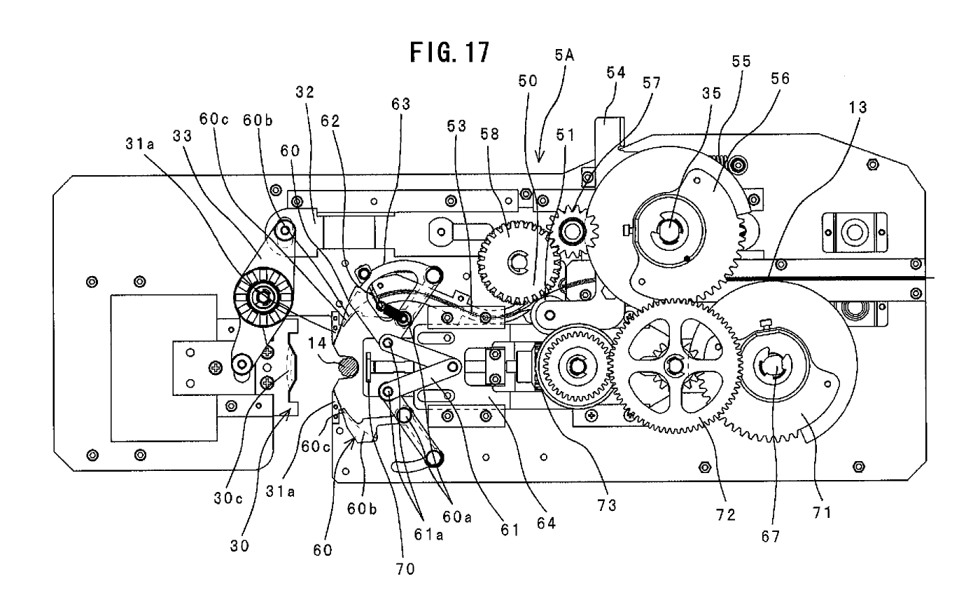

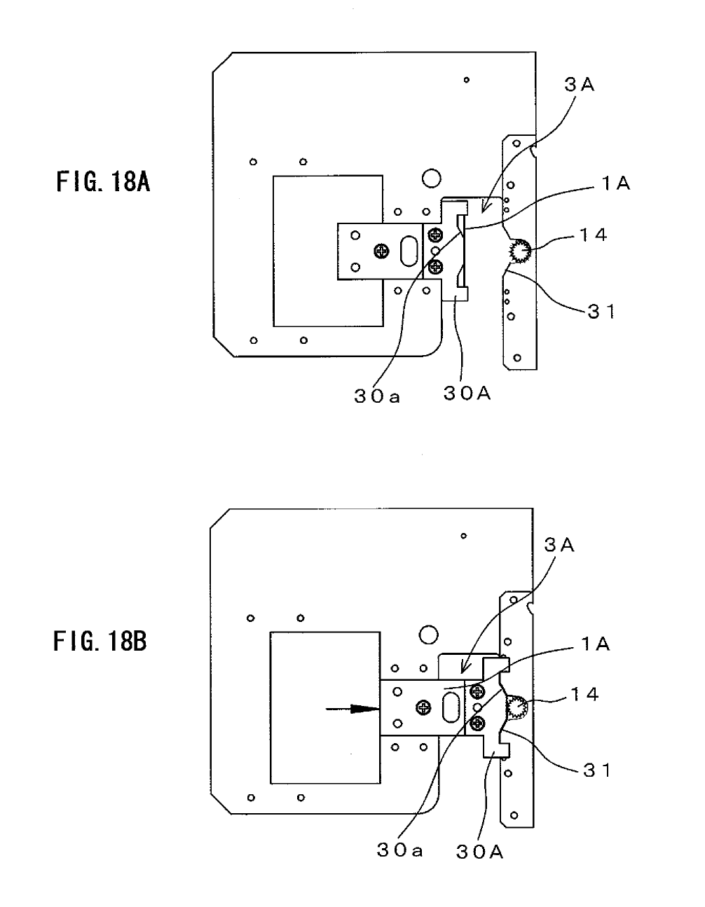

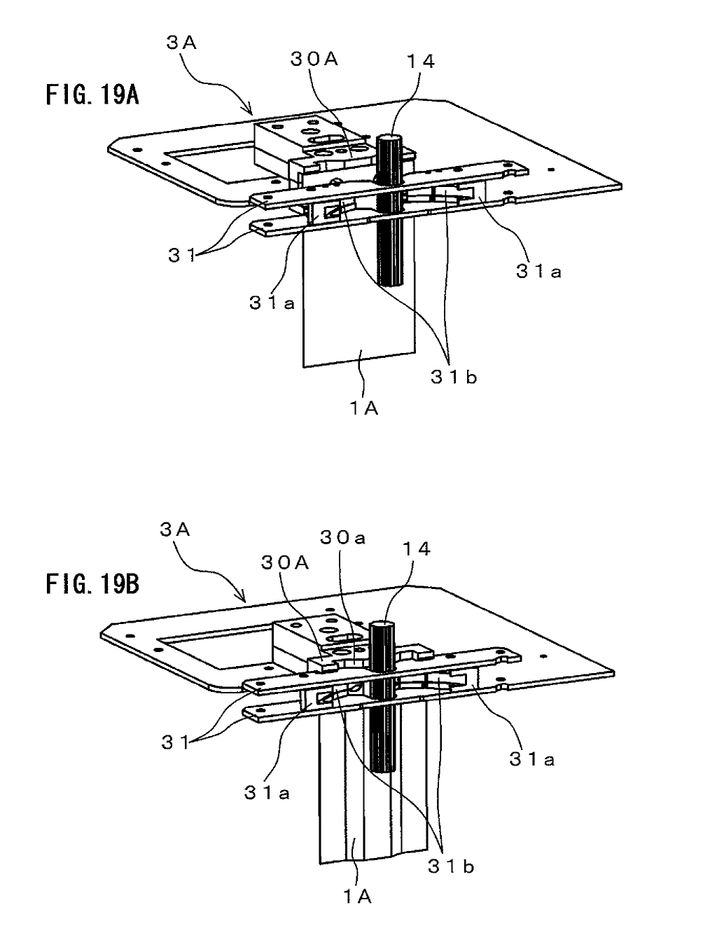

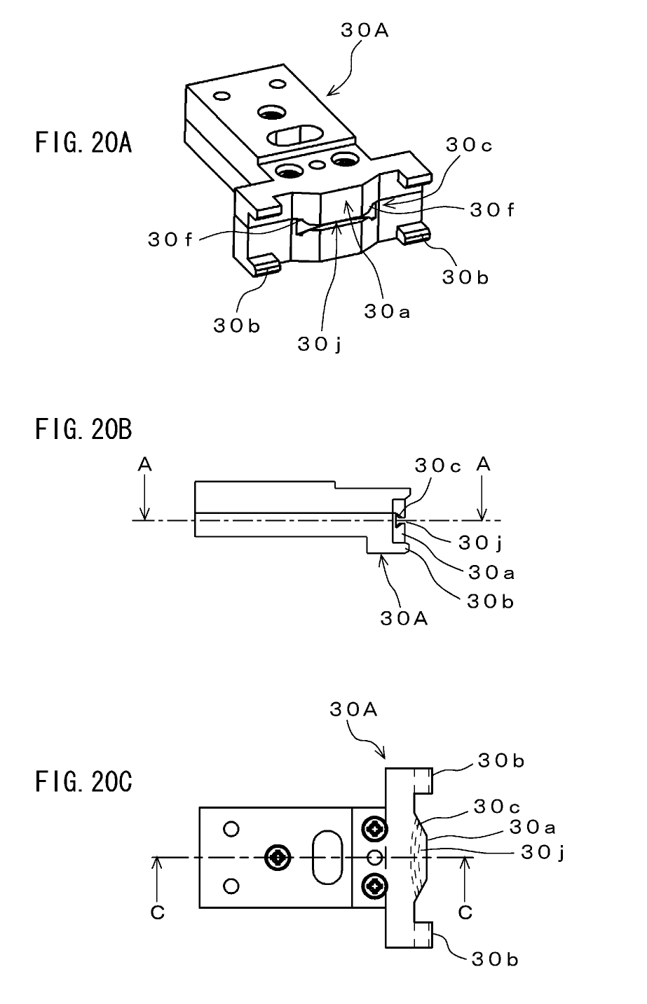

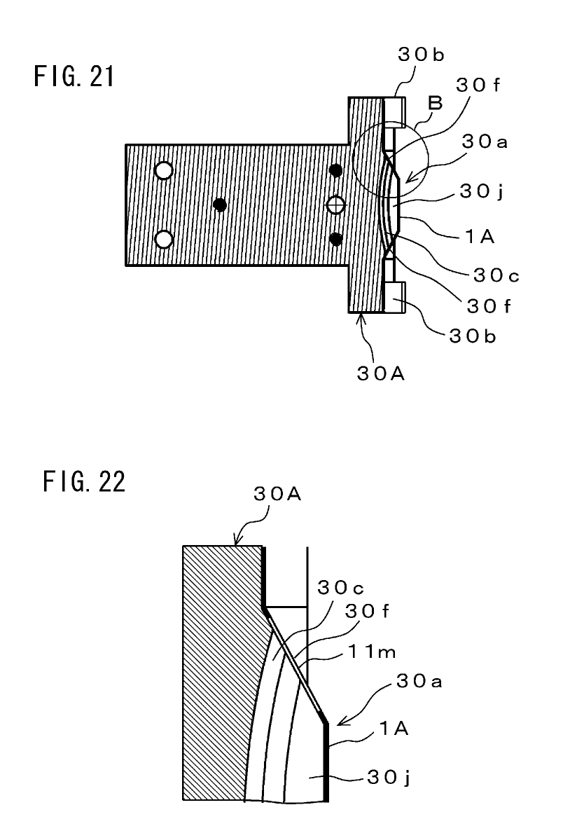

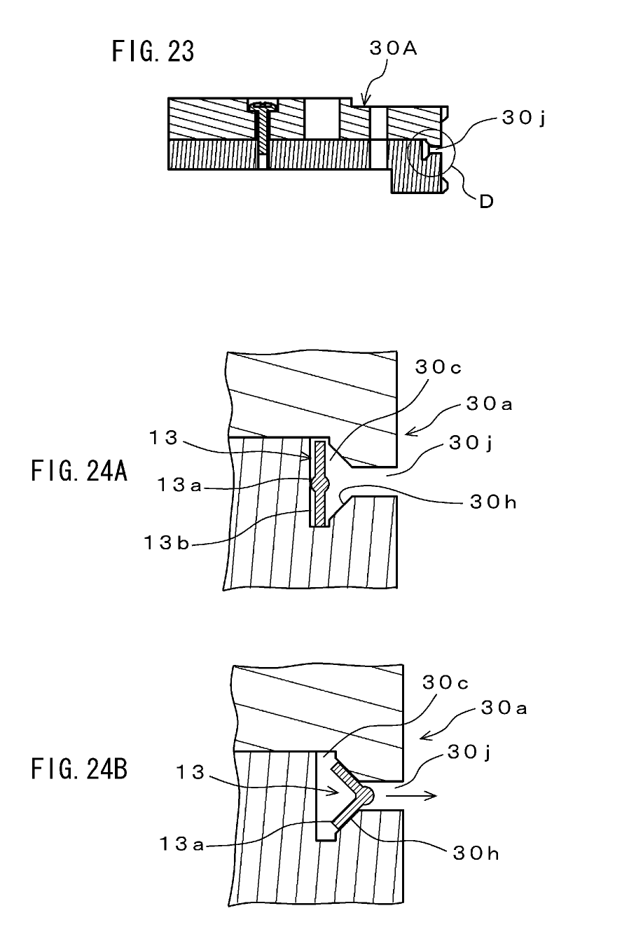

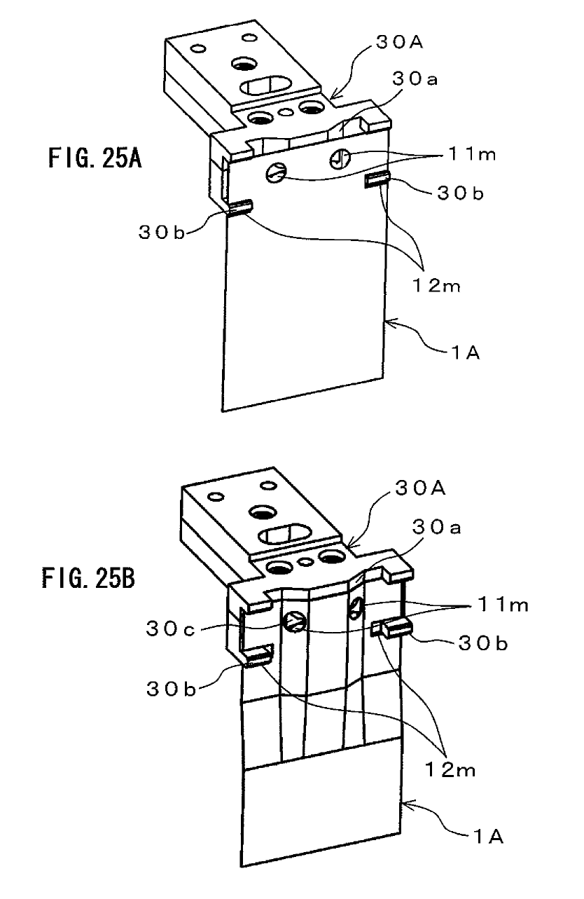

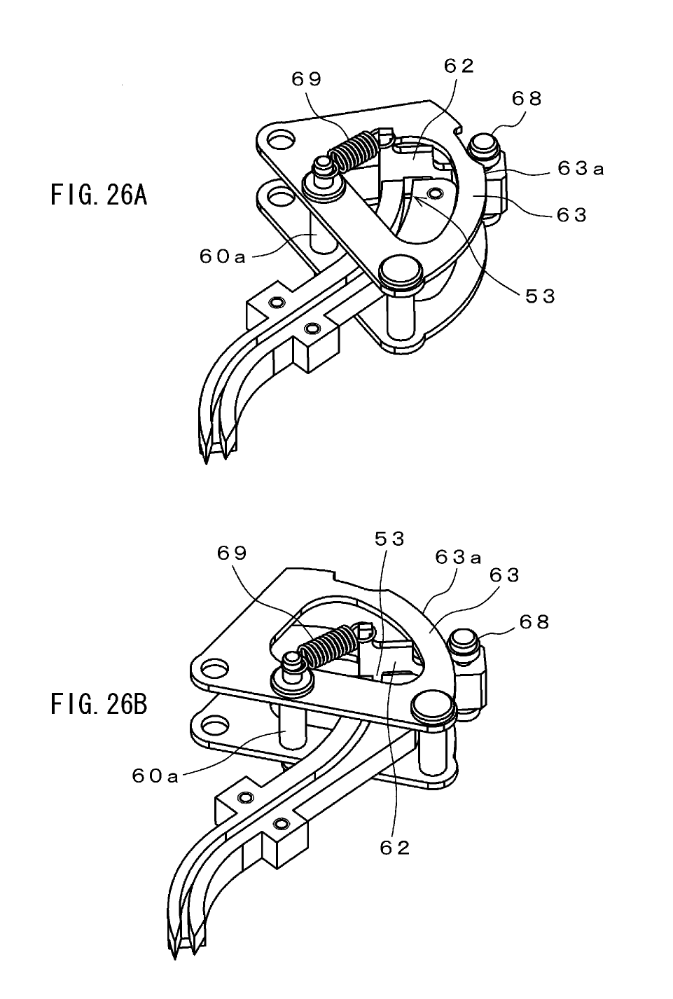

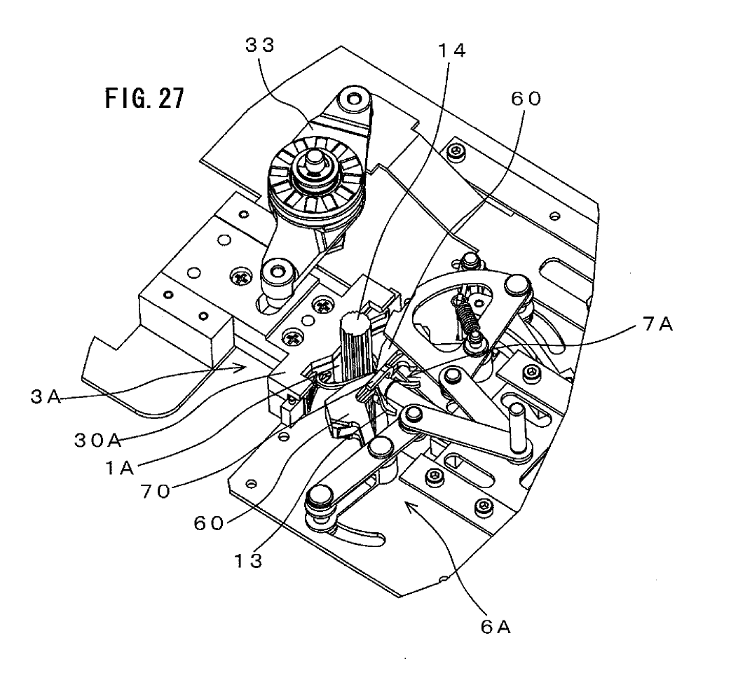

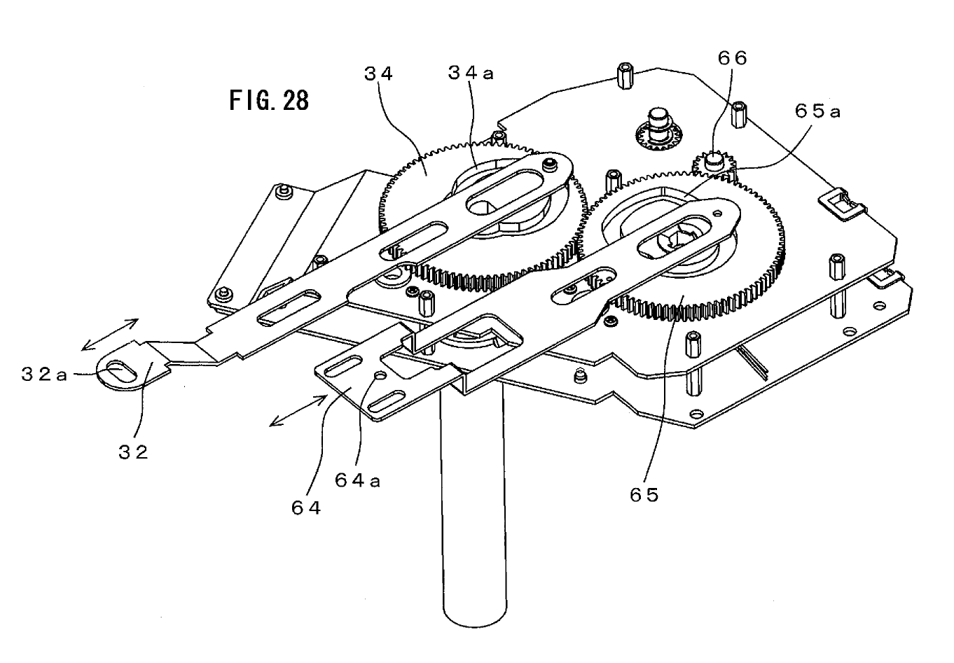

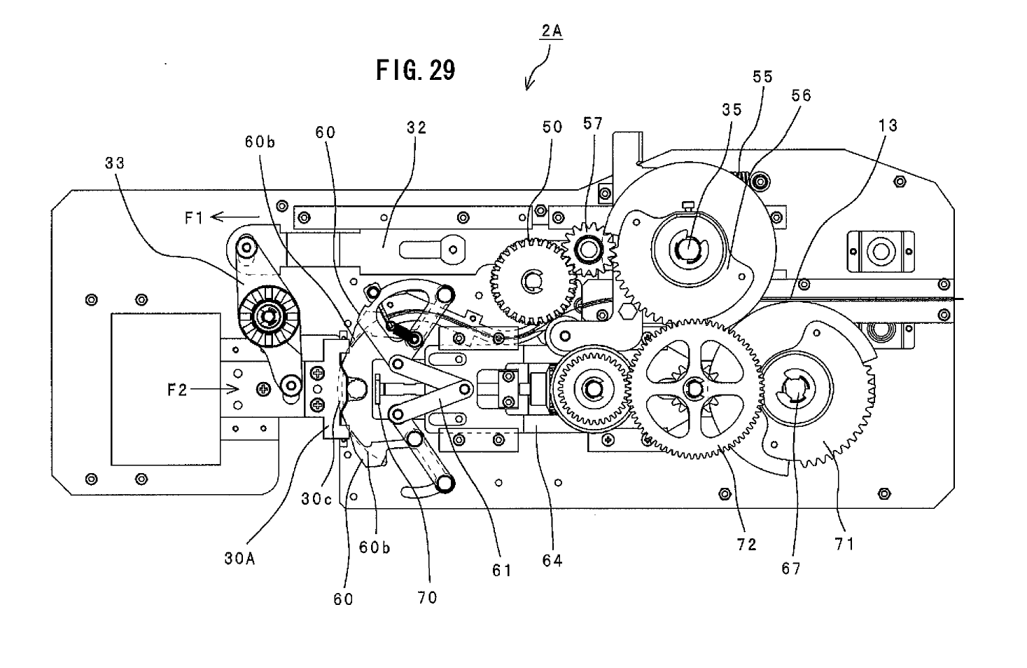

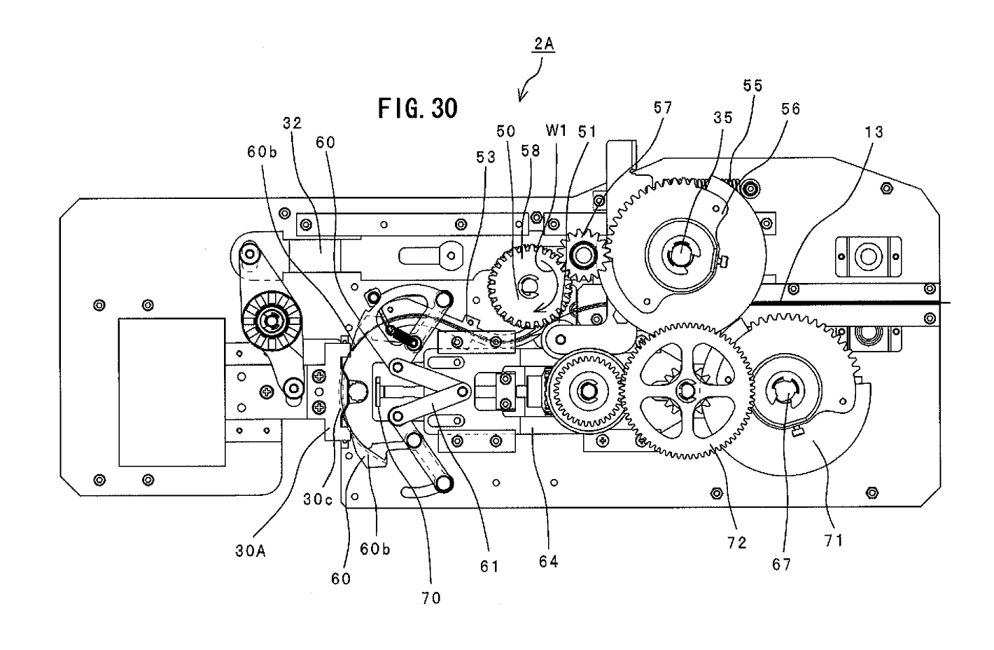

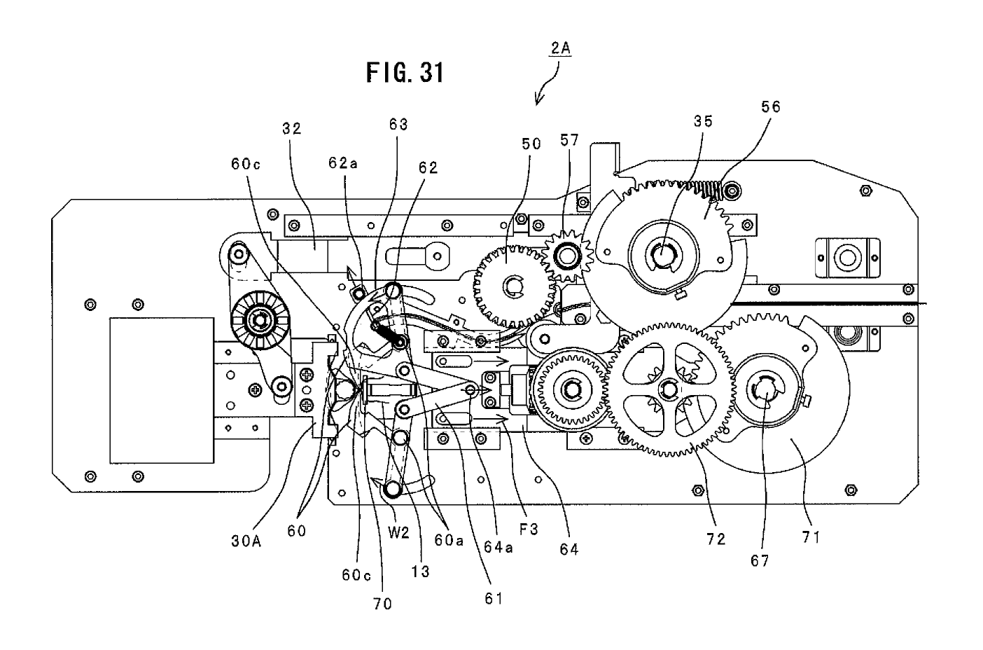

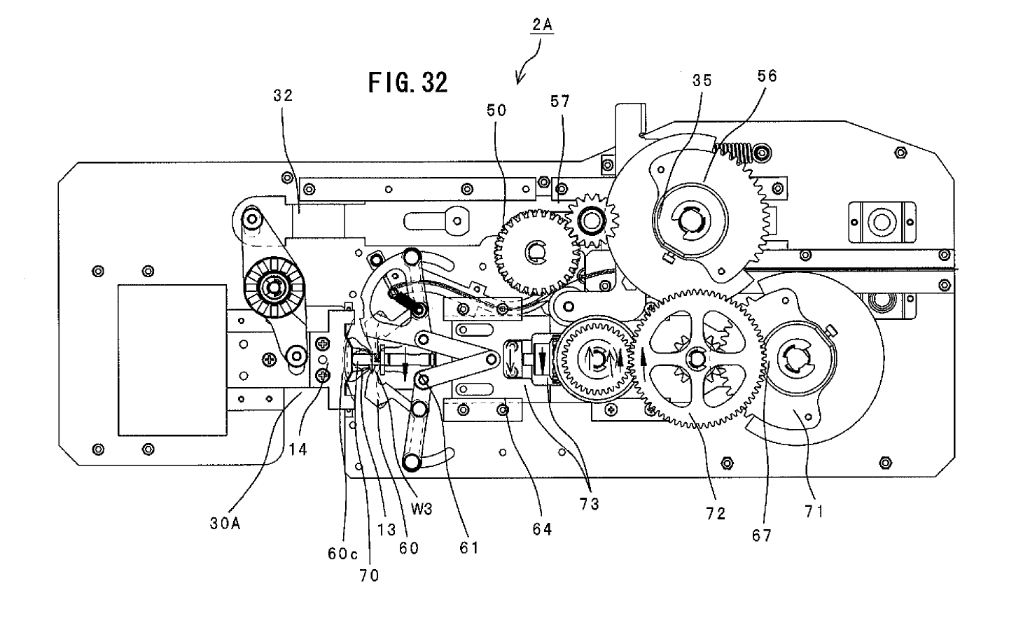

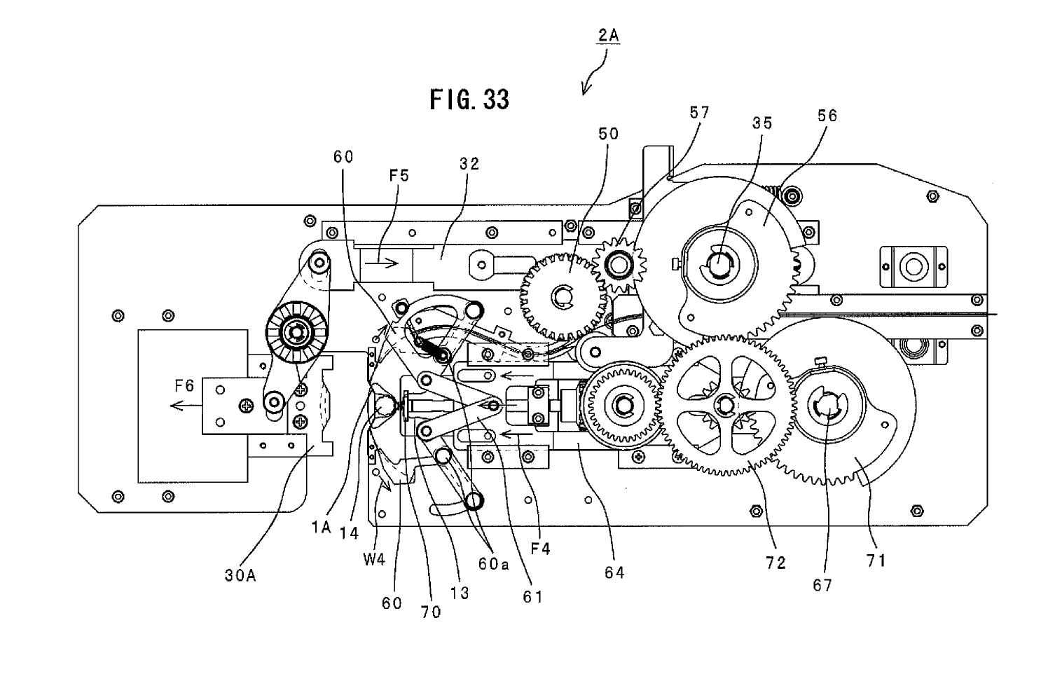

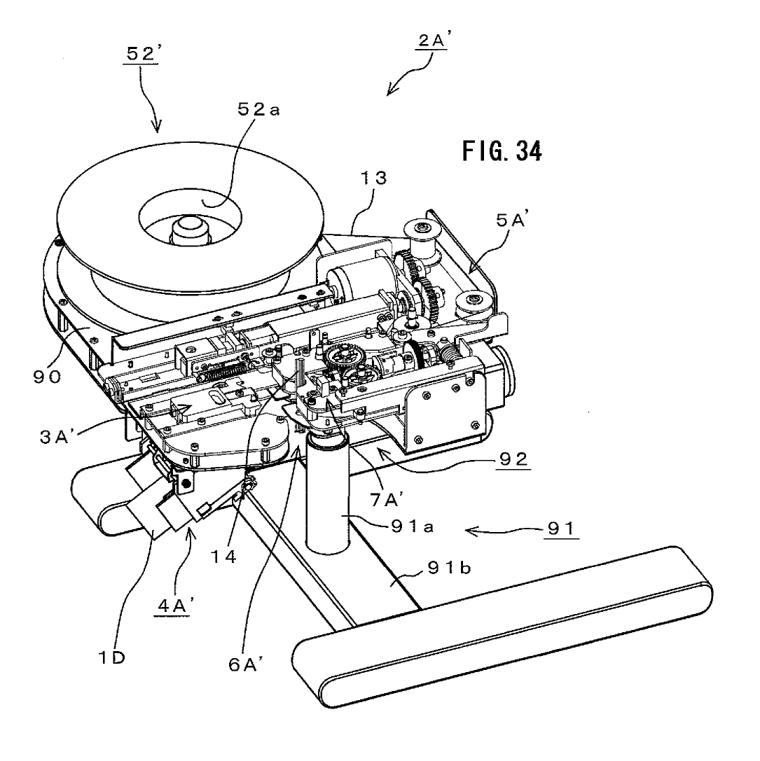

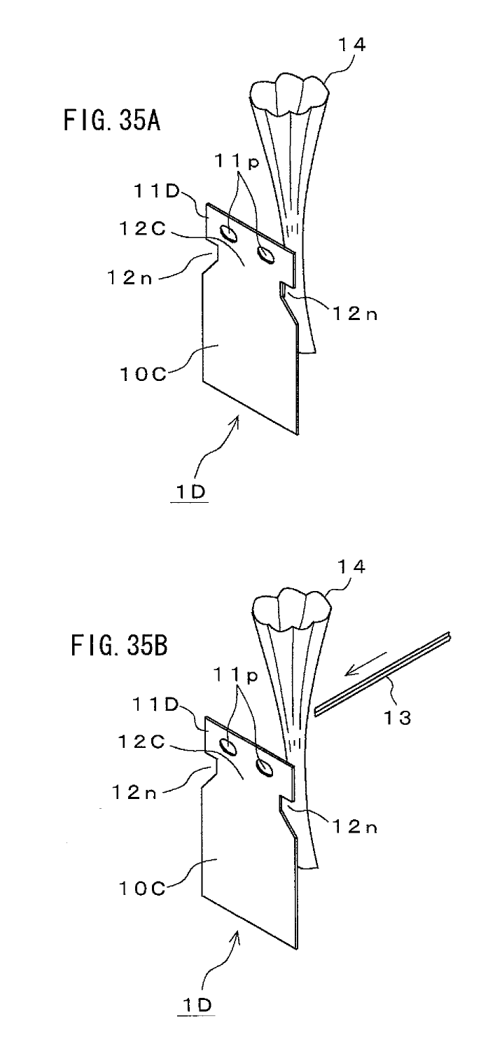

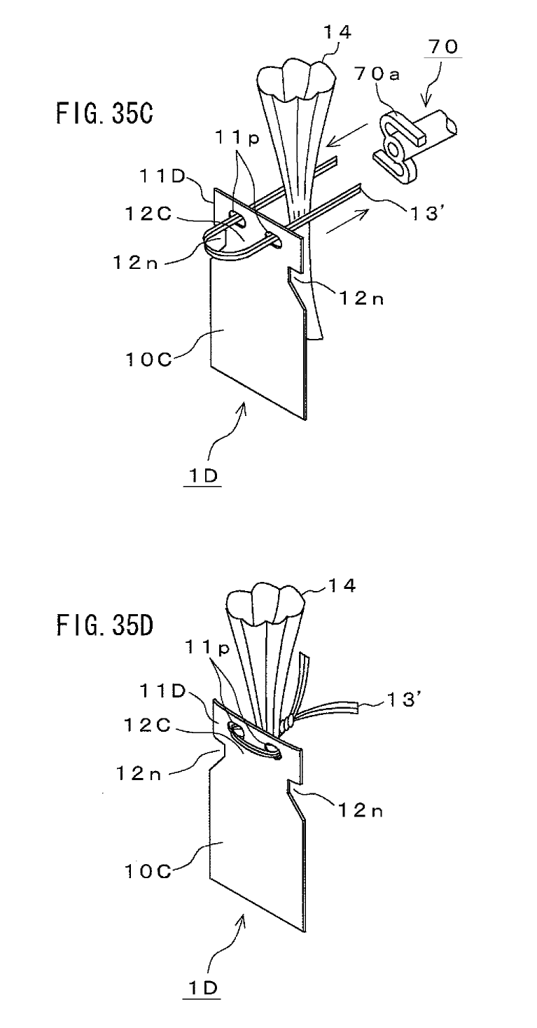

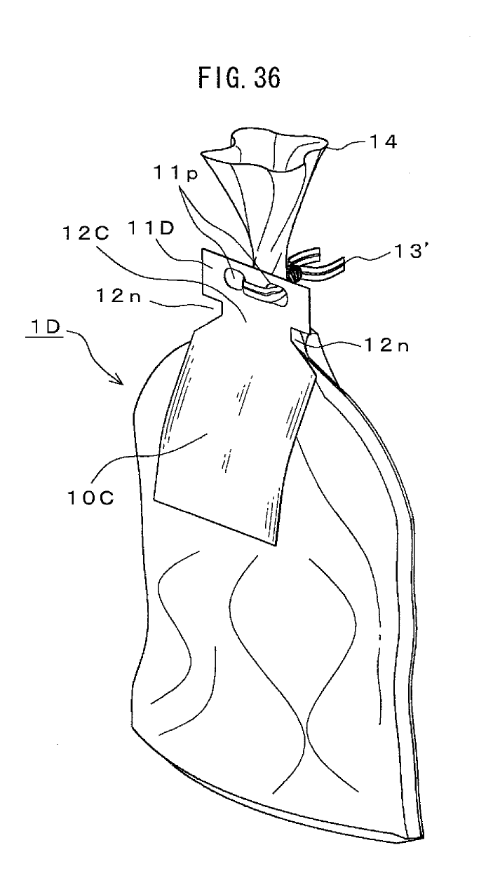

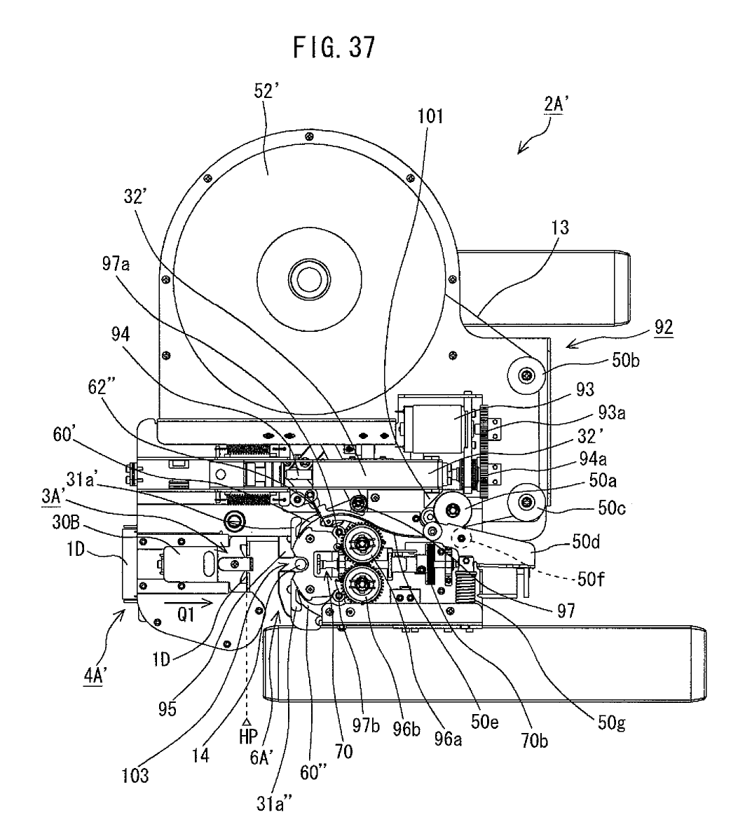

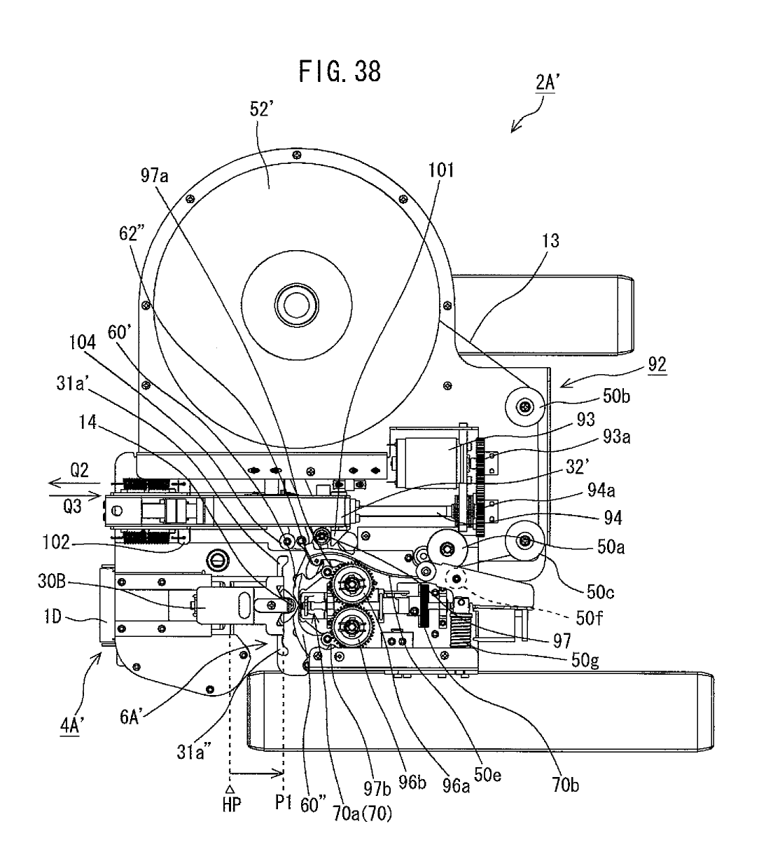

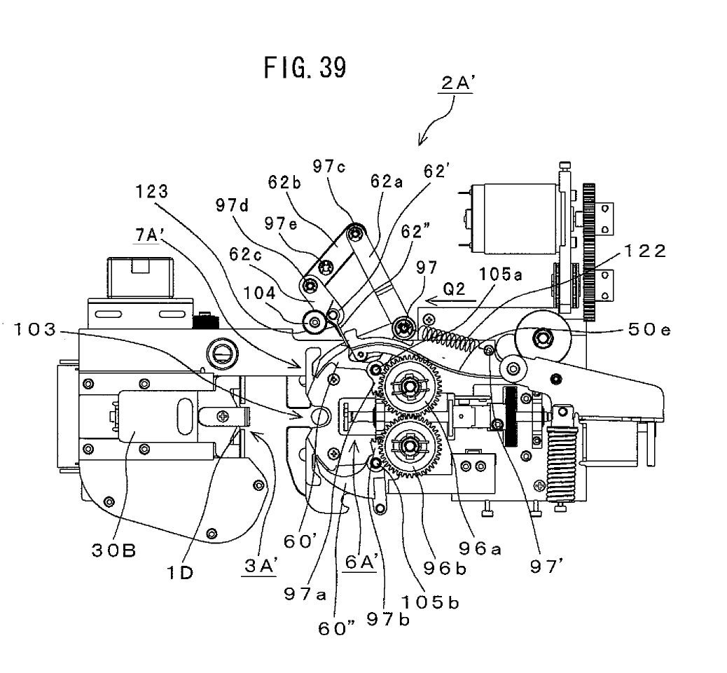

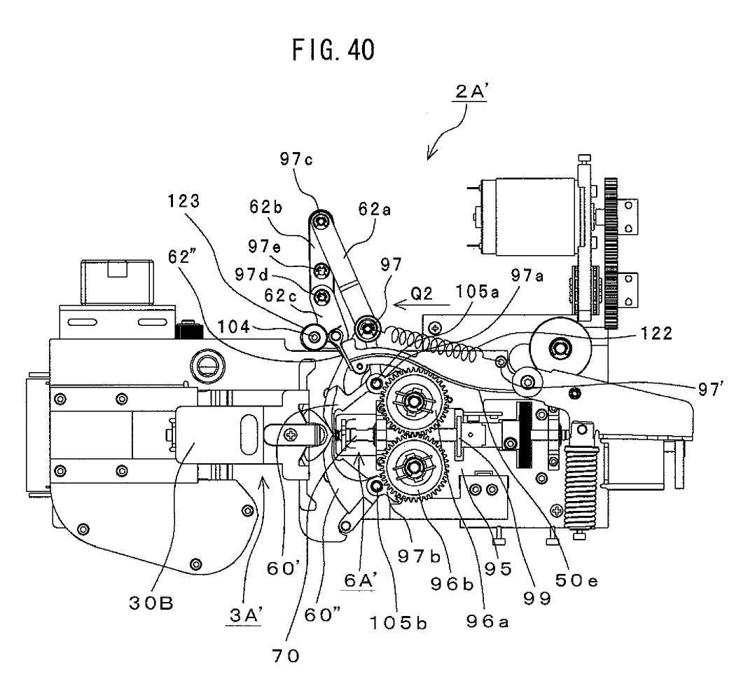

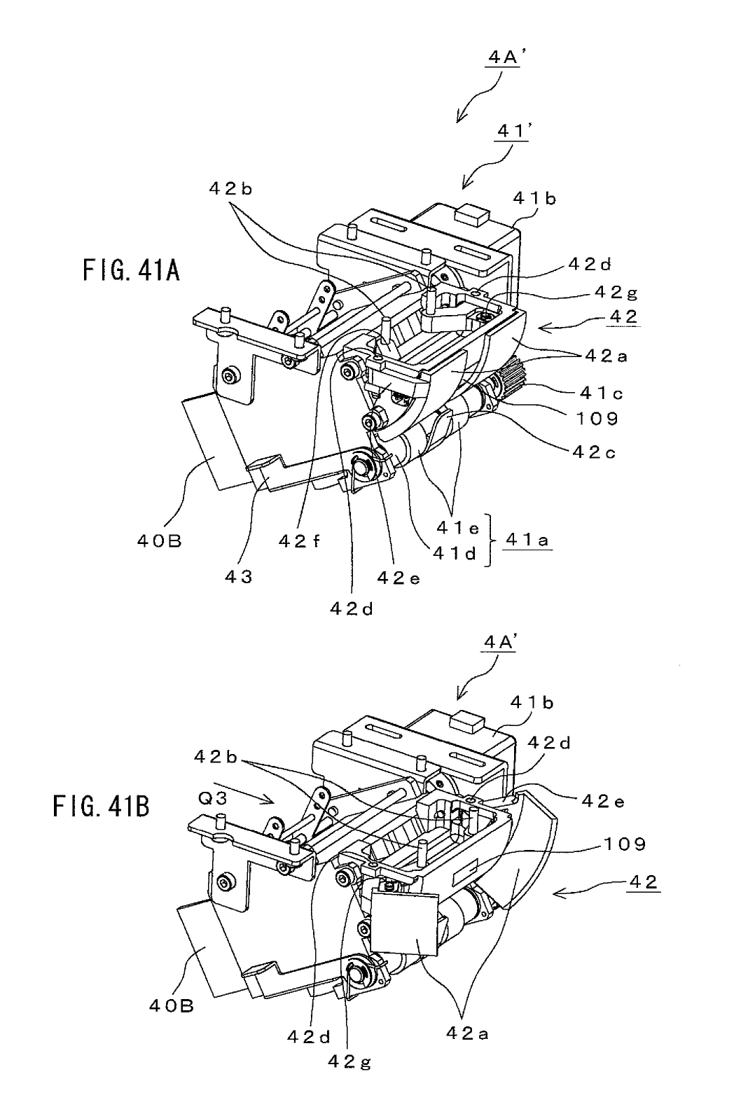

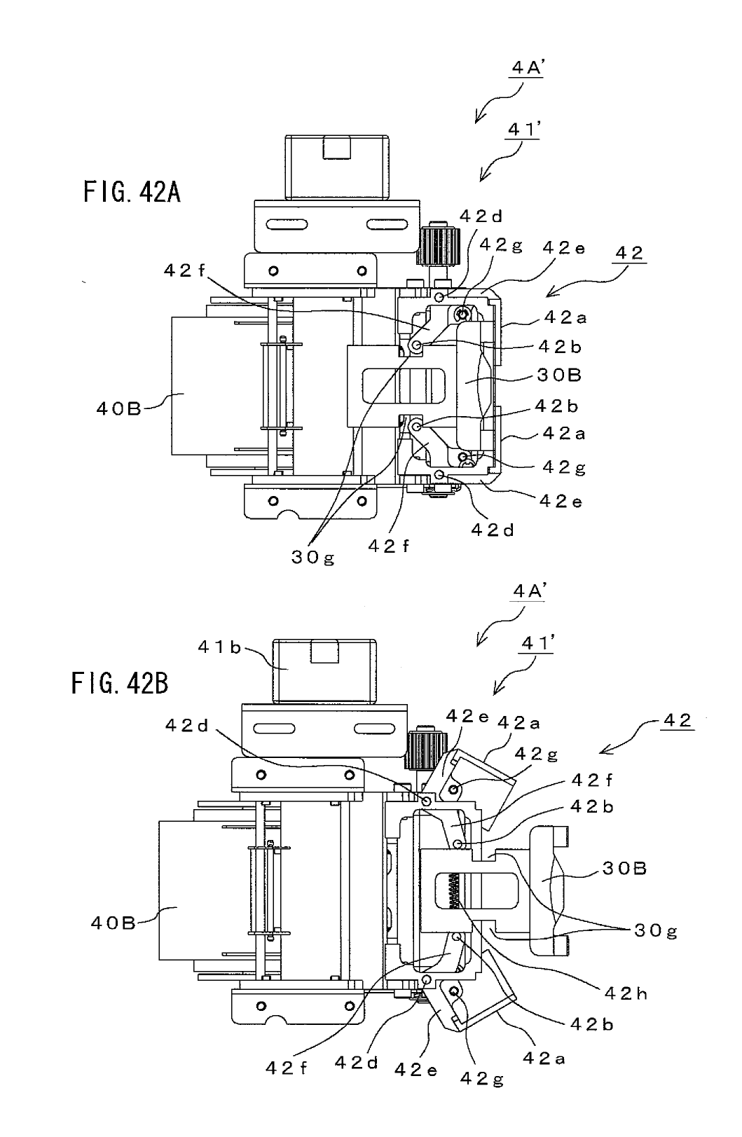

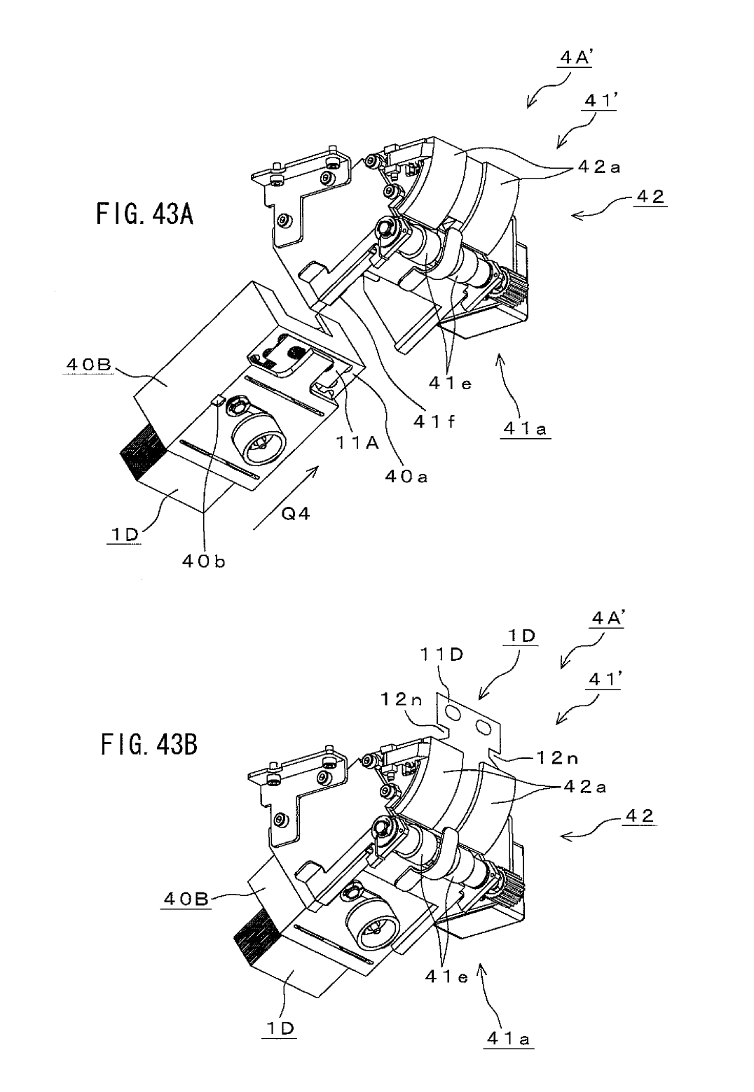

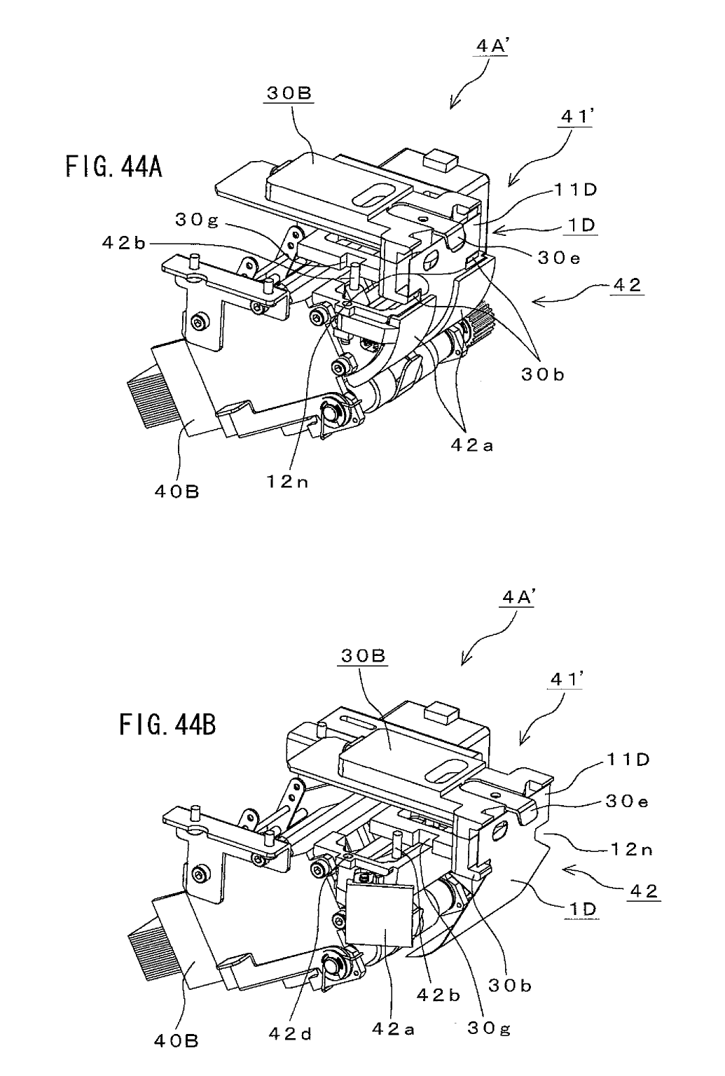

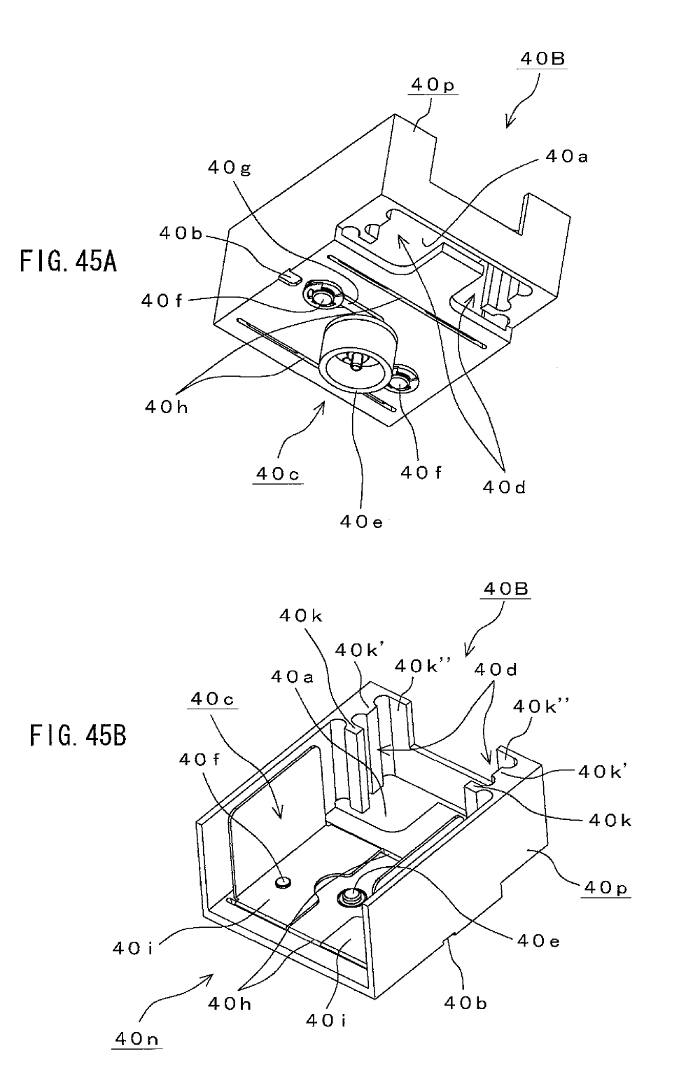

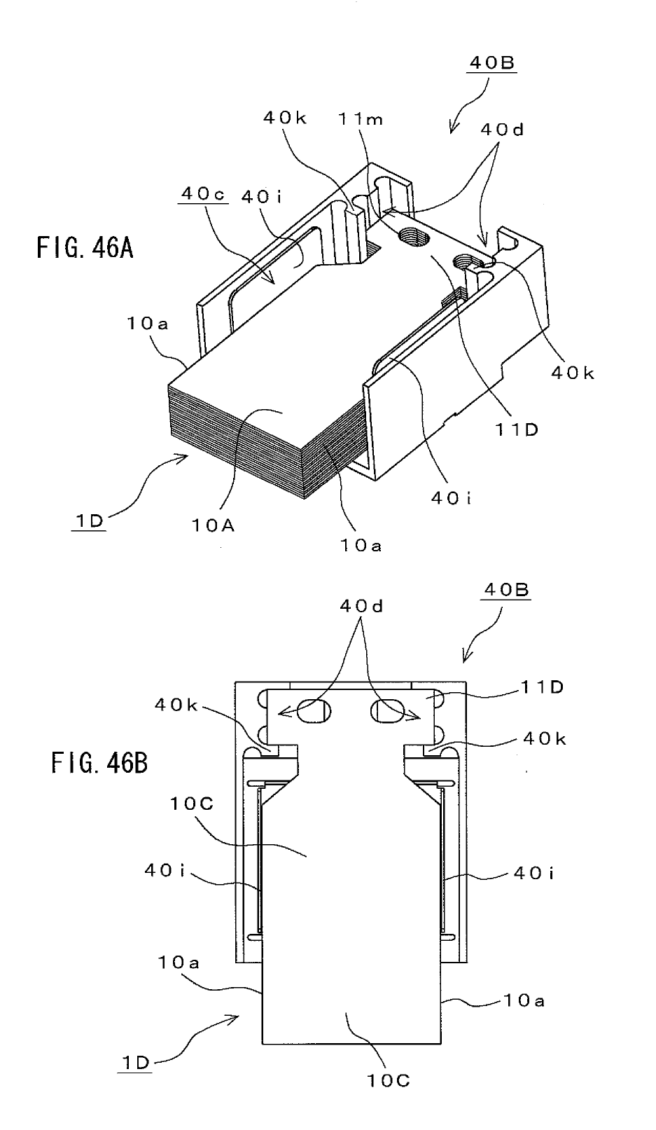

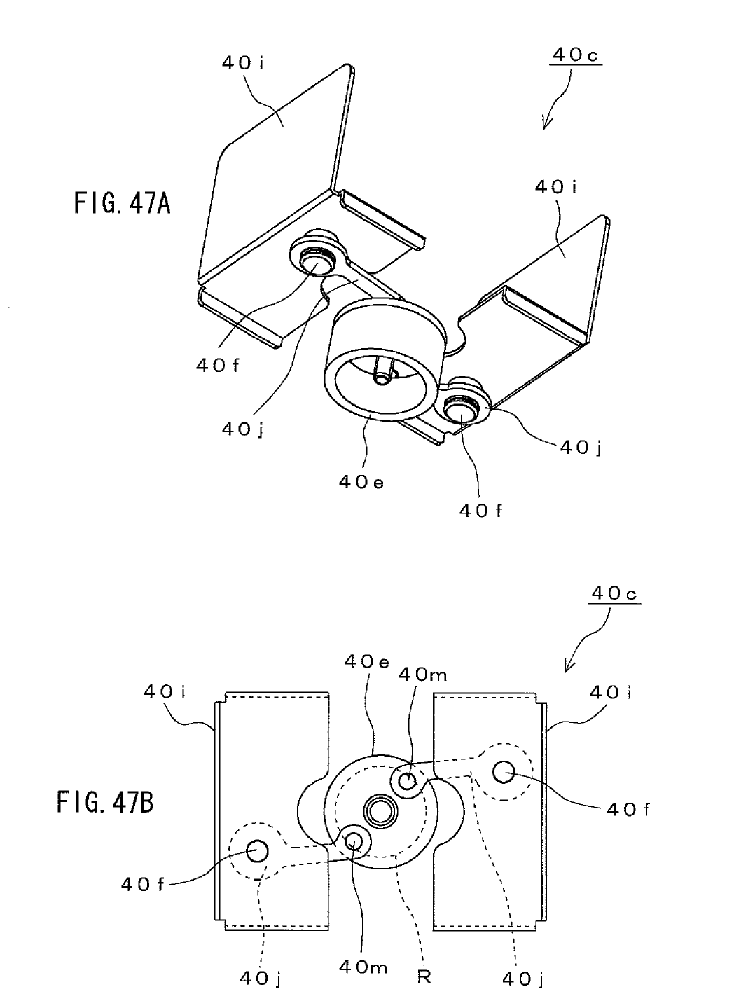

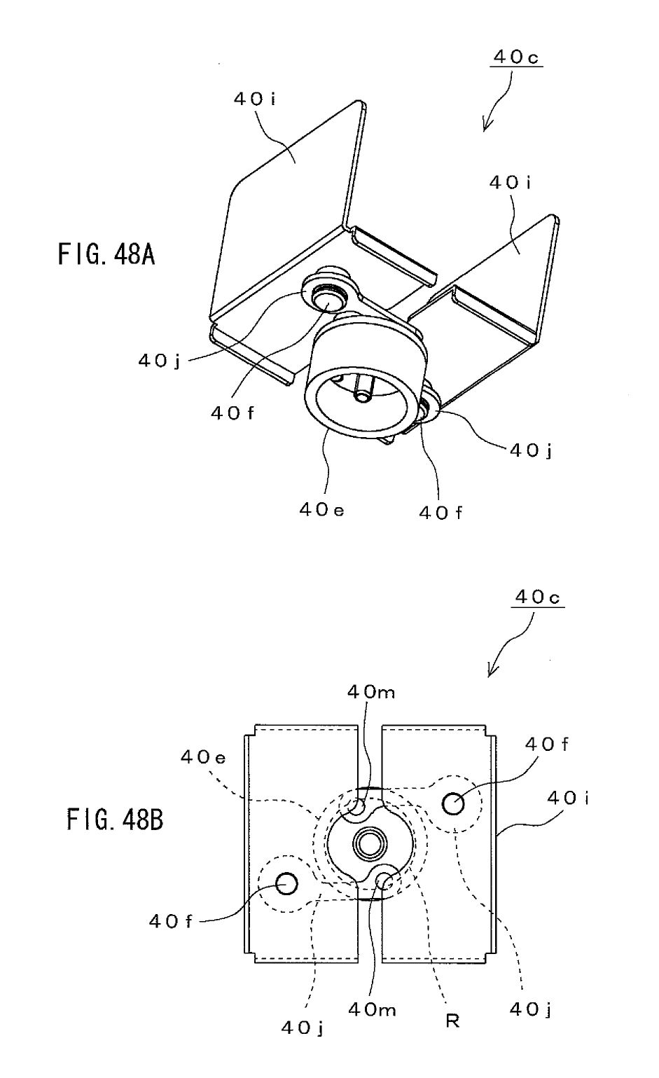

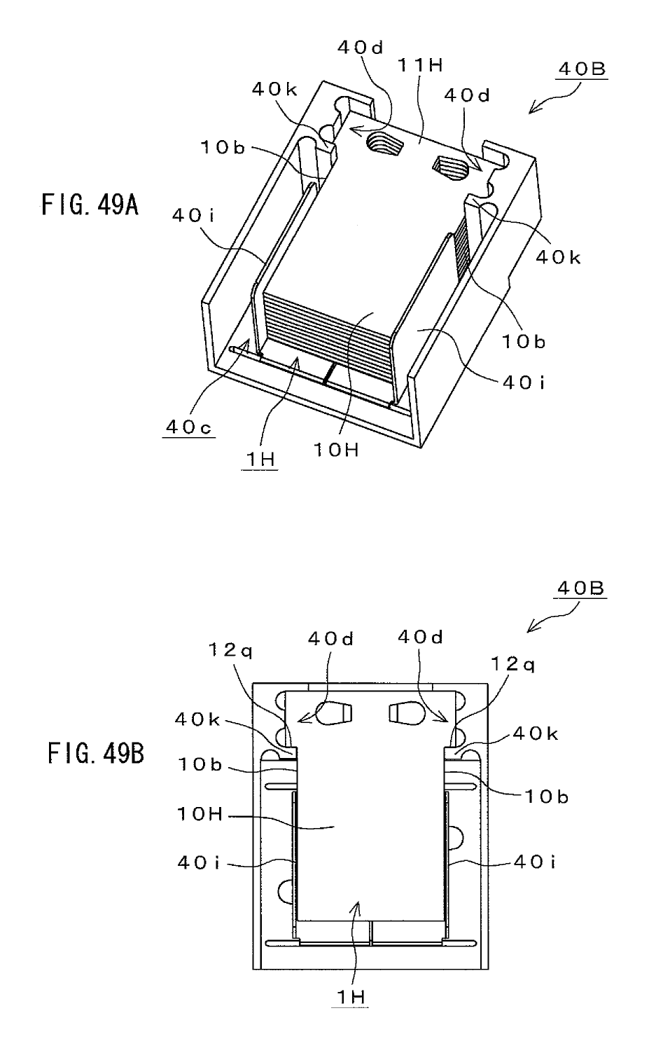

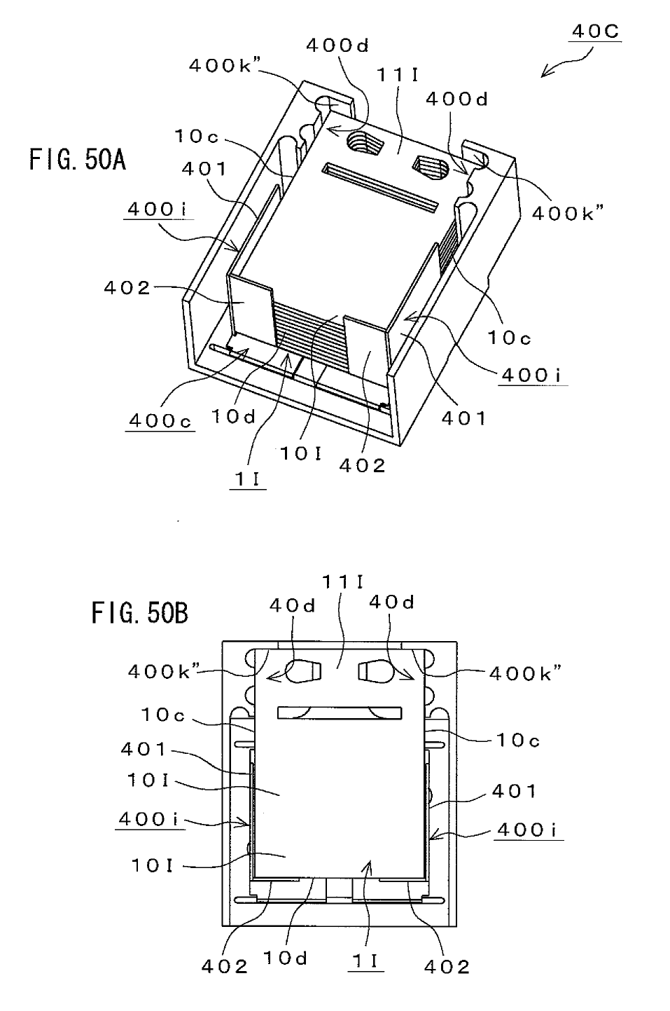

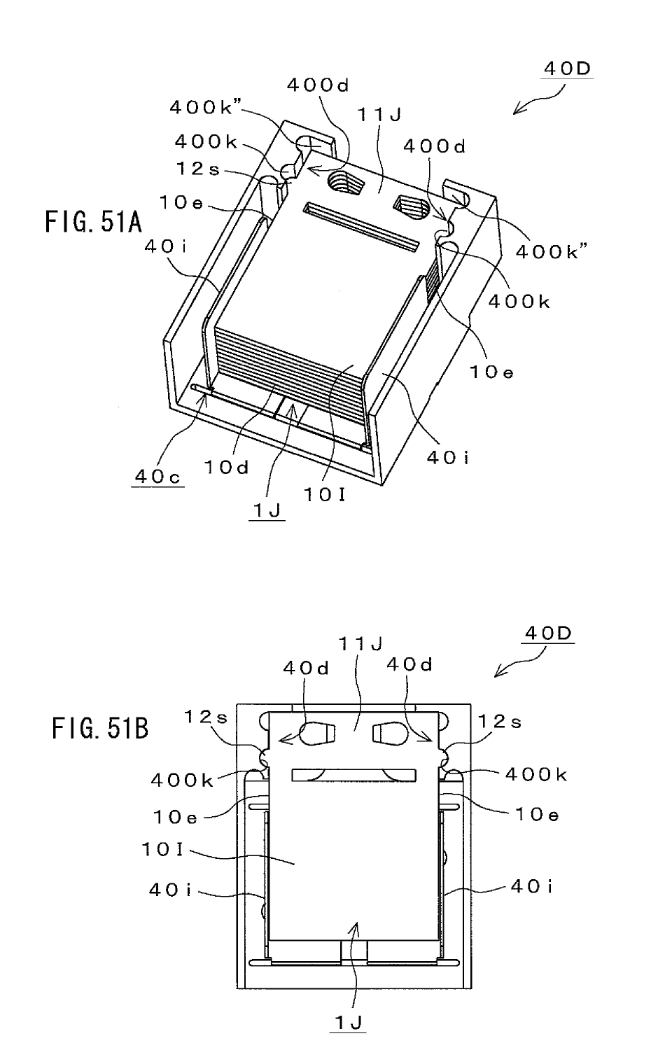

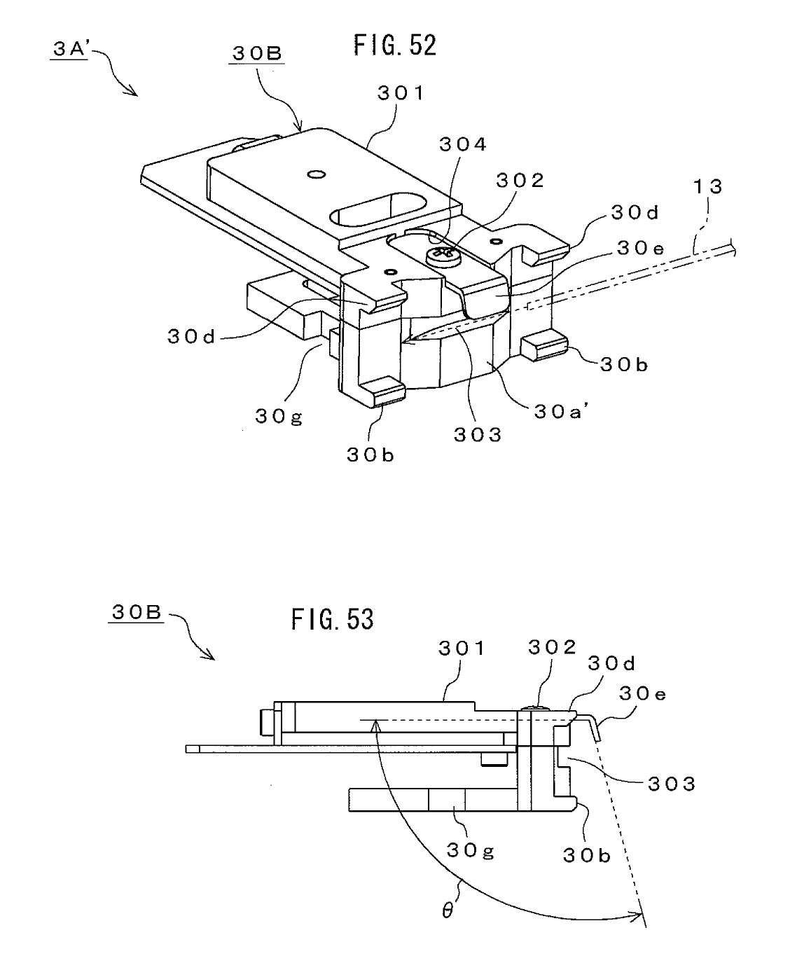

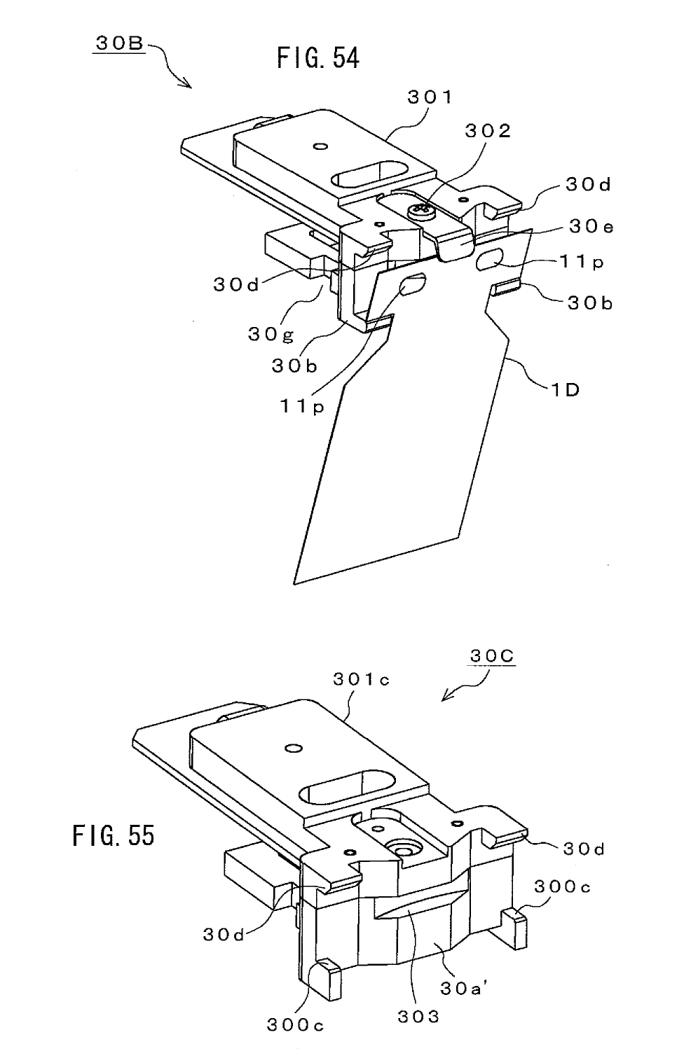

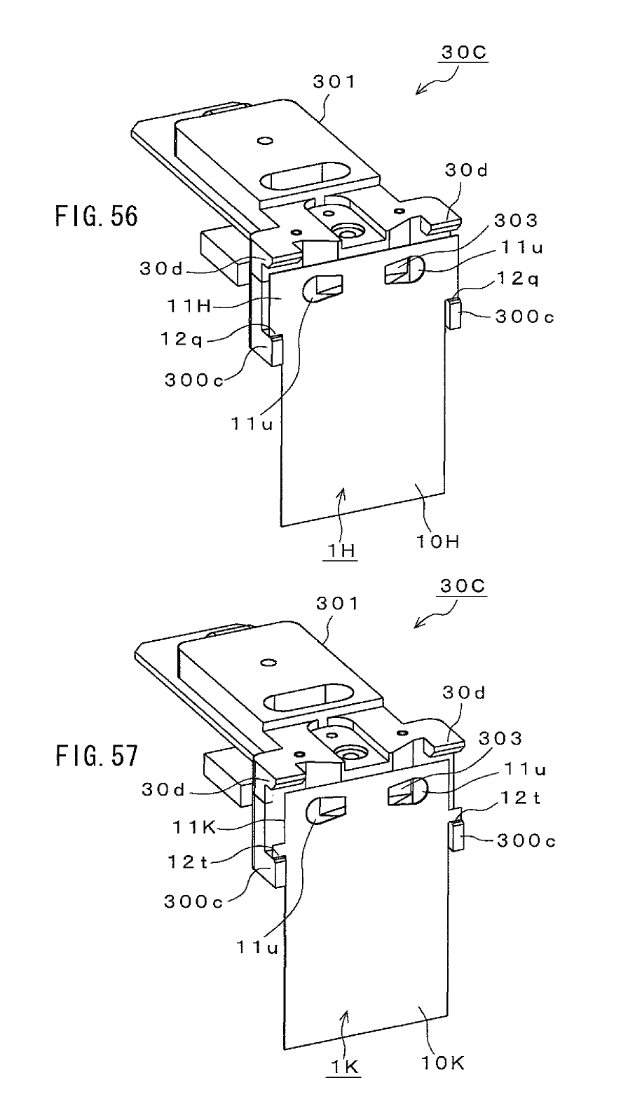

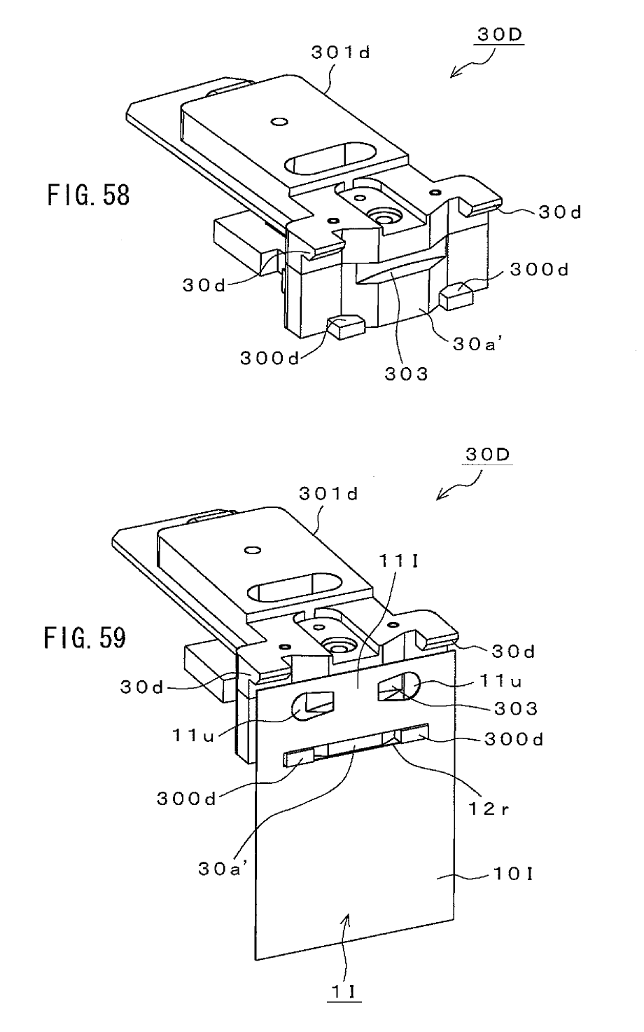

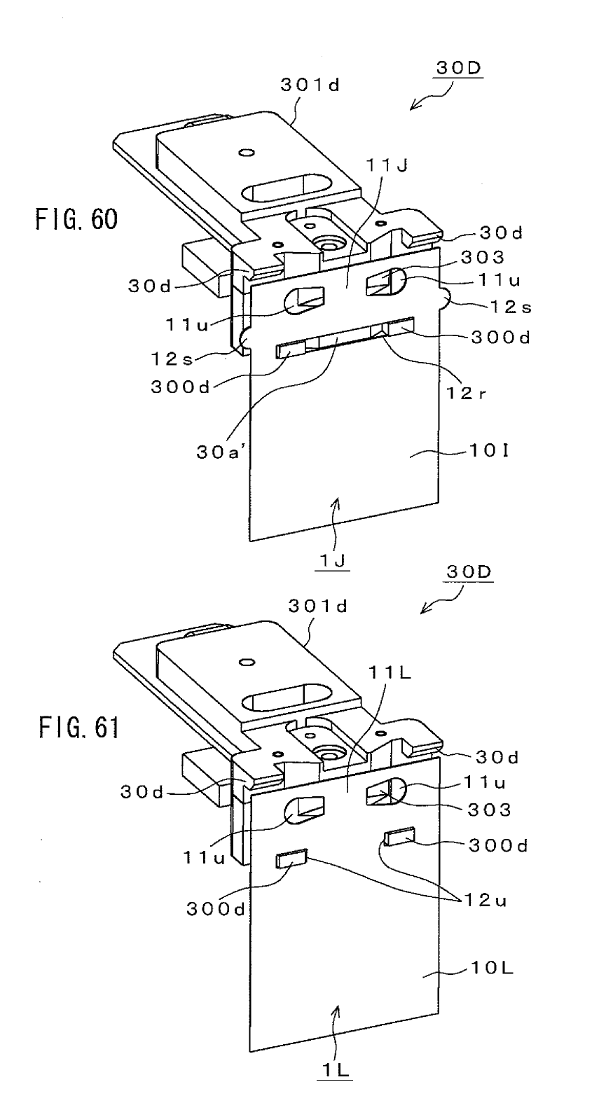

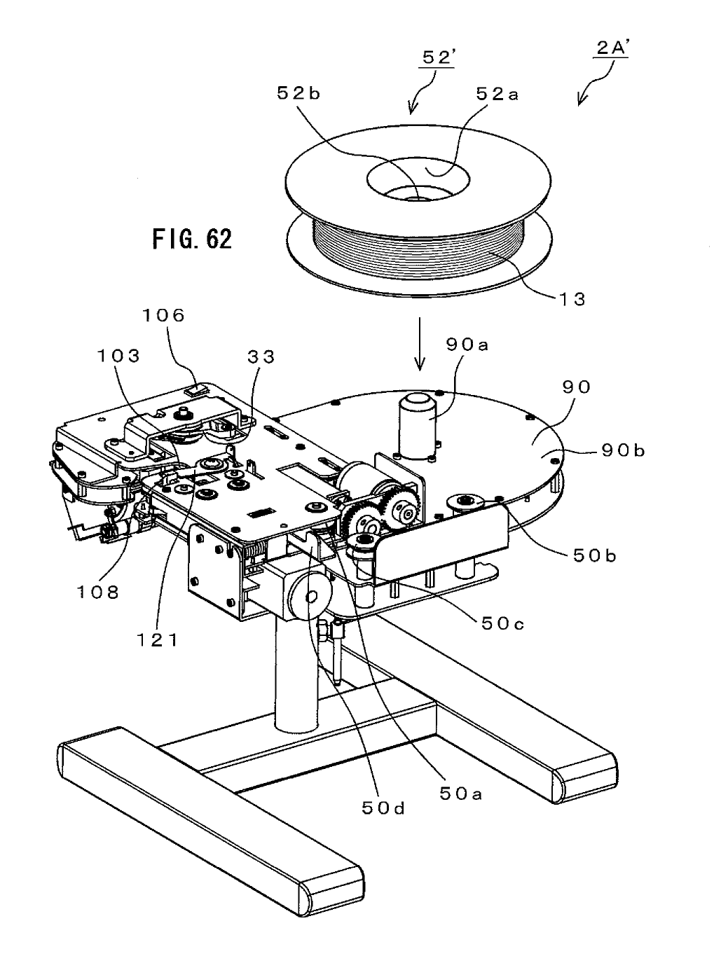

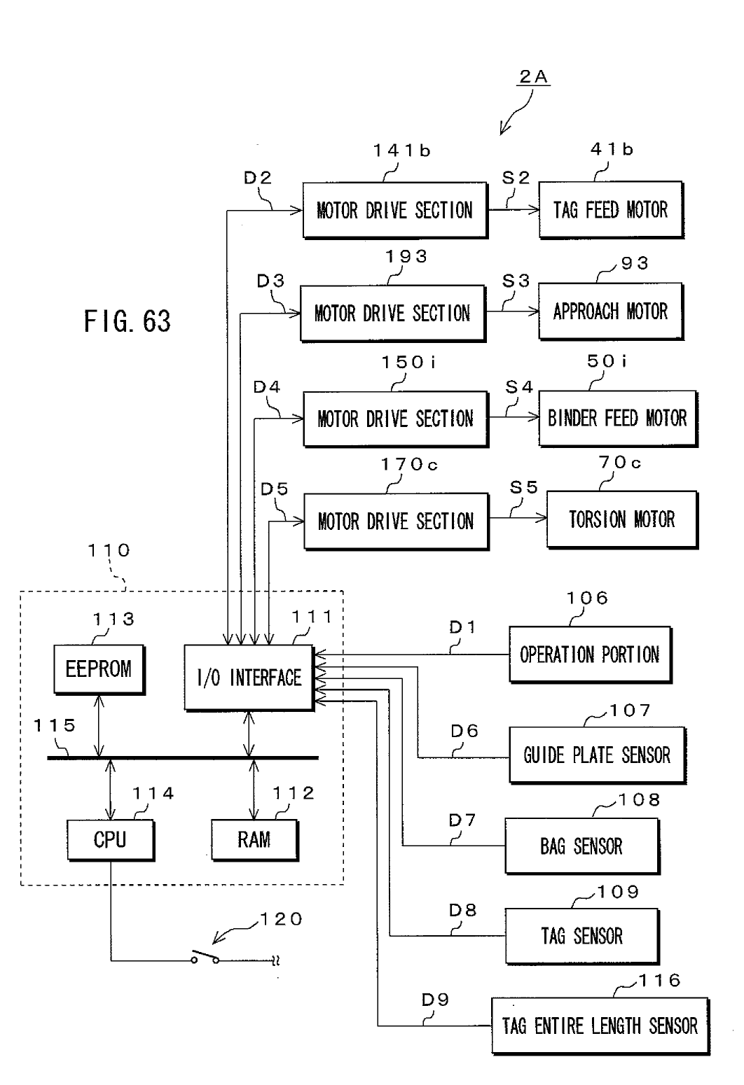

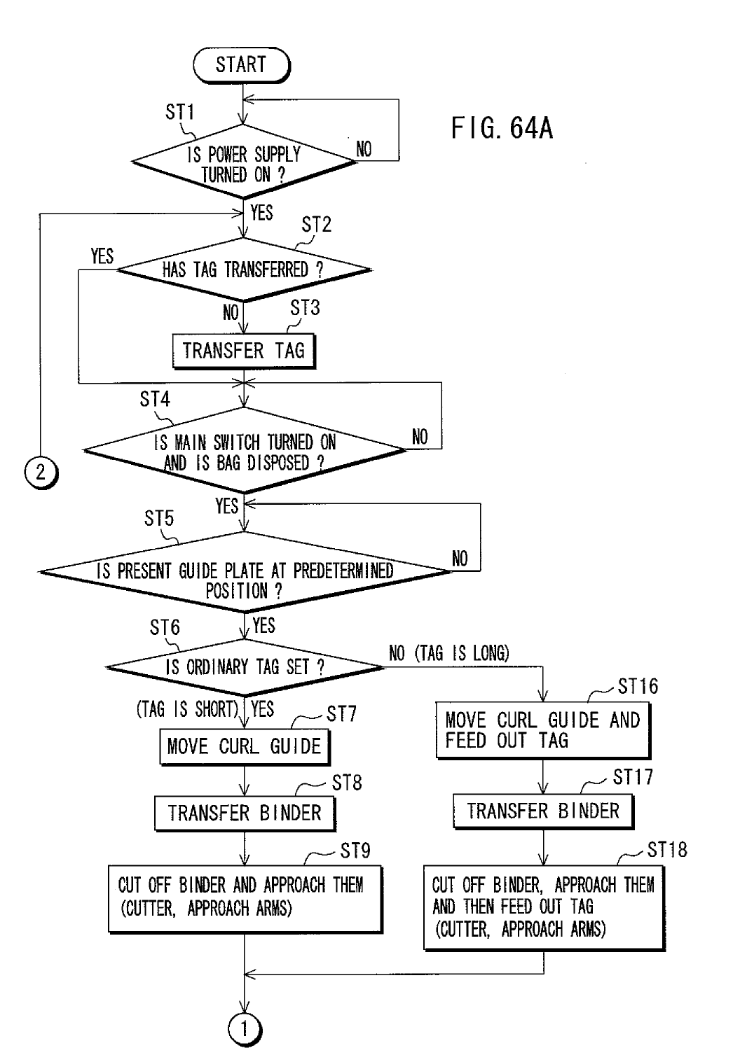

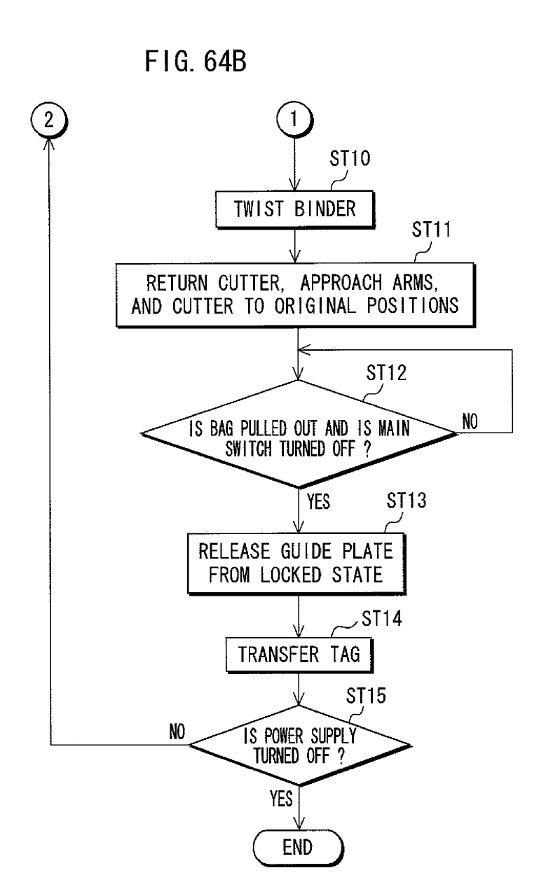

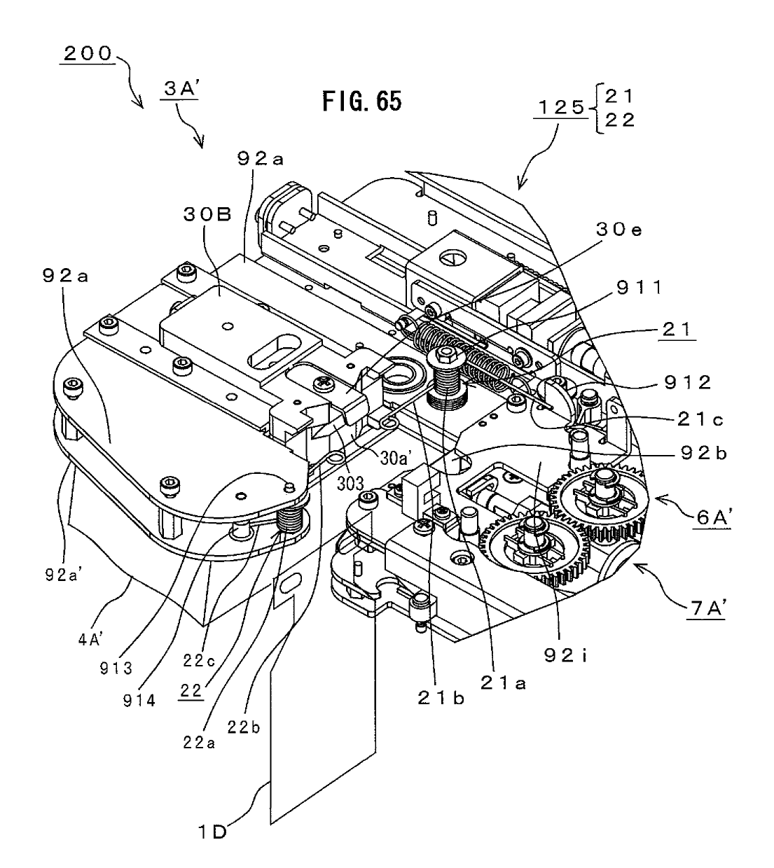

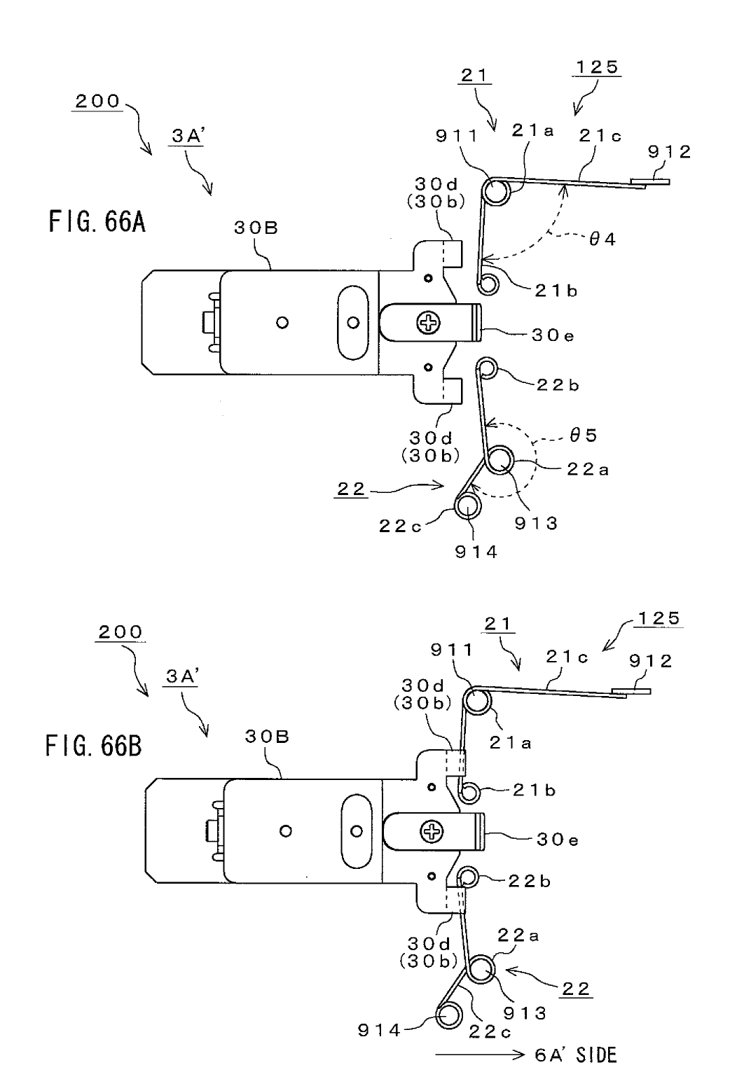

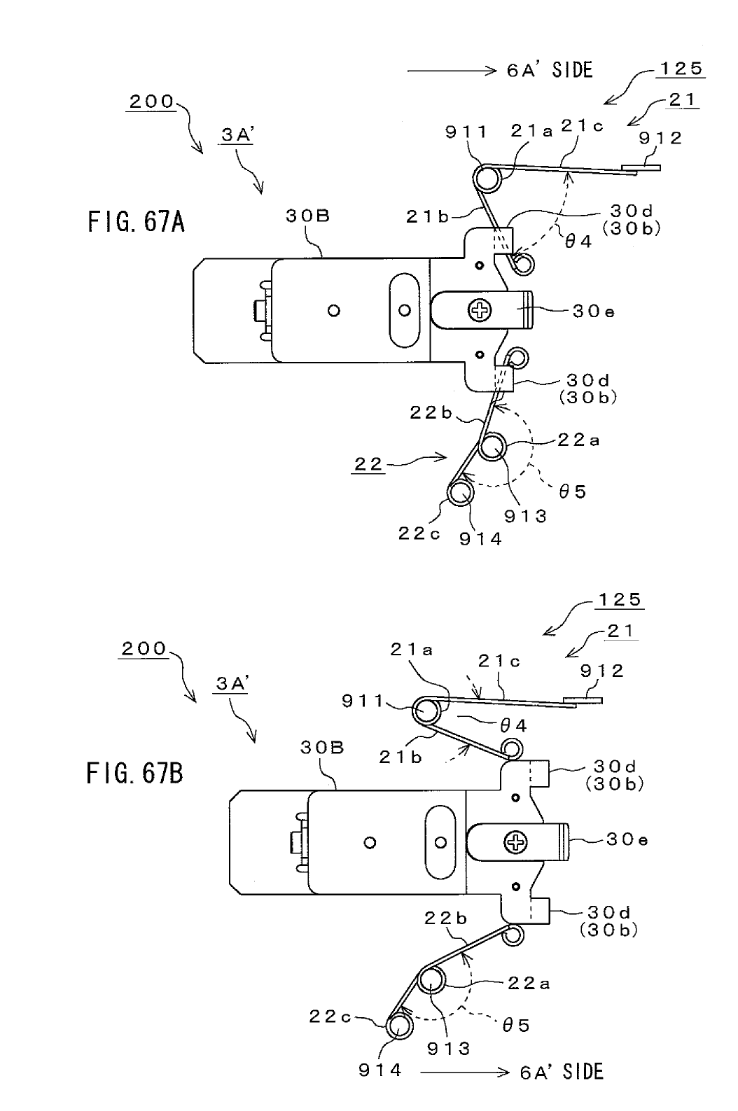

### BRIEF DESCRIPTION OF THE DRAWINGS

[FIG. 1A] is a plan view showing one example of a tag of a first embodiment.

[FIG. 1B] is a perspective view showing the one example of the tag of the first embodiment.

[FIG. 2] is a perspective view showing one example of a binder which is used for the tag of the present embodiment.

[FIG. 3A] is a perspective view showing one example of a usage type of the tag of the first embodiment.

[FIG. 3B] is a perspective view showing one example of a usage type of a tag of a second embodiment.

[FIG. 4A] is a plan view showing one example of the tag of the second embodiment.

[FIG. 4B] is a perspective view showing the one example of the tag of the second embodiment.

[FIG. 5A] is a plan view showing one example of a tag of a third embodiment.

[FIG. 5B] is a perspective view showing the one example of the tag of the third embodiment.

[FIG. 6] is a plan view showing an example of a function of the tag of the third embodiment.

[FIG. 7A] is a plan view showing one example of a tag of a fourth embodiment.

[FIG. 7B] is a plan view showing one example of a tag of a fifth embodiment.

[FIG. 8A] is a plan view showing one example of a tag of a sixth embodiment.

[FIG. 8B] is a plan view showing one example of a tag of a seventh embodiment.

[FIG. 9A] is an explanatory diagram showing a condition before punching in a process of manufacturing a tag 1F.

[FIG. 9B] is an explanatory diagram showing a condition after punching in the process of manufacturing the tag 1F.

[FIG. 10A] is a plan view showing one example of a tag of an eighth embodiment.

[FIG. 10B] is a perspective view showing the one example of the tag of the eighth embodiment.

[FIG. 11A] is a plan view showing one example of a tag of a ninth embodiment.

[FIG. 11B] is a perspective view showing the one example of the tag of the ninth embodiment.

[FIG. 12A] is a plan view showing one example of a tag of a tenth embodiment.

[FIG. 12B] is a perspective view showing the one example of the tag of the tenth embodiment.

[FIG. 13A] is a plan view showing one example of a tag of an eleventh embodiment.

[FIG. 13B] is a perspective view showing the one example of the tag of the eleventh embodiment.

[FIG. 14A] is a plan view showing one example of a tag of a twelfth embodiment.

[FIG. 14B] is a perspective view showing the one example of the tag of the twelfth embodiment.

[FIG. 15] is a perspective view showing an overall configuration of a binding machine of the present embodiment.

[FIG. 16] is a perspective view showing a configuration of main components of the binding machine of the present embodiment.

[FIG. 17] is a plan view showing the configuration of the main components of the binding machine of the present embodiment.

[FIG. 18A] is a plan view of a major portion showing a configuration of a tag hold mechanism and a state before a curl guide operates.

[FIG. 18B] is a plan view of the major portion showing the configuration of the tag hold mechanism and the state in which the curl guide is progressing.

[FIG. 19A] is a perspective view of the major portion showing the configuration of the tag hold mechanism and the state before the curl guide operates.

[FIG. 19B] is a perspective view of the major portion showing the configuration of the tag hold mechanism and the state where the curl guide is progressing.

[FIG. 20A] is a perspective view showing one example of the curl guide.

[FIG. 20B] is a side view showing the example of the curl guide.

[FIG. 20C] is a plan view showing the example of the curl guide.

[FIG. 21] is a cross-sectional view taken along lines A-A of FIG. 20B showing one example of a binder passage.

[FIG. 22] is an enlarged view of a portion B in FIG. 21 showing the one example of the binder passage.

[FIG. 23] is a cross-sectional view taken along lines C-C of FIG. 20C showing one example of a binder take-out slit.

[FIG. 24A] is an enlarged view of a portion D showing a configuration of the binder take-out slit and its operations before binder take-out.

[FIG. 24B] is an enlarged view of the portion D showing the configuration of the binder take-out slit and its operations during binder take-out.

[FIG. 25A] is an operation explanatory diagram showing changes in shape of the tag by the tag-holding operation of the curl guide.

[FIG. 25B] is an operation explanatory diagram showing changes in shape of the tag by the tag-abutting operation of the curl guide.

[FIG. 26A] is a perspective view of a major portion showing a configuration and operations of a cutter before cutting.

[FIG. 26B] is a perspective view of the major portion showing the configuration and the operations of the cutter after cutting.

[FIG. 27] is a perspective view of a major portion showing a configuration and operations of a binder-fastening mechanism.

[FIG. 28] is a perspective view showing a configuration example of a drive mechanism for a working plate.

[FIG. 29] is an operation explanatory diagram showing the binding machine in a process of forming a transfer passage for the binder.

[FIG. 30] is an operation explanatory diagram showing the binding machine in a process of transferring the binder.

[FIG. 31] is an operation explanatory diagram showing the binding machine in a process of forming the binder.

[FIG. 32] is an operation explanatory diagram showing the binding machine in a process of fastening the binder.

[FIG. 33] is an operation explanatory diagram showing the binder in a process of returning various portions to their origins and releasing a bound bag.

[FIG. 34] is a perspective view showing a configuration example of a binding machine 2A′ of the present embodiment.

[FIG. 35A] is a perspective view showing an example of movement of a tag 1D by the binding machine 2A′.

[FIG. 35B] is a perspective view showing an example of insertion operation of a binder 13 to the tag 1D by the binding machine 2A′.

[FIG. 35C] is a perspective view showing an example of formation of the binder 13 by the binding machine 2A′.

[FIG. 35D] is a perspective view showing an example of fastening of a binder 13′ by the binding machine 2A′.

[FIG. 36] is a perspective view showing an example of mounting of the tag 1D.

[FIG. 37] is a top view showing a configuration and an operation example of the binding machine 2A′ in a standby state.

[FIG. 38] is a top view showing the configuration and the operation example of the binding machine 2A′ in a bound condition.

[FIG. 39] is a top view showing a configuration of the major portion and an operation example of the binding machine 2A′ in the standby state.

[FIG. 40] is atop view showing the configuration of the major portion and the operation example of the binding machine 2A′ in the bound condition.

[FIG. 41A] is a perspective view showing a configuration example of a tag transfer mechanism 4A′ in a condition where a guide flap 42a is closed.

[FIG. 41B] is a perspective view showing a configuration example of the tag transfer mechanism 4A′ in a condition where the guide flap 42a is open.

[FIG. 42A] is a top view showing an operation example of a curl guide 30B of the tag transfer mechanism 4A′ in a condition where the guide flap 42a is closed.

[FIG. 42B] is a top view showing an operation example of the curl guide 30B of the tag transfer mechanism 4A′ in a condition where the guide flap 42a is open.

[FIG. 43A] is a perspective view showing a condition before a cartridge 40B is mounted and before the tag 1D is fed out by the tag transfer mechanism 4A′.

[FIG. 43B] is a perspective view showing a condition after the tag 1D is fed out by the tag transfer mechanism 4A′.

[FIG. 44A] is a perspective view showing an example where the curl guide 30B is disposed to the tag 1D fed out by the tag transfer mechanism 4A′.

[FIG. 44B] is a perspective view showing an example where the tag 1D is transferred by the curl guide 30B of the tag transfer mechanism 4A′.

[FIG. 45A] is a bottom-side perspective view showing a configuration example of the cartridge 40B.

[FIG. 45B] is a top-side perspective view showing a configuration example of the cartridge 40B.

[FIG. 46A] is a perspective view showing an example of functions of the cartridge 40B in a condition where the tags 1D are stored.

[FIG. 46B] is a top view showing the example of functions of the cartridge 40B in a condition where the tags 1D are stored.

[FIG. 47A] is a perspective view showing a configuration of the major portion of a tag position adjustment portion 40c and an example of separating tag width adjustment plates 40i from each other.

[FIG. 47B] is a top view showing the configuration of the major portion of the tag position adjustment portion 40c and the example of separating the tag width adjustment plates 40i from each other.

[FIG. 48A] is a perspective view showing the configuration of the major portion of the tag position adjustment portion 40c and an example of approximating the tag width adjustment plates 40i to each other.

[FIG. 48B] is a top view showing the configuration of the major portion of the tag position adjustment portion 40c and the example of approximating the tag width adjustment plates 40i to each other.

[FIG. 49A] is a perspective view showing an example of functions of the cartridge 40B in a condition where tags 1H are stored.

[FIG. 49B] is a top view showing the example of the functions of the cartridge 40B in a condition where the tags 1H are stored.

[FIG. 50A] is a perspective view showing an example of functions of a cartridge 40C.

[FIG. 50B] is a top view showing the example of the functions of the cartridge 40C.

[FIG. 51A] is a perspective view showing an example of functions of a cartridge 40D.

[FIG. 51B] is a top view showing the example of the functions of the cartridge 40C.

[FIG. 52] is a perspective view showing a configuration example of the curl guide 30B in a tag hold mechanism 3A.

[FIG. 53] is a side view showing a configuration example of the curl guide 30B in a condition where a tag support is attached.

[FIG. 54] is a perspective view showing a comparative example (at the time of supporting) about a tag support member 30e in the curl guide 30B.

[FIG. 55] is a perspective view showing a configuration example of a curl guide 30C.

[FIG. 56] is a perspective view showing an example where the tag 1H is held in the curl guide 30C.

[FIG. 57] is a perspective view showing an example where a tag 1K is held in the curl guide 30C.

[FIG. 58] is a perspective view showing a configuration example of a curl guide 30D.

[FIG. 59] is a perspective view showing an example where a tag 1I is held in the curl guide 30D.

[FIG. 60] is a perspective view showing an example where a tag 1J is held in the curl guide 30D.

[FIG. 61] is a perspective view showing an example where a tag 1L is held in the curl guide 30D.

[FIG. 62] is a perspective view showing a condition where a bobbin 52′ is detached from a binding machine 2A′.

[FIG. 63] is a block diagram showing a configuration example of a control system of the binding machine 2A′.

[FIG. 64A] is a flowchart (part 1) showing an example of operations of the binding machine 2A′.

[FIG. 64B] is a flowchart (part 2) showing the example of the operations of the binding machine 2A′.

[FIG. 65] is a partially enlarged perspective view showing a configuration example of a tag spring support mechanism 125 of a binding machine 200 as a second embodiment.

[FIG. 66A] is a top view showing the tag spring support mechanism 125 in the standby time thereof and a standby example of the tag hold mechanism 3A′ before the tag is mounted.

[FIG. 66B] is a top view showing an example of deformation operations of the tag spring support mechanism 125 after the tag is mounted.

[FIG. 67A] is a top view showing an example of the deformation (earlier deformation) operations of the tag spring support mechanism 125 during transfer of the tag.

[FIG. 67B] is a top view showing an example of the deformation (later deformation) operations of the tag spring support mechanism 125 during transfer of the tag.

### BEST MODE FOR CARRYING OUT THE INVENTION

It is an object of the present invention to provide a tag that keeps its orientation stably in a condition where it is attached to a mounted target and that enables recognizing of information securely and a method for manufacturing the same.

A description will be given of the tag and the method for manufacturing the same of the present invention with reference to the drawings.

### Configuration Examples of Tag of the Present Embodiments

A description will be given of one example of the tag of a first embodiment with reference to FIGS. 1A and 1B. Further, a description will be given of one example of a binder which is used for the tag of the present embodiment with reference to FIG. 2. Further, a description will be given of one example of a usage type of the tag of the present embodiment with reference to FIGS. 3A and 3B.

A tag 1A of the first embodiment shown in FIG. 1A is comprised of an information-showing portion 10A, a mounting portion 11A, and a coupling portion 12A which are formed integrally by using a thin sheet material such as paper or plastic so that it is attached to a mounted target such as a bag 14 (see FIG. 3) by a binder 13.

The information-showing portion 10A has, for example, a square shape, on which various kinds of information are represented through printing, etc. Further, a sticker on which the various kinds of information are printed may be attached. Further also, inscribed information such as braille may be written.

The mounting portion 11A has catching holes 11m at two positions, which are caught by the binder 13. The catching holes 11m are one example of catching portions and given by forming two through holes with a predetermined spacing therebetween in the horizontal direction of the tag 1A, assuming that the longitudinal direction of the tag 1A is a vertical direction.

The binder 13, which attaches the tag 1A to the bag 14, is generally referred to as a twist tie, etc. and as shown in FIG. 2, it is comprised of a flexible thin wire 13a, which serves as a core wire made of metal or resin, covered by a covering material 13b such as resin or paper and is shaped like a narrow tape. Each of the catching holes 11m in the binder 13 has such a diameter that the binder 13 can be inserted.

The coupling portion 12A couples the mounting portion 11A and the information-showing portion 10A with a concave portion (engagement portion) 12m being formed by notching portions of both sides of the information-showing portion 10A into predetermined shapes so that a width thereof is smaller than that of the information-showing portion 10A.

Next, a description will be given of one example of a tag of a second embodiment with reference to FIGS. 4A and 4B.

A tag 1B of the second embodiment is comprised of an information-showing portion 10B, a mounting portion 11B, and a coupling portion 12B which are formed integrally by using a thin sheet material such as paper or plastic. This tag 1B is attached to a mounted target such as a bag 14 as shown in FIG. 3B by the binder 13 shown in FIG. 2.

The information-showing portion 10B has, for example, a square shape, on which various kinds of information are represented through printing, etc. Further, a sticker on which the various kinds of information are printed may be attached. Further also, inscribed information such as braille may be written.

The mounting portion 11B has catching grooves 11n at two positions, which are caught by the binder 13. The catching grooves 11n are one example of catching portions and given by forming two grooves with a predetermined spacing therebetween in the horizontal direction of the tag 1B, assuming that the longitudinal direction of the tag 1B is a vertical direction. Each of the catching grooves 11n has a width over which the binder 13 passes with an opening thereof facing outward. It should be noted that the opening may face upward.

The coupling portion 12B couples the mounting portion 11B and the information-showing portion 10B with a concave portion 12m being formed by notching portions of both sides of the information-showing portion 10B into predetermined shapes so that a width thereof is smaller than that of the information-showing portion 10B.

### Usage Examples of Tag of the Present Embodiments

Next, a description will be given of a usage type of the tag 1A of the first embodiment with reference to drawings. As shown in FIG. 3A, one binder 13 is passed through the catching holes 11m at the two positions in the tag 1A. The binder 13 passed through the catching holes 11m in the tag 1A is wound around a binding portion 14a which is arranged so as to squeeze a predetermined portion near a top of the bag 14, so that the binding portion 14a of the bag 14 may be bound by twisting its both ends for fastening.

Since the binder 13 is passed through the catching holes 11m, by binding the binding portion 14a of the bag 14 with the binder 13, the tag 1A is attached to the bag 14a with a portion between the catching holes 11m in the mounting portion 11A being sandwiched between the binder 13 and the bag 14.

Since the binder 13 is passed through the catching holes 11m at the two positions, by binding the binding portion 14a of the bag 14 with the binder 13, in the tag 1A, the information-showing portion 10A is oriented vertically along the bag 14, not horizontally.

Further, in the tag 1A, the binder 13 is wound around the binding portion 14a which is arranged so as to squeeze the bag 14, so that the mounting portion 11A thereof is curved. However, between the mounting portion 11A and the information-showing portion 10A, the concave portion 12m is formed in both sides of the information-showing portion 10A, thereby coupling them to each other over a width of the coupling portion 12A that is smaller than that of the information-showing portion 10A. Accordingly, the information-showing portion 10A does not conform to a shape of the mounting portion 11A so that the information-showing portion 10A is not greatly curved. Accordingly, it becomes not difficult for the information written on the information-showing portion 10A of the tag 1A to be recognized because of the curving.

Then, the appearance when the tag 1A is mounted to the bag 14 may be improved because the information-showing portion 10A is oriented vertically along the bag 14 without being curved.

Next, a description will be given of a usage type of the tag 1B of the second embodiment with reference to drawings. As shown in FIG. 3B, one binder 13 is passed through the catching grooves 11n at the two positions in the tag 1B. The binder 13 passed through the catching grooves 11n in the tag 1B is wound around the binding portion 14a which is arranged so as to squeeze a predetermined portion near the top of the bag 14, so that the binding portion 14a of the bag 14 may be bound by twisting its both ends for fastening.

Since the binder 13 is passed through the catching grooves 11n, by binding the binding portion 14a of the bag 14 with the binder 13, the tag 1B is attached to the bag 14 with a portion between the catching grooves 11n in the mounting portion 11B being sandwiched between the binder 13 and the bag 14.

Since, as is the case of the tag 1A, the binder 13 is passed through the catching grooves 11n at the two positions, by binding the binding portion 14a of the bag 14 with the binder 13, in the tag 1B, the information-showing portion 10A is oriented vertically along the bag 14, not horizontally.

Further, in the tag 1B, the binder 13 is wound around the binding portion 14a which is arranged so as to squeeze the bag 14, so that the mounting portion 11B thereof is curved. However, between the mounting portion 11B and the information-showing portion 10B, the concave portion 12m is formed in both sides of the information-showing portion 10B, thereby coupling them to each other over a width of the coupling portion 12B that is smaller than that of the information-showing portion 10B. Therefore, the information-showing portion 10B does not conform to a shape of the mounting portion 11B so that the information-showing portion 10B is not greatly curved. Accordingly, it becomes not difficult for the information written on the information-showing portion 10B of the tag 1B to be recognized because of the curving.

Then, the appearance when the tag 1B is mounted to the bag 14 may be improved because the information-showing portion 10B is oriented vertically along the bag 14 without being curved.

Here, the binder 13 is passed through the open catching grooves 11n but in a condition where the bag 14 is bound with the binder 13, the tag 1B is caught because the binder 13 is fitted into the grooves, so that the tag 1B is not so easily detached from the bag 14. On the other hand, if the binder 13 binding the bag 14 is loosened, the tag 1B can easily be detached from the binder 13, so that the tag 1B rendered useless can be easily removed without detaching the binder 13.

Next, a description will be given of one example of a tag of a third embodiment with reference to FIGS. 5A and 5B. A tag 1C of the third embodiment shown in FIGS. 5A and 5B is comprised of an information-showing portion 10C, a mounting portion 11A, and a coupling portion 12C which are formed integrally by using a thin sheet material such as paper or plastic so that it is attached to a mounted target such as the bag 14 by a binder 13. It should be noted that identical reference symbols and numerals are given to identical components of the tags of the first and second embodiments, a detailed description of which will be omitted.

The information-showing portion 10C is provided so that its region is, for example, a substantially hexagon-shaped region (region delimited by a dash-and-two-dots line 10C′), on which various kinds of information are represented through printing, etc. Further, a sticker on which the various kinds of information are printed may be attached. Further also, inscribed information such as braille may be written.

The mounting portion 11A has catching holes 11m at two positions, which are caught by the binder 13. The catching holes 11m are one example of catching portions and given by forming two through holes with a predetermined spacing therebetween in the horizontal direction of the tag 1A, assuming that the longitudinal direction of the tag 1A is a vertical direction.

The coupling portion 12C couples the mounting portion 11A and the information-showing portion 10C with a concave portion 12n being formed by notching portions of both sides of the information-showing port ion 10C into predetermined shapes so that a width thereof is smaller than that of the information-showing portion 10C.

The concave portions 12n of the tag 1C are formed so that a total sum of an angle θ1 between a side 10Ca of the concave portion 12n on a side of the information-showing portion 10C and a side 12Ca of the concave portion 12n on a side of the coupling portion 12C and an angle θ2 between a side 11Ae of the concave portion 12n on a side of the mounting portion 11A and the side 12Ca of the concave portion 12n on the side of the coupling portion 12C is greater than 180 degrees. In this example, of these angles θ1 and θ2, the angle θ1 on a side positioned at a rear side along a tag feeding direction is arranged to be an obtuse angle.

For example, the tag 1C is formed so that the angle θ1 has an obtuse angle of about 130 degrees, the angle θ2 has substantially a right angle of about 90 degrees, and the total sum of the angles θ1 and θ2 may be about 220 degrees. Accordingly, when feeding out one of the stacked tags 1C, if the side 10Ca of the concave portion 12n and the side 11Ae intersect and come in sliding contact with each other, the sides 10Ca and 11Ae slide obliquely without meshing with each other.

A description will be given of an example of the functions of the tag 1C of the third embodiment with reference to FIG. 6. The tags 1C shown in FIG. 6 is shown so that the lowest tag 1C′ is fed out of the stacked state thereof. In this case, the tags 1C′ and 1C are each formed so that the total sum of the angles θ1 and θ2 is about 220 degrees. Accordingly, when feeding out the lowest tag 1C′, if the side 10Ca of the concave portion 12n of the tag 1C′ and the sides 11Ae and 11Ad of the concave portion 12n of the tag 1C intersect and come in sliding contact with each other, the sides 10Ca and the sides 11Ae and 11Ad slide obliquely without meshing with each other. Therefore, the concave portion 12n in the tag 1C′ fed out first is not caught in the concave portion 12n in the tag 1C to be fed out next, thus making it possible to feed out only one of the stacked tags 1C′ smoothly.

Next, a description will be given of one example of each of the tags of fourth and fifth embodiments with reference to FIGS. 7A and 7B. A tag 1D of the fourth embodiment shown in FIG. 7A is comprised of an information-showing portion 10C, a mounting portion 11D, and a coupling portion 12C which are formed integrally by using a thin sheet material such as paper or plastic so that it is attached to a mounted target such as a bag 14 by a binder 13. It should be noted that identical reference symbols and numerals are given to identical components of the tags of the first through third embodiments, a detailed description of which will be omitted.

The information-showing portion 10C shown in FIG. 7A is provided so that its region is, for example, a substantially hexagon-shaped region, on which various kinds of information are represented through printing, etc. Further, a sticker on which the various kinds of information are printed may be attached. Further also, inscribed information such as braille may be written.

The mounting portion 11D has catching holes 11p at two positions, which are caught by the binder 13. The catching holes 11p are one example of catching portions and given by forming two through holes with a predetermined spacing therebetween in the horizontal direction of the tag 1D, assuming that the longitudinal direction of the tag 1D is a vertical direction. The through holes each has a shape like a long hole extended along a direction in which the mounting portion 11D extends. By thus forming each of the catching holes 11p into a long hole shape, when binding the small bag 14 at the top thereof, the binding diameter can be made smaller than that of the tag 1C, so that the bag can be tied at the top sufficiently. It should be noted that the long hole shape may be replaced with the shape of an ellipse or a rectangle.

An information-showing portion 10E (region delimited by a dash-and-two-dots line 10E′) of a tag 1E of the fifth embodiment shown in FIG. 7B has, for example, a substantially circular shape, on which various kinds of information are represented through printing, etc. Further, a sticker on which the various kinds of information is printed may be attached. Further also, inscribed information such as braille may be written.

The mounting portion 11D has the catching holes 11p at two positions, which are caught by the binder 13. The catching holes 11p are one example of catching portions and given by forming two through holes with a predetermined spacing therebetween in the horizontal direction of the tag 1D, assuming that the longitudinal direction of the tag 1E is a vertical direction. The through holes each has a shape like a long hole extended horizontally.

The coupling portion 12C couples the mounting portion 11D and the information-showing portion 10E to each other with its width being smaller than that of the information-showing portion 10E having the circular shape. This causes the concave portions 12p to be formed.

The concave portions 12p of the tag 1E are formed so that a total sum of an angle θ3 between an arc S of the concave portion 12p on a side of the information-showing portion 10E and a side 12Ca of the concave portion 12p on a side of the coupling portion 12C and an angle θ2 between a side 11Ae of the concave portion 12p on a side of the mounting portion 11D and the side 12Ca of the concave portion 12p on the side of the coupling portion 12C is greater than 180 degrees.

Accordingly, when feeding out one of the stacked tags 1E, if the arc S of the concave portion 12p and the side 11Ae intersect and come in sliding contact with each other, the arc S and the side 11Ae may slide obliquely without meshing with each other.

Next, a description will be given of one example of each of the tags of sixth and seventh embodiments with reference to FIGS. 8A and 8B. A tag 1F of the sixth embodiment shown in FIG. 8A is comprised of an information-showing portion 10C, a mounting portion 11F, and a coupling portion 12C which are formed integrally by using a thin sheet material such as paper or plastic so that it is attached to a mounted target such as a bag 14 by a binder 13. It should be noted that identical reference symbols and numerals are given to identical components of the tags of the first through fifth embodiments, a detailed description of which will be omitted.

The information-showing portion 10C shown in FIG. 8A is provided so that its region is, for example, a substantially hexagon-shaped region, on which various kinds of information are represented through printing, etc. Further, a sticker on which the various kinds of information are printed may be attached. Further also, inscribed information such as braille may be written.

The mounting portion 11F has catching holes 11q at two positions, which are caught by the binder 13. The catching holes 11q are one example of catching portions and given by forming two through holes with a predetermined spacing therebetween in the horizontal direction of the tag 1F, assuming that the longitudinal direction of the tag 1F is a vertical direction. The through holes have respectively a shape like a long hole extended in the horizontal direction and include a slit 11r. The slit 11r is provided so as to extend peripherally and horizontally in the tag 1F from a center of the long hole shape.

By thus forming the slit 11r, in a process of manufacturing the tags 1F by punching an original fabric sheet, which is material of the tags 1F, the residue given as a result of punching the tags 1F to form the catching holes 11q can be coupled with this original fabric sheet.

A mounting portion 11G of a tag 1G shown in FIG. 8B has catching holes 11s at two positions, which are caught by the binder 13. The catching holes 11s are one example of catching portions and given by forming two through holes with a predetermined spacing therebetween in the horizontal direction of the tag 1G, assuming that the longitudinal direction of the tag 1G is a vertical direction. The catching holes 11s respectively have a shape like a long hole extended along the horizontal direction and include a slit 11t. The slit 11t is provided so as to extend peripherally in the tag 1G and vertically (upward in the figure) in the tag 1G from a center of the long hole shape. In such a manner, the slit 11t maybe formed which has a different shape from the slit 11r shown in FIG. 8A.

Next, the process of manufacturing a tag 1F will be described with reference to FIGS. 9A and 9B. An original fabric sheet 88 shown in FIG. 9A is in a state in which the tag 1F has not punched yet. First, a metal mold of the tag 1F is formed. Next, this metal mold of the tag 1F is pushed against the original fabric sheet 88, to punch the tag 1F as indicated by a broken line. An original fabric sheet 88′ shown in FIG. 9B is in a state in which one of the tags 1F is punched. To the original fabric sheet 88′ from which the one of the tags 1F is punched, punch-out residues 11q′ of the catching holes 11q are coupled via coupling portions 11r′ so that a disposal of the punch-out residues 11q′ of the catching holes 11q is made easy. Further, since the punch-out residues 11q′ of the catching holes 11q are pulled by the original fabric sheet 88′, the catching holes 11q can be punched securely.

Next, a description will be given of one example of a tag of an eighth embodiment with reference to FIGS. 10A and 10B. A tag 1H of the eighth embodiment shown in FIGS. 10A and 10B is comprised of an information-showing portion 10H, a mounting portion 11H, and a coupling portion 12H which are formed integrally by using a thin sheet material such as paper or plastic so that it is attached to a mounted target such as a bag 14 by a binder 13.

The information-showing portion 10H is provided so that its region is, for example, a substantially rectangle-shaped region (region delimited by the coupling portion 12H indicated by a dash-and-two-dots line), on which various kinds of information are represented through printing, etc. Further, a sticker on which the various kinds of information are printed may be attached. Further also, inscribed information such as braille may be written.

The coupling portion 12H corresponds to a boundary between the information-showing portion 10H and the mounting portion 11H and couples the information-showing portion 10H and the mounting portion 11H with each other. Assuming that the longitudinal direction of the tag 1H is a vertical direction and the latitudinal direction of the tag 1H is a horizontal direction, the length (horizontal width) of the coupling portion 12H is equal to the length (horizontal width) of the information-showing portion 10H.

The mounting portion 11H is coupled to the information-showing portion 10H through this coupling portion 12H. The horizontal width of the mounting portion 11H is formed to be greater than that of the information-showing portion 10H. That is, the mounting portion 11H has both the horizontal ends projecting from both the horizontal ends of the information-showing portion 10H. Both the horizontal ends thus projected are used as catching portions 12q, 12q. The catching portion 12q at each of the both ends is used when the tag 1H is held by the curl guide 30C shown in FIG. 55.

The mounting portion 11H has catching holes 11u at two positions, which are caught by the binder 13. The catching holes 11u are one example of catching portions and given by forming two through holes with a predetermined spacing therebetween in the horizontal direction of the tag 1H. These right and left catching holes 11u respectively have a shape of a horizontally long hole extended along a direction in which the mounting portion 11H extends. In this example, this shape of the horizontally long hole has a shape whose vertical width increases along the direction in which the mounting portion 11H extends. Further, the shape of the horizontally long hole in these catching holes 11u has a portion where the catching holes 11u face each other, which is formed substantially perpendicular to that extending direction. That is, the catching holes 11u each includes a vertical portion 110u. When fastening the tape-shaped (band-like) binder 13 (see FIG. 10B), a tape-shaped covering material 13b abuts against the face of this vertical portion 110u of the catching hole 11u.

Accordingly, the catching holes 11u including the vertical portions 110u can have less stress applied by the covering material 13b of the binder 13 compared with, for example, the circular catching holes 11m shown in FIGS. 5A and 5B and the rectangle-shaped catching holes 11p shown in FIGS. 7A and 7B. It is thus possible to prevent the catching holes 11u from deforming the mounting portion 11H. Accordingly, it is also possible to prevent the information-showing portion 10H coupled to this mounting portion 11H from being deformed, thereby improving the appearances of the tag 1H.

Next, a description will be given of one example of the tag of a ninth embodiment with reference to FIGS. 11A and 11B. A tag 1I of the ninth embodiment shown in FIGS. 11A and 11B is comprised of an information-showing portion 10I, a mounting portion 11I, and a coupling portion 121 which are formed integrally by using a thin sheet material such as paper or plastic so that it is attached to amounted target such as a bag 14 by a binder 13. It should be noted that identical reference symbols and numerals are given to identical components of the tag H shown in FIGS. 10A and 10B, a detailed description of which will be omitted.

The information-showing portion 10I is provided so that its region is, for example, a rectangle-shaped region, on which various kinds of information are represented through printing, etc. Further, a sticker on which the various kinds of information are printed may be attached. Further also, inscribed information such as braille may be written.

The mounting portion 11I has catching holes 11u at two positions, which are caught by a binder 13. The catching holes 11u are one example of catching portions and given by forming two through holes with a predetermined spacing therebetween in the horizontal direction of the tag 1I, assuming that the longitudinal direction of the tag 1I is a vertical direction and the latitudinal direction of the tag 1I is a horizontal direction.

The coupling portion 12I (region delimited by broken lines) couples the information-showing portion 10I and the mounting portion 11I to each other. In this example, a predetermined region that interconnects the mounting portion 11I and the information-showing portion 10I has an opening formed at its midsection (engagement portion 12r), so that both the remaining ends serve as the coupling portion 12I.

The engagement portion 12r is given by forming a rectangular opening and used when the tag 1H is held by the curl guide 30D shown in FIG. 58. In this example, a tag latching claw portion 300d of the curl guide 30D is inserted thereinto. It should be noted that although the engagement portion 12r has been given by opening the midsection of the predetermined region that interconnects the mounting portion 11I and the information-showing portion 10I, the invention is not limited thereto: the opening may be formed anywhere in the body of the tag 1I, for example, a region of the information-showing portion 10I.

Next, a description will be given of one example of the tag of a tenth embodiment with reference to FIGS. 12A and 12B. A tag 1J of the tenth embodiment shown in FIGS. 12A and 12B is comprised of an information-showing portion 10I, a mounting portion 11J, and a coupling portion 12I which are formed integrally by using a thin sheet material such as paper or plastic so that it is attached to a mounted target such as a bag 14 by a binder 13. It should be noted that identical reference numerals are given to identical components of the tag of the ninth embodiment, a detailed description of which will be omitted.

The information-showing portion 10I is provided so that its region is, for example, a rectangle-shaped region, on which various kinds of information are represented through printing, etc. Further, a sticker on which the various kinds of information are printed may be attached. Further also, inscribed information such as braille may be written.

The mounting portion 11J has catching holes 11u at two positions, which are caught by a binder 13. The catching holes 11u are given by forming two through holes with a predetermined spacing therebetween in the horizontal direction of the tag 1J, assuming that the longitudinal direction of the tag 1J is a vertical direction and the latitudinal direction of the tag 1J is a horizontal direction.

The mounting portion 11J further has semicircle-shaped projecting portions 12s for positioning at its both the horizontal ends. These projecting portions 12s will be fitted to concave portions 400k formed in both end surfaces of a cartridge 40D (see FIGS. 51A and 51B), which is one example of a tag storage member, when installing the tag 1J to it. It should be noted that although the projecting portions 12s respectively have been formed as the semicircular shape, the invention is not limited thereto: any shape such as a rectangle may be possible as far as it can be formed to be projected.

The coupling portion 12I (region delimited by broken lines) couples the information-showing portion 10I and the mounting portion 11J to each other. In this example, a predetermined region that interconnects the mounting portion 11J and the information-showing portion 10I has an opening formed at its midsection (engagement portion 12r), so that both the remaining ends serve as the coupling portion 12I.

The engagement portion 12r is given by forming a rectangular opening and used when the tag 1J is held by the curl guide 30D shown in FIG. 58. In this example, a tag latching claw portion 300d of the curl guide 30D is inserted thereinto.

Next, a description will be given of one example of a tag of an eleventh embodiment with reference to FIGS. 13A and 13B. A tag 1L of the eleventh embodiment shown in FIGS. 13A and 13B is comprised of an information-showing portion 10L, a mounting portion 11L, and a coupling portion 12L which are formed integrally by using a thin sheet material such as paper or plastic so that it is attached to amounted target such as a bag 14 by a binder 13. It should be noted that identical reference symbols and numerals are given to identical components of the tag 1L shown in FIGS. 11A and 11B, a detailed description of which will be omitted.

The information-showing portion 10L is provided so that its region is, for example, a rectangle-shaped region, on which various kinds of information are represented through printing, etc. Further, a sticker on which the various kinds of information are printed may be attached. Further also, inscribed information such as braille may be written.

The mounting portion 11L has catching holes 11u at two positions, which are caught by a binder 13. The catching holes 11u are given by forming two through holes with a predetermined spacing therebetween in the horizontal direction of the tag 1L, assuming that the longitudinal direction of the tag 1L may be a vertical direction and the latitudinal direction of the tag 1L may be a horizontal direction.

The coupling portion 12L (region delimited by broken lines) couples the information-showing portion 10L and the mounting portion 11L to each other. In this example, a predetermined region that interconnects the mounting portion 11L and the information-showing portion 10L has openings formed at both ends thereof (engagement portions 12u, 12u), so that the remaining portion thereof serves as the coupling portion 12L.

The two engagement portions 12u are given by forming rectangular openings with a predetermined spacing therebetween in the horizontal direction of the tag 1L and used when the tag 1L is held by the curl guide 30D shown in FIG. 58. In this example, a tag latching claw portion 300d of the curl guide 30D is inserted thereinto.

It should be noted that although each of the engagement portions 12u has been given by opening two portions in the predetermined region that interconnects the mounting portion 11L and the information-showing portion 10L, the invention is not limited thereto: the openings may be formed in any portions on the body of the tag 1L, for example, the region of the mounting portion 11L or the information-showing portion 10L.

Further, the tag 1L can make opened areas of the engagement portions 12u smaller as compared with those of the engagement portion 12r in the tag 1I (see FIGS. 11A and 11B) and the tag 1J (see FIGS. 12A and 12B), thereby allowing the tag more robust to be provided. That is, the information-showing portion 10L and the mounting portion 11L are coupled with each other through the central coupling portion 12L as well as the coupling portion 12L on both sides, so that they can be coupled more securely.

Next, a description will be given of one example of a tag of twelfth embodiment with reference to FIGS. 14A and 14B. A tag 1K of the twelfth embodiment shown in FIGS. 14A and 14B is comprised of an information-showing portion 10K, a mounting portion 11K, and a coupling portion 12K which are formed integrally by using a thin sheet material such as paper or plastic so that it is attached to a mounted target such as a bag 14 by a binder 13. It should be noted that identical reference symbols and numerals are given to identical components of the tag 1H shown in FIGS. 10A and 10B, a detailed description of which will be omitted.

The information-showing portion 10K is provided so that its region is, for example, a rectangle-shaped region, on which various kinds of information are represented through printing, etc. Further, a sticker on which the various kinds of information are printed may be attached. Further also, inscribed information such as braille may be written.

The coupling portion 12K (region delimited by broken lines) couples the information-showing portion 10K and the mounting portion 11K. In this case, assuming that a longitudinal direction of the tag 1K is a vertical direction and a latitudinal direction thereof is a horizontal direction, the length in the horizontal direction (horizontal width) of the coupling portion 12K is formed so as to be greater than the horizontal width of the information-showing portion 10K and the horizontal width of the mounting portion 11K. Both of the horizontal ends of the coupling portion 12K project from both of the horizontal ends of the information-showing portion 10K. Both of these horizontally projecting ends (engagement portions 12t, 12t) are used when the tag 1K is held by the curl guide 30C shown in FIG. 55. In this example, a tag latching claw portion 300c of the curl guide 30C is engaged.

The mounting portion 11K is coupled to the information-showing portion 10K through this coupling portion 12K. The horizontal width of the mounting portion 11K is formed so as to be substantially equal to the horizontal width of the information-showing portion 10K. The mounting portion 11K has catching holes 11u at two positions, which are caught by a binder 13. The catching holes 11u are one example of catching portions and given by forming two through holes with a predetermined spacing therebetween in the horizontal direction of the tag 1K.

### Configuration Example of Binding Machine of the Present Embodiments

It should be noted that if the tags 1A and 1B described above are to be attached to the bag 14 etc. by using the binder 13, the efficiency will be poor in manual operations, which is not suited for mass-production. Thus, such a binding machine has been proposed that the tags 1A and 1B are attached to the bag 14 by binding operation of the binder 13 to the bag 14.

A description will be given of an overall configuration of the binding machine of the present embodiment with reference to FIG. 15. Further, a description will be given of a configuration of main components of the binding machine of the present embodiment with reference to FIGS. 16 and 17. Next, a description will be given of a configuration of the binding machine for attaching the tag 1A described in FIGS. 1A and 1B or the tag 1B described in FIGS. 4A and 4B by the binding operation of the binder 13. It should be noted that the tag 1A will be illustrated in the following description but similar configuration may be applied even in a case where the tag 1B is used.

A binding machine 2A of the present embodiment is provided with a tag hold mechanism 3A that constitutes a guide to pass the binder 13 through the catching holes 11m in the tag 1A shown in FIG. 1 and a tag transfer mechanism 4A that transfers the tag 1A to the tag hold mechanism 3A.

The binding machine 2A is further provided with a binder transfer mechanism 5 that transfers the binder 13 to the tag hold mechanism 3A, a binder formation mechanism 6A that forms the binder 13 passed through the catching holes 11m in the tag 1A in order to fasten this binder, and a binder-fastening mechanism 7A that fastens the formed binder 13.

A description will be given of a configuration and operations of the tag hold mechanism 3A with reference to FIGS. 18A, 18B, 19A and 19B.

The tag hold mechanism 3A is one example of tag guide means, and is provided with a curl guide 30A that holds the tag 1A and an abutment guide 31 that sandwiches the tag 1A between itself and the curl guide 30A so that the tag 1A may be curved into a predetermined shape.

Also, a configuration of the curl guide 30A will be described with reference to FIGS. 20A to 20C.

The curl guide 30A shown in FIGS. 20A to 20C is provided with a tag curving protrusion 30a that curves the tag 1A shown in FIGS. 1A and 1B in the latitudinal direction thereof, tag latching claw portions 30b which catch the concave portions 12m of the tag 1A, a binder passage 30c through which the binder 13 shown in FIG. 2 passes, and a binder take-out slit 30d by which the binder 13 passed though the binder passage 30c is taken out of the binder passage 30c.

The tag curving protrusion 30a has such a shape as to curve the mounting portion 11A of the tag 1A shown in FIGS. 1A and 1B inwards in the latitudinal direction. Each of the tag latching claw portions 30b is constituted of a convex having a shape that conforms to each of the concave portions 12m in the tag 1A so that the tag 1A may be positioned with respect to the curl guide 30A when the tag latching claw portions 30b are fitted into the concave portions 12m in the tag 1A.

A description will be given of a configuration of the binder passage 30c with reference to FIGS. 21 and 22. FIG. 21 is a cross-sectional view taken along lines A-A of FIG. 20(B) showing one example of the binder passage 30c, and FIG. 22 is an enlarged view of a portion B in FIG. 21 showing the one example of the binder passage 30c.

The binder passage 30c shown in FIGS. 21 and 22 has a shape that permits the binder 13 shown in FIG. 2 to pass through it and is given by forming a groove that interconnects two openings 30f made in the tag curving protrusion 30a with respect to the positions of the catching holes 11m in the tag 1A shown in FIGS. 1A and 1B.

The binder passage 30c that interconnects the two openings 30f made in the convex-shaped tag curving protrusion 30a has the shape of a curve having a large diameter, so that the binder 13 passed through the binder passage 30c is moderately curved approximately linearly. In this case, a distance between the binder passage 30c and the tag curving protrusion 30a is made as small as possible so that a distance between the binder 13 passed through the binder passage 30c and the tag 1A held by the tag curving protrusion 30a may be made smaller.

A description will be given of a configuration of the binder take-out slit 30d with reference to FIG. 23. Also, a description will be given of a configuration and operations of the binder take-out slit 30d with reference to FIGS. 24A and 24B. FIGS. 24A and 24B are each an enlarged view of a portion D in FIG. 23.

The binder take-out slit 30d shown in FIG. 24A is configured by forming in the tag curving protrusion 30a a groove-shaped opening having a smaller width than that of the binder passage 30c. In the binder passage 30c, the whole of the side facing the tag curving protrusion 30a is opened.

As shown in FIG. 2, the binder 13 has the shape of a narrow tape and is formed by covering the flexible thin wire 13a made of metal or resin, etc. by the covering material 13b such as resin or paper. As shown in FIG. 24A, the binder take-out slit 30d has a width that is smaller than a width of the binder 13 and greater than a width of the thin wire 13a. Accordingly, if such force is applied as to take out the binder 13 from the binder passage 30c, the binder 13 is guided along the shape of a chamfering portion 30e between the binder passage 30c and the binder take-out slit 30d, passes through the binder take-out slit 30d as the covering material 13b is deformed, and is then taken out of the binder passage 30c as shown in FIG. 24B.

It should be noted that the binder take-out slit 30d has been formed as an opening having a smaller width than that of the binder passage 30c, so that if a binding machine 2A is used without using the tag 1A, a bag etc. to be bound may be prevented from entering the binder take-out slit 30d.

Referring back to FIGS. 18A, 18B, 19A, and 19B, the abutment guide 31 is configured so as to be made of, for example, metal sheet members each having a shape that conforms to the tag curving protrusion 30a of the curl guide 30A and is provided with a pair of guide blocks 31a between the two sheets of metal sheet members.

The guide blocks 31a are provided with guide grooves 31b through which the binder 13 shown in FIG. 2 passes. The guide grooves 31b connect to the binder passage 30c in the curl guide 30A when abutting the curl guide 30A against the abutment guide 31.

Next, a description will be given of changes in shape of the tag 1A caused by the operations of the curl guide 30A with reference to FIGS. 25A and 25B.

As shown in FIG. 25A, the tag 1A is held by the curl guide 30A if the concave portions 12m are caught(engaged) by the tag latching claw portions 30b of the curl guide 30A.

If the curl guide 30A holding the tag 1A abuts against the abutment guide 31 as shown in FIGS. 18B and 19B, the tag 1A is sandwiched between the curl guide 30A and the abutment guide 31.

Accordingly, as shown in FIG. 25B, the tag 1A results in having a curved shape in the latitudinal direction thereof on its region near the mounting portion 11A principally in accordance with the shape of the tag curving protrusion 30a. Further, the tag 1A is positioned by catching (engaging) the concave portions (engagement portions) 12m by (with) the tag latching claw portions 30b of the curl guide 30A, so that the positions of the catching holes 11m are aligned with the binder passage 30c in the curl guide 30A.

Further, since the curl guide 30A abuts against the abutment guide 31, the binder passage 30c in the curl guide 30A and the guide grooves 31b in the guide blocks 31a of the abutment guide 31 are connected to each other via the catching holes 11m of the tag 1A.

Accordingly, a passage is formed which passes from one of the guide grooves 31b in the abutment guide 31 through one of the catching holes 11m in the tag 1A, passes from the binder passage 30c in the curl guide 30A through the other catching hole 11m in the tag 1A, and leading to the other guide groove 31b in the abutment guide 31.

Therefore, by feeding the binder 13 as guided by this passage, the binder 13 can be passed through the two catching holes 11m in the tag 1A.

The tag transfer mechanism 4A shown in FIG. 15 is one example of tag transfer means, is provided with a tag storage portion 40A that stores a plurality of the tags 1A and a tag transfer guide 41 that transfers one of the tags 1A, which is taken out from the tag storage portion 40A, to the curl guide 30A of the tag hold mechanism 3A.

The tag storage portion 40A stacks and stores a plurality of the tags 1A and then lets out the tags 1A one by one by a transfer roller, not shown. A tag transfer guide 41 provides a curved guide that transfers one tag 1A let out horizontally from the tag storage portion 40A in a direction perpendicular to the curl guide 30A of the tag hold mechanism 3A. Further, the tag transfer guide 41 retreats if the curl guide 30A operates.

A binder transfer mechanism 5A shown in FIGS. 16 and 17 is one example of binder transfer means and is provided with a feed roller 50 that is driven rotationally and a driven roller 51 that pushes the binder 13 to the feed roller 50.

The binder 13 is provided in a continuous and elongated manner in a condition where it is wound around a reel 52 as shown in FIG. 15 and passes between the feed roller 50 and the driven roller 51 to be fed to a guide member 53. The driven roller 51 is pushed to the feed roller 50 by a spring 55 via a release lever 54, so that if the guide roller 50 is driven rotationally, the binder 13 is transferred and reeled out of the reel 52.

The binder formation mechanism 6A is one example of binder formation means and is provided with a pair of approach arms 60, a first link 61 that interlocks the pair of approach arms 60, a cutter 62 that cuts off the binder 13, and a second link 63 that operates the cutter 62, which form the binder 13.

The pair of approach arms 60 are attached to a frame 20 of the binding machine 2A in such a manner that they can rotate around shafts 60a as fulcrums. The approach arms 60 connect to the guide grooves 31b in the guide block 31a if they rotate around the shafts 60a as the fulcrums to be open. Further, the approach arms 60 are provided with guide grooves 60b that form a passage through which the binder 13 passes and binder formation claw portions 60c that form the binder 13 by closing operations around the shafts 60a as the fulcrums.

The first link 61 is comprised of two links that connect to the approach arms 60 in such a manner that they can rotate around shafts 61a as the fulcrums and, thus transforming a linear operation into a rotating operation of the approach arms 60 around the shafts 60a as the fulcrums.

Next, a description will be given of a configuration and operations of the cutter 62 with reference to FIGS. 26A and 26B. The cutter 62 shown in FIG. 26A is slidably mounted along a passage through which the binder 13 is transferred by the guide member 53, and is provided with a roller 62a that is guided by the second link 63 and a spring 62b that applies force in such a direction that it may retreat from the transfer passage for the binder 13.

The second link 63 is provided with a cam face 63a that displaces the roller 62a of the cutter 62. The second link 63 is attached to one of the approach arms 60, to rotate around the shaft 60a as a fulcrum so that the cam face 63a may be displaced.

As shown in FIG. 26B, the second link 63 pushes the roller 62a by means of the cam face 63a based on an operation for closing the approach arms 60, and moves the cutter 62 against the spring 62b in such a direction that the guide member 53 blocks the transfer passage for the binder 13. This causes the binder 13 to be cut off at a predetermined position.

Next, a description will be given of a configuration and operations of the binder-fastening mechanism 7A with reference to FIG. 27. The binder-fastening mechanism 7A shown in FIG. 27 is one example of binder-fastening means and is provided with a torsion arm 70 which is driven rotationally. The torsion arm 70 has an S shape, so that if the binder 13 is formed by closing the approach arms 60 of the binder formation mechanism 6A, both ends of the binder 13 are fitted into an S-shaped groove. Then, by turning the torsion arm 70 in a predetermined direction, both ends of the binder 13 are twisted, thus fastening the binder 13.

Next, a description will be given of a drive mechanism that drives the tag hold mechanism 3A, the binder transfer mechanism 5A, the binder formation mechanism 6A, and the binder-fastening mechanism 7A by interlocking them with each other.

The tag hold mechanism 3A moves in such a direction that the operations of a first working plate 32 that slides and moves are transmitted via a torque limiter 33 to the curl guide 30A and the curl guide 30A comes close to and separates from the facing abutment guide 31.

Further, in the binder formation mechanism 6A, the operations of a second working plate 64 that slides and moves are transmitted via the first link 61 to the pair of approach arms 60, so that the approach arms 60 are opened and closed by rotating around the shafts 60a as the fulcrums.

Next, a description will be given of a configuration of a mechanism to drive the working plates with reference to FIG. 28. The first working plate 32 shown in FIG. 28 is driven by a first working plate drive gear 34, which is driven rotationally, with the curl guide 30A shown in FIG. 29 being coupled via the torque limiter 33 to the guide portion 32a. The first working plate drive gear 34 is provided with a cam groove 34a which is displaced through rotational driving. In the first working plate 32, a guide roller, not shown, is guided in the cam groove 34a. Then, the rotational operations of the first working plate drive gear 34 are transformed by the shape of the cam groove 34a into sliding operations of the first working plate 32 which are indicated by an arrow.

The second working plate 64 is driven by a second working plate drive gear 65, which is driven rotationally, with the first link 61 shown in FIGS. 16 and 17 being coupled to a link center 64a. The second working plate drive gear 65 is provided with a cam groove 65a which is displaced through rotational driving. In the second working plate 64, a guide roller, not shown, is guided by the cam groove 65a. Then, the rotational operations of the second working plate drive gear 65 are transformed by the shape of the cam groove 65a into sliding operations of the second working plate 64 which are indicated by an arrow.

The second working plate drive gear 65 meshes with a pinion gear 66 mounted to a shaft of a motor, not shown. Further, the first working plate drive gear 34 is in mesh with the second working plate drive gear 65.

Accordingly, the driving force of the motor, not shown, is transmitted to the first working plate drive gear 34 and the second working plate drive gear 65, so that the first working plate 32 and the second working plate 64 slide and move at a predetermined timing based on the shapes of the cam grooves.

In the binder transfer mechanism 5A shown in FIGS. 16 and 17, the driving force of an intermittent drive gear 56 mounted to a shaft 35 of the first working plate drive gear 34 shown in FIG. 28 is transmitted via a timing gear 57 to a gear 58 mounted on the same axis as that of the feed roller 50.

The intermittent drive gear 56 has a gear formed on a portion of its circumference, which meshes with the timing gear 57 at a predetermined timing for each rotation. This causes the feed roller 50 to be driven rotationally only during the predetermined timing that the intermittent drive gear 56 rotates once.

In the binder-fastening mechanism 7A, the driving force of an intermittent drive gear 71 mounted to a shaft 67 of the second working plate drive gear 65 shown in FIG. 28 is transmitted via a timing gear 72 and a bevel gear 73 to the torsion arm 70.

The intermittent drive gear 71 has a gear formed on a portion of its circumference, which meshes with the timing gear 72 at a predetermined timing for each rotation. This cases the torsion arm 70 to be driven rotationally only during the predetermined timing that the intermittent drive gear 71 rotates once.

As described above, the intermittent drive gear 56 that drives the binder transfer mechanism 5A is disposed on the same axis as that of the first working plate drive gear 34 that drives the tag hold mechanism 3A. The intermittent drive gear 71 that drives the binder-fastening mechanism 7A is disposed on the same axis as that of the second working plate drive gear 65 that drives the binder formation mechanism 6A.

Accordingly, with the driving force of the single motor, not shown, the hold and release operations of the tag 1A by the tag guide 30, the transfer operations of the binder 13 by the feed roller 50, the cut-off and formation operations of the binder 13 by the approach arms 60, and the fastening operations of the binder 13 by the torsion arm 70 are interlinked at a predetermined timing.

### Operation Example of Binding Machine of the Present Embodiments

Next, a description will be given of an example of operations to attach the tag 1A to the bag 14 by using the binding machine 2A of the present embodiment with reference to the drawings.

First, the binding machine 2A is in an initial state shown in FIG. 17. In this state, if a sensor, not shown, detects that the bag 14 has been set, one of the tags 1A is transferred by the tag transfer mechanism 4A shown in FIG. 15 to the tag guide 30 of the tag hold mechanism 3A.

The tag 1A transferred to the tag guide 30 is held by the curl guide 30A as shown in FIG. 25A and is positioned with its concave portions (engagement portions) 12m being caught (engaged) by the tag latching claw portions 30b.

A description will be given of operations of the binding machine 2A in the process of forming a transfer passage for the binder 13 with reference to FIG. 29.

If a motor, not shown, in the binding machine 2A shown in FIG. 29 is driven rotationally, the first working plate drive gear 34 and the second working plate drive gear 65 shown in FIG. 28 as well as the intermittent drive gear 56 and the intermittent drive gear 71 shown in FIGS. 17 etc. are driven rotationally.

If the first working plate drive gear 34 is driven rotationally in a condition where the binding machine 2A is in the initial state shown in FIG. 17, the first working plate 32 slides and moves in a direction of an arrow F1 shown in FIG. 29 in conformity with the shape of the cam groove 34a. This causes the curl guide 30A to move in a direction of an arrow F2 and abut against the abutment guide 31.

If the curl guide 30A holding the tag 1A abuts against the abutment guide 31, the tag 1A is sandwiched between the curl guide 30A and the abutment guide 31. Accordingly, the tag 1A results in having a curved shape in the latitudinal direction thereof on its region near the mounting portion 11A principally in accordance with the shape of the tag curving protrusion 30a as shown in FIG. 25B. Further, the tag 1A is positioned by catching (engaging) the concave portions (engagement portions) 12m by (with) the tag latching claw portions 30b of the curl guide 30A, so that the positions of the catching holes 11m are aligned with the binder passage 30c in the curl guide 30A.

Further, since the curl guide 30A abuts against the abutment guide 31, the binder passage 30c in the curl guide 30A and the guide groove 31b in the guide block 31a of the abutment guide 31 are connected to each other via the catching holes 11m in the tag 1A.

Accordingly, a passage is formed which passes from one of the guide grooves 31b in the abutment guide 31 through one of the catching holes 11m in the tag 1A, passes from the binder passage 30c in the curl guide 30A through the other catching hole 11m in the tag 1A, and leading to the other guide groove 31b in the abutment guide 31.

It should be noted that if the second working plate drive gear 65 is driven rotationally in a condition where the binding machine 2A is in the initial state shown in FIG. 17, the second working plate 64 is not slid and moved owing to the shape of the cam groove 65a.

Further, since the intermittent drive gear 56 on the same axis as that of the first working plate drive gear 34 does not mesh with the timing gear 57, the transfer roller 50 is not driven rotationally so that the binder 13 is not transferred. Furthermore, since the intermittent drive gear 71 on the same axis as that of the second working plate drive gear 65 does not mesh with the timing gear 72, the torsion arm 70 is not driven rotationally.

A description will be given of operations of the binding machine 2A in the process of transferring the binder 13 with reference to FIG. 30.

If the first working plate drive gear 34 rotates until the curl guide 30A shown in FIG. 30 comes to abut against the abutment guide 31, the first working plate 32 stops sliding or moving owing to the shape of the cam groove 34a, so that the curl guide 30A is held at a position where it abuts against the abutment guide 31.

If the first working plate drive gear 34 is driven rotationally further in this condition, the intermittent drive gear 56 on the same axis comes to mesh with the timing gear 57. This causes the transfer roller 50 to rotate in a direction of an arrow W1 so that the binder 13 is transferred. If the binder 13 is transferred, the binder 13 is caused to pass through the two catching holes 11m in the tag 1A because the transfer passage for the binder 13 is already formed by the curl guide 30A.

It should be noted that in the process where the transfer roller 50 is driven rotationally, the second working plate 64 is not slid and moved owing to the shape of the cam groove 65a although the second working plate drive gear 65 is rotating. Further, the torsion arm 70 is not driven rotationally because the intermittent drive gear 71 on the same axis as that of the second working plate drive gear 65 does not mesh with the timing gear 72.

A description will be given of operations of the binding machine 2A in the process of forming the binder 13 with reference to FIG. 31.

If the intermittent drive gear 56 is driven rotationally until the binder 13 shown in FIG. 31 is transferred to a predetermined position, the gear portion of the intermittent drive gear 56 is disengaged from the timing gear 57, thus causing the transfer of the binder 13 to stop.

If the second working plate drive gear 65 is driven rotationally further in a condition where the gear portion of the intermittent drive gear 56 is disengaged from the timing gear 57, the second working plate 64 slides and moves in a direction of an arrow F3 owing to the shape of the cam groove 65a. This causes the link center 64a to which the first link 61 is coupled to slide and move together with the second working plate 64 so that the pair of approach arms 60 are driven rotationally in a direction of an arrow W2 around the shafts 60a as the fulcrums, thereby closing the binder formation claw portion 60c.

In the operations of closing the approach arms 60, first, as shown in FIG. 26B, the roller 62a is pushed by the cam face 63a of the second link 63, to move the cutter 62 against the spring 62b in such a direction that the guide member 53 blocks the transfer passage for the binder 13, thereby cutting off the binder 13 at a predetermined position.

If the approach arms 60 are closed further, both ends of the binder 13 that is cut off to a predetermined length are formed into such a shape that they are brought close to the torsion arm 70.

It should be noted that in the process where the approach arms 60 are driven rotationally, the first working plate 32 is not slid and moved owing to the shape of the cam groove 34a although the first working plate drive gear 34 rotates, so that the curl guide 30A is held at a position where it abuts against the abutment guide 31. Further, since the intermittent drive gear 71 on the same axis as that of the second working plate drive gear 65 does not mesh with the timing gear 72, the torsion arm 70 is not driven rotationally.

A description will be given of operations of the binding machine 2A in the process of fastening the binder 13 with reference to FIG. 32.

If the second working plate drive gear 65 rotates to a position where the pair of approach arms 60 shown in FIG. 32 are closed, the second working plate 64 stops sliding and moving owing to the shape of the cam groove 65a, so that the approach arms 60 are held at a position where both ends of the binder 13 are brought close to the torsion arm 70.

If the second working plate drive gear 65 is driven rotationally further in this condition, the intermittent drive gear 71 on the same axis comes to mesh with the timing gear 72. This causes the timing gear 72 and a pair of bevel gears 73 to rotate in an arrow direction, thus rotationally driving the torsion arm 70 in a direction of an arrow W3 to twist both ends of the binder 13 so that the binder 13 is fastened.

It should be noted that in the process where the torsion arm 70 is driven rotationally, the first working plate 32 is not slid and moved owing to the shape of the cam groove 34a although the first working plate drive gear 34 rotates, so that the curl guide 30A is held at a position where it is caused to abut against the abutment guide 31.

A description will be given of operations of the binding machine 2A in the process of releasing a bound bag by bringing the portions back to their respective home positions with reference to FIG. 33.

If the intermittent drive gear 71 is driven rotationally until both ends of the binder 13 shown in FIG. 33 are twisted for a predetermined number of times and fastened, the gear portion of the intermittent drive gear 71 is disengaged from the timing gear 72, thus causing the rotation of the torsion arm 70 to stop.

If the second working plate drive gear 65 is driven rotationally further in a condition where the gear portion of the intermittent drive gear 71 is disengaged from the timing gear 72, the second working plate 64 slides and moves in a direction of an arrow F4 owing to the shape of the cam groove 65a. This causes the link center 64a to which the first link 61 is coupled to slide and move together with the second working plate 64 so that the pair of approach arms 60 are driven rotationally in a direction of an arrow W4 around the shafts 60a as the fulcrums and return to their home positions, thereby opening the binder formation claw portion 60c.

Further, if the first working plate drive gear 34 is driven rotationally further in a condition where the gear portion of the intermittent drive gear 71 is disengaged from the timing gear 72, the first working plate 32 slides and moves in a direction of an arrow F5 owing to the shape of the cam groove 34a. This causes the curl guide 30A to move in a direction of an arrow F6, thus separating from the abutment guide 31.

If the curl guide 30A is separated from the abutment guide 31, the tag 1A does not follow the operations of the curl guide 30A because it is already attached to the bag 14 with the binder 13. Accordingly, as shown in FIG. 24B, force is applied in such a direction as to take out the binder 13 from the binder passage 30c in the curl guide 30A, so that the binder 13 passes through the binder take-out slit 30d as the covering material 13b is deformed, thus going off from the binder passage 30c.

Accordingly, the tag 1A is detached from the curl guide 30A and then the bag 14 is bound with the binder 13, thereby attaching the tag 1A to the bag 14 as shown in FIGS. 3A and 3B.

In such a manner, by utilizing the concave portions (engagement portions) 12m formed between the information-showing portion 10A and the mounting portion 11A as a positioning portion to let the binder 13 pass through the catching holes 11m, the tag 1A of the present embodiment can be used in the binding machine 2A capable of attaching the tag 1A also by binding the bag 14 with the binder 13.

Although manual operations of passing the binder through the two catching holes are not efficient and not suited to mass-production, the working efficiency may be enhanced by mechanizing the process including passing process of the binder through the catching holes, thus providing the tag suitable for mass-production.

It should be noted that although the above embodiment has employed the binder configuration of covering a core wire made of metal or resin, etc. with a covering material to provide a tape-like (band-like) shape, the binder is not limited to this configuration.

For example, a linear member having a circular cross section in a condition where the core wire has been covered may be employed as the binder or a wire or a single-wire material made of resin may be also employed. Any binder may be employed as far as it has a proper flexibility suitable enough to be twisted and fastened.

### Configuration and Operation Example of Binding Machine of Other Embodiments

Next, a description will be given of a configuration example of a binding machine 2A′ of the present embodiment with reference to FIG. 34. The binding machine 2A′ shown in FIG. 34 lets a linear binder 13 such as a twist tie pass through catching holes 11p in a TAG 1D shown in FIG. 7A, for example, and binds this binder 13 around a mounted target such as a bag 14 (see FIG. 36) squeezed at its top to attach the tag 1D to the mounted target.

The binding machine 2A′ is provided with a body chassis portion 92 and a support portion 91 that supports the body chassis portion 92. The support portion 91 is constituted of an “H” shaped support table 91b and a support rod 91a that is attached perpendicularly to the support table 91b. To the leading end of the support rod 91a, the body chassis portion 92 is attached in such a manner as to be parallel to the support table 91b. The body chassis portion 92 is constituted by combining a plurality of steel plates. In the body chassis portion 92, a tag hold mechanism 3A′, a tag transfer mechanism 4A′, a binder transfer mechanism 5A′, a binder formation mechanism 6A′, a binder-fastening mechanism 7A′, and a bobbin 52′ are provided. It should be noted that the binder transfer mechanism 5A′, the binder formation mechanism 6A′, and the binder-fastening mechanism 7A′ constitute one example of binding means.

The tag transfer mechanism 4A′ functions as one example of tag transfer means, to transfer a tag 1D. The tag transfer mechanism 4A′ is disposed to a lower side of a front (left side of the paper in FIG. 37) of the body chassis portion 92. The tag transfer mechanism 4A′ stores a plurality of the tags 1D. In this example, the tag transfer mechanism 4A′ transfers the stored tags 1D one by one to the tag hold mechanism 3A′ for each binding operation.

The tag hold mechanism 3A′ functions as one example of tag hold-and-movement means and is disposed to an upper side of the front of the body chassis portion 92 in such a manner as to face the tag transfer mechanism 4A′ via the body chassis portion 92. The tag hold mechanism 3A′ holds a tag 1D transferred by the tag transfer mechanism 4A′ and moves toward the binder formation mechanism 6A′. After the movement of the tag hold mechanism 3A′, the binder 13 wound around the bobbin 52′ is transferred.

The bobbin 52′ is one example of a binding-and-holding assembly, to bind the binder 13 around itself and hold it. The bobbin 52′ is provided with a core 52a, which is one example of a rod-shaped binding portion, in such a configuration that the binder 13 is wound around the core 52a and held. The bobbin 52′ is installed on an installation table 90 of the body chassis portion 92 disposed horizontally with respect to the ground in such a manner that the core 52a of this bobbin 52′ is substantially perpendicular.

The binder transfer mechanism 5A′ is mounted in the vicinity of the bobbin 52′, to pull out the binder 13 wound around and held by the bobbin 52′ and transfers this binder 13 toward the tag hold mechanism 3A′ after it has been moved toward the binder formation mechanism 6A′. The transferred binder 13 is passed through two catching holes 11m in the tag 1D held by the tag hold mechanism 3A′.

The binder formation mechanism 6A′ is installed to a position where it faces the tag hold mechanism 3A′ holding the tag 1D, cuts off the binder 13 passed through the tag 1D, approximates the front and rear ends of a binder 13′ that is cut off from the binder on the side of the bobbin 52′ and then supplies it to the binder-fastening mechanism 7A′.

The binder-fastening mechanism 7A′ is installed in the vicinity of the binder formation mechanism 6A′, and twists the front and rear ends of the binder 13′ brought close by this binder formation mechanism 6A′ to fasten it. The binding machine 2A′ having such a configuration passes the binder 13 through the tag 1D and binds the binder 13′ around the bag 14 etc. with its top squeezed, thus attaching the tag 1D to the bag 14.

Next, a description will be given of the binding machine 2A′ shown in FIG. 34 and functions of the binding machine 2A′ with reference to FIGS. 35A to 35D. In this example, the binding machine 2A′ transfers the tag 1D by the tag transfer mechanism 4A′, holds the tag 1D by the tag hold mechanism 3A′, and moves toward the binder formation mechanism 6A′ where a bag 14 is disposed as shown in FIG. 35A.

The binder transfer mechanism 5A′ shown in FIG. 34 pulls out the binder 13 wound around the bobbin 52′ by about 80 mm and, as shown in FIG. 35B, cause the head of this binder 13 to pass through the two catching holes 11p in the tag 1D.

After a leading end of the binder 13 has passed through one of the catching holes 11p, the binder 13 is turned around in accordance with the shape of the tag hold mechanism 3A′ shown in FIG. 34 so that the leading end of this binder 13 is passed through the other catching hole 11p as shown in FIG. 35C. After the insertion, the binder formation mechanism 6A′ cuts off the binder 13 at a predetermined position to set the whole length of the binder 13 to about 80 mm. After the cut-off, the binder formation mechanism 6A′ gets both ends of the cut-off binder 13′ close to the bag 14 and limits a shape of the binder 13′ into a U-shape.

The front and rear ends of the binder 13′ limited into the U-shape are brought close to each other and held by an S-shaped portion 70a of a torsion arm 70 having an S-shaped head shown in FIG. 35C, which torsion arm 70 is then rotated a predetermined number of times. This causes the binder 13′ to be twisted and fastened and also the tag 1D to be fixed to the top of the bag 14 by means of the binder 13′ as shown in FIG. 35D. Thus, the bag 14 is bound at its top and the tag 1D is fixed automatically.

Next, a description will be given of an example of mounting the tag 1D with reference to FIG. 36. To the bag 14 shown in FIG. 36, the binder 13′ is fastened and the tag 1D is mounted with the binder 13′. Since the binder 13′ is passed through the two catching holes 11p in the tag 1D so that the top of the bag 14 is bound with this binder 13′, an orientation of the information-showing portion 10C stands vertically along the bag 14, thereby preventing facing horizontally.

Further, the binder 13′ is wound around the rod-like deformed top of the twisted bag 14, so that a mounting portion 11D of the tag 1D may be curved in accordance with the twisted shape of the bag 14 in some cases. However, concave portions 12n are formed in both sides of the information-showing portion 10C to provide a coupling portion 12C, which is narrower than that of the information-showing portion 10C, coupling the mounting portion 11D and the information-showing portion 10C, so that the information-showing portion 10C does not conform to the curved shape of the mounting portion 11D and is difficult to be curved to a great extent. Accordingly, it is possible to clearly recognize information described on the information-showing portion 10C of the tag 1D. Further, since the information-showing portion 10C stands vertically along the bag 14 without curving, the bag 14 may have good appearances in a condition where the tag 1D is attached to it.

Next, a description will be given of a configuration and an operation example of the binding machine 2A′ with reference to FIGS. 37 to 40. The binding machine 2A′ shown in FIG. 37 is a view viewed from a top of the binding machine 2A′ shown in FIG. 34. A state of this binding machine 2A is a standby state. In the standby state of the binding machine 2A′, the tag transfer mechanism 4A′ has transferred one tag 1D to the tag hold mechanism 3A′.

The tag hold mechanism 3A′ is provided with a curl guide 30B and a guide plate 95. The curl guide 30B is mounted slidably and waits at the position of a home position HP shown in FIG. 37. To move this curl guide 30B in a direction of an arrow Q1, a working plate 32′, an approach motor 93, a ball screw shaft 94, and a torque limiter 33 (see FIG. 62) are mounted.

In this example, as the approach motor 93, a direct current (DC) motor is used, so that a gear 93a linked to the rotary shaft of this approach motor 93 meshes with a gear 94a linked to the ball screw shaft 94. The working plate 32′ is screwed on this ball screw shaft 94 so that it can be slid and moved. The operations of the sliding nod moving working plate 32′ are transmitted to the curl guide 30B via the torque limiter 33. Having received the operations of the working plate 32′, the curl guide 30B moves close to and away from the binder formation mechanism 6A′ which faces the curl guide 30B. In front of the binder formation mechanism 6A′, the guide plate 95 is mounted slidably.

In this guide plate 95, its sliding movement is detected by a transmission-type guide plate sensor 107 (see FIG. 63). Thus, if the user tries to dispose the bag 14 to a binding opening 103 shown in FIG. 37, first the guide plate 95 is once pushed in by the bag 14 being disposed and, if the bag 14 is properly disposed to the binding opening 103, the guide plate 95 automatically returns to the illustrated state. By detecting this reciprocating operation with the guide plate sensor 107, it is possible to determine that the bag 14 has been disposed to the detection opening 103 properly. It should be noted that if the guide plate 95 remains in a condition where it has been pushed in, the binding machine 2A′ determines that the bag 14 is not properly set to the binding opening 103 and so does not start binding. It is thus possible to avoid faulty binding. Further, the guide plate 95 prevents the tag 1D from dropping by causing the claws of the curl guide 30B which hold the tag 1D to reach this guide plate 95.

The binder 13 of the bobbin 52′ is pulled out to a predetermined position by the binder transfer mechanism 5A′. In this example, the binder transfer mechanism 5A′ is comprised of a binder feed roller 50a, driven rollers 50b and 50c, a lever 50d, a transfer passage 50e, and a binder feed motor 50i (see FIG. 63). The driven roller 50b is mounted in the vicinity of the bobbin 52′ and the driven roller 50c is mounted in such a manner that the leading end of the binder 13 may face an entrance of the transfer passage 50e. The binder feed roller 50a is mounted in the vicinity of the entrance of the transfer passage 50e and has the rotary shaft of the binder feed motor 50i linked to itself. Against this binder feed roller 50a, the lever 50d is abutted. In this example, the lever 50d is provided with a driven roller 50f and a spring 50g and is rotatably mounted to the body chassis portion 92. The lever 50d is urged counterclockwise by the spring 50g so that the driven roller 50f abuts against the binder feed roller 50a. The binder 13 is sandwiched between the driven roller 50f and the binder feed roller 50a. Thus, if the binder feed roller 50a rotates clockwise, it is possible to pull out the binder 13 from the bobbin 52′ and fed it to the transfer passage 50e.

It should be noted that when replacing the bobbin 52′ and passing first the binder 13 of the new bobbin 52′ to the transfer passage 50e, the user swing the lever 50d clockwise and widen the gap between the driven roller 50f and the binder feed roller 50a to pass the binder 13 of the bobbin 52′ between them, thus setting the leading end of this binder 13 on the position of a cutter 62″.

The binder formation mechanism 6A′ is provided with a cutter 62″ and left-side and right-side approach arms 60″ and 60′. The cutter 62″ is mounted to the body chassis portion 92 via cutter links 62a to 62c (see FIG. 39) and a link roller 97. As the working plate 32′ slides and moves, the link roller 97 is pushed by a roller arm 101 mounted to the lower end of the above-described working plate 32′. If the link roller 97 is pushed, the cutter links 62a to 62c linked to this link roller 97 operate so that the cutter 62″ mounted to the leading end of the cutter link 62c shown in FIG. 39 moves so as to cut off the binder 13.

Further, one end of the right-side approach arm 60′ is mounted to the link roller 97. A shape of this approach arm 60′ is V-shape. The approach arm 60′ is mounted to the link roller 97 rotatably at its one end so that a gullet in the approach arm 60′ is engaged rotatably with the body chassis portion 92 with a pin 105a. Also, in the gullet in the approach arm 60′, a fan-shaped (intermittent) gear 97a is fixed with the pin 105a and meshes with one coupling gear 96a. This coupling gear 96a meshes with the other coupling gear 96b adjacent to it, with which gear 96b, a fan-shaped gear 97b meshes. To this fan-shaped gear 97b, the left-side L-shaped approach arm 60″ is mounted by means of the pin 105b.

Owing to this configuration, if the link roller 97 is pushed, the right-side approach arm 60′ swings around the pin 105a counterclockwise while, at the same time, the fan-shaped gear 97a also swings around the pin 105a counterclockwise, so that the coupling gear 96a which is in mesh with this fan-shaped gear 97a rotates clockwise. If the coupling gear 96a rotates clockwise, the coupling gear 96b rotates counterclockwise, then the fan-shaped gear 97b which is in mesh with this coupling gear 96b swings clockwise around the pin 105b, and then the left-side approach arm 60″ mounted to this fan-shaped gear 97b also swings clockwise around the pin 105b. Therefore, the left-side and right-side approach arms 60″ and 60′ are closed to each other.

It should be noted that the left-side and right-side approach arms 60″ and 60′ constitute part of the transfer passage 50e for the binder 13 in a condition where they are open. In this example, the right-side approach arm 60′ constitutes the transfer passage 50e from the position of the cutter 62″ to that of a connect block 31a′. The connect block 31a′ connects the approach arm 60′ and the curl guide 30B to each other. On the other hand, the left-side approach arm 60″ constitutes a terminal portion of the transfer passage 50e. A connect block 31a″ connects the curl guide 30B and the approach arm 60″ to each other.

The binder-fastening mechanism 7A′ is provided with a torsion arm 70 and a torsion motor 70c (see FIG. 63). As this torsion motor 70c, a stepping motor is used. The torsion arm 70 has an S-shaped portion 70a (see FIGS. 35A to 35D) at its front end and a gear 70b at its read end and holds the front and rear ends of the binder 13′ by the S-shaped portion 70a. The rotary shaft of the torsion motor 70c meshes with the gear 70b, so that as this torsion motor 70c rotates, the torsion arm 70 rotates accordingly.

The binding machine 2A′ shown in FIG. 38 is in a bind state where the binder 13 is passed through the tag 1D and the bag 14 is bound with the binder 13′ which is obtained by cutting the binder 13 off. To make a shift from the standby state shown in FIG. 37 to this bind state, first in the binding machine 2A′, in a process where the user tries to dispose the bag 14 to the binding opening 103 shown in FIG. 37, a main switch 120 (see FIG. 63) is turned on with an arm 121 shown in FIG. 62. Then, as described above, the reciprocating operation of the guide plate 95 is detected by the guide plate sensor 107, thus determining that the bag 14 is disposed to the binding opening properly.

After the bag 14 is disposed, the approach motor 93 is rotated forwardly to forwardly rotate the ball screw shaft 94 via the gears 93a and 94a. The working plate 32′ screwed on this ball screw shaft 94 so that it can be slid and moved slides and moves in a direction of an arrow Q2. The operations of this working plate 32′ are transmitted via the torque limiter 33 (see FIG. 62) to the curl guide 30B, so that having received the operations of the working plate 32′, this curl guide 30B moves from the home position HP to a binding position P1 in such a direction as to get close to the facing binder formation mechanism 6A′ and also pushes in the guide plate 95 until it abuts against the connect blocks 31a′ and 31a″. In this case, the guide plate 95 prevents the tag 1D from dropping because the claws of the curl guide 30B which hold the tag 1D reach this guide plate 95. Further, the curl guide 30B constitutes part of the transfer passage 50e for the binder 13.

After the movement of the curl guide 30B, the binder feed roller 50a is rotated by the binder feed motor 50i (see FIG. 63) so that the binder 13 sandwiched between this bind feed roller 50a and the driven roller 50f urged by the spring 50g is pulled out by about 80 mm from the bobbin 52′ and fed out to the transfer passage 50e. In this case, the binder 13 goes along the transfer passage 50e constituted of the approach arm 60′ and the connect block 31a′ at the right side, the curl guide 30B, and the connect block 31a″ and the approach arm 60″ at the left side.

After the binder 13 is fed out to the transfer passage 50e, the approach motor 93 is rotated again to rotate the ball screw shaft 94 via the gears 93a and 94a. Owing to this rotation of the ball screw shaft 94, the working plate 32′ slides and moves further in a direction of an arrow Q2 so that the link roller 97 is pushed forward by the roller arm 101 mounted to the lower end portion of this working plate 32′.

Because the link roller 97 is pushed forward, the cutter 62″ linked-connected to this link roller 7 is put into the transfer passage 50e for the binder 13 as shown in FIG. 38, thus cutting off the binder 13 placed in the transfer passage 50e. Simultaneously with this cut-off processing, the right-side approach arm 60′ which is link-connected to the link roller 97 swings counterclockwise while also simultaneously the fan-shaped gear 97a also swings counterclockwise, thus clockwise swinging the coupling gear 96a which is in mesh with this fan-shaped gear 97a. If this coupling gear 96a rotates clockwise, the coupling gear 96b rotates counterclockwise, to rotate clockwise the fan-shaped gear 97b which meshes with this coupling gear 96b, which in turn clockwise rotates also the left-side approach arm 60″ mounted on this fan-shaped gear 97b. Therefore, the left-side and right-side approach arms 60″ and 60′ get closed to each other so that the left-side and right-side approach arms 60″ and 60′approximate the front and rear ends of the binder 13′ to the torsion arm 70, thus limiting a shape of the binder 13 into a U-shape.

The torsion arm 70 holds the front and rear ends of the binder 13′ by the S-shaped portion 70a provided at its leading end. In a condition where the front and rear ends of the binder 13′ are held by this S-shaped portion 70a, the torsion arm 70 is rotated a predetermined number of times by the torsion motor 70c (see FIG. 63). With this, the binder 13′ is fastened to the top of the bag 14.

After the binder 13′ is fastened, the approach motor 93 is rotated backward to backward rotate the ball screw shaft 94 via the gears 93a and 94a. The working plate 32′ screwed to this ball screw shaft 94 so that it can be slid and moved slides in a direction of an arrow Q3. Having received this operation of the working plate 32′, the curl guide 30B moves in such a direction as to separate from the facing binder formation mechanism 6A′ and also releases the pushed-in guide plate 95. Moreover, the roller arm 101 and the link roller 97 mounted to the lower end of the working plate 32′ are released from the mutually abutting condition. A tension spring 122 which is constantly urging the link roller 97 toward the catching shaft 97′ is stretched and hooked over between the link roller 97 and the catching shaft 97′, so that if the roller arm 101 and the link roller 97 are released from the mutual abutting condition, the link roller 97 moves in the direction of the arrow Q3.

As the link roller 97 moves toward the Q3 direction, the cutter 62″ which is link-connected to this link roller 97 retreats from the transfer passage 50e for the binder 13.

Simultaneously with the retreating processing of this cutter 62″, the right-side approach arm 60′ linked to the link roller 97 swings clockwise while simultaneously the fan-shaped gear 97a also swings clockwise, thus counterclockwise rotating the coupling gear 96a which is in mesh with this fan-shaped gear 97a. If this coupling gear 96a rotates counterclockwise, the coupling gear 96b rotates clockwise and the fan-shaped gear 97b, which is in mesh with this coupling gear 96b, swings counterclockwise, thus counterclockwise swinging also the left-side approach arm 60″ mounted to this fan-shaped gear 97b. Therefore, the left-side and right-side approach arms 60″ and 60′ get open from each other, so that the left-side and right-side approach arms 60″ and 60′ constitute part of the transfer passage 50e again.

Then, the tag transfer mechanism 4A′ transfers one of the tags 1D stored therein to the curl guide 30B of the tag hold mechanism 3A′. With this, the binding machine 2A′ returns into the standby state shown in FIG. 37.

The binding machine 2A′ shown in FIG. 39 is a top view showing an example of a configuration of the major portion thereof and shows the tag hold mechanism 3A′, the binder formation mechanism 6A′, and the binder-fastening mechanism 7A′ of the binding machine 2A′ in the standby state shown in FIG. 37.

The binder formation mechanism 6A′ shown in FIG. 39 is provided with the cutter links 62a to 62c, link pins 97c and 97d, and a fixed shaft 97e for the purpose of operating the cutter 62″. This cutter 62″ is mounted rotatably by a spindle 62′ provided at a corner of the L-shaped cutter link 62c. To one end of the cutter link 62c, a spring shaft 104 is mounted.

A helical spring 123 is wound around the spring shaft 104 as well as one end side of the helical spring 123 is engaged with the cutter 62″ and the other end side thereof is engaged with the spindle 62′. Accordingly, the cutter 62″ is constantly urged by the helical spring 123 counterclockwise so that it may swing around the spindle 62′. Further, the other end of the cutter link 62c is mounted rotatably via a link pin 97d to one end of the cutter link 62b.

The approximate midsection of the cutter link 62b is fixed via the fixed shaft 97e to the body chassis portion 92 (see FIG. 34) so that it may swing around the fixed shaft 97e. The other end of the cutter link 62b is mounted rotatably to one end of the cutter link 62a by the link pin 97c. The other end of this cutter link 62a is linked rotatably via a rink roller 97 to the V-shaped approach arm 60′. The gullet in the approach arm 60′ is mounted rotatably to the body chassis portion 92 with the pin 105a. Also, the fan-shaped gear 97a fixed in the gullet in the approach arm 60′ is also mounted rotatably to the body chassis portion 92 with the pin 105a.

Further, one end (rear end) of the left-side L-shaped approach arm 60″ is mounted rotatably to the body chassis portion 92 with the pin 105. Also, the fan-shaped gear 97b fixed to the rear end of the approach arm 60″ is also mounted rotatably to the body chassis portion 92 with the pin 105b. Owing to this configuration, if the link roller 97 is pushed in the direction of the arrow Q2, the cutter links 62a to 62c operate as a link around the fixed shaft 97e, thus inserting the cutter 62″ into the transfer passage 50e for the binder 13.

For example, the binding machine 2A′ shown in FIG. 40 is a top view of an example of the configuration of the major portion thereof and shows the tag hold mechanism 3A′, the binder formation mechanism 6A′, and the binder-fastening mechanism 7A′ of the binding machine 2A′ in the bind state shown in FIG. 38.

The link roller 97 of the binder formation mechanism 6A′ shown in FIG. 40 is pushed in the direction of the arrow Q2 so that the cutter link 62a which is link-connected to this link roller 97 is pushed up. The cutter link 62b which is link-connected by means of the link pin 97c to this cutter link 62a thus pushed up swings counterclockwise around the fixed shaft 97e. The cutter link 62c linked via the link pin 97d to this counterclockwise swung cutter link 62b is pushed down. Accordingly, the cutter 62″ which is linked-connected to this cutter link 62c is also pushed down so that the cutter 62″ is inserted into the transfer passage 50e for the binder 13, thus cutting off the binder 13 which is present in the transfer passage 50e.

Further, as described in FIG. 38, simultaneously with the operation of the cutter 62″, the right-side approach arm 60′ which is link-connected to the link roller 97 swings counterclockwise around the pin 105a. Simultaneously, the fan-shaped gear 97a also swings counterclockwise and the coupling gear 96a which is in mesh with this fan-shaped gear 97a rotates clockwise. If this coupling gear 96a rotates clockwise, the coupling gear 96b rotates counterclockwise and the fan-shaped gear 97b which is in mesh with this coupling gear 96b rotates clockwise. The left-side approach arm 60″ mounted to this fan-shaped gear 97b also swings clockwise around the pin 105. Therefore, the left-side and right-side approach arms 60″ and 60′ get closed and the left-side and right-side approach arms 60″ and 60′ can approximate the front and rear ends of the binder 13′ to the torsion arm 70.

Next, a description will be given of a configuration and an operation example of the tag transfer mechanism 4A′ with reference to FIGS. 41A to 44B. The tag transfer mechanism 4A′ shown in FIG. 41A is configured to have a cartridge 40B and a tag feed portion 41′. The cartridge 40B is one example of the tag storage portion and a plurality of the tags 1D is stored in this cartridge 40B in a condition where they are stacked. This cartridge 40B is inserted obliquely from the rear end side of the tag feed portion 41′ and mounted to the tag feed portion 41′.

The tag feed portion 41′ is provided with a tag feed roller 41a and a tag feed motor 41b. In this example, the tag feed roller 41a is constituted of a roller rotary shaft 41d and two roller rings 41e. The two roller rings 41e are press-fitted to the roller rotary shaft 41d and fixed with spacing therebetween. To one end of this roller rotary shaft 41d, a gear 41c is mounted. Material of the roller rings 41e is, for example, rubber material. Of course, other materials than rubber material may be used as far as they have large frictional force with the tag 1D.

The tag feed roller 41a is mounted rotatably to a front of a bottom of the tag feed portion 41′ in such a manner that the roller rotary shaft 41d is perpendicular to a direction in which the tags 1D stored in the cartridge 40B are fed out. In this case, the roller rings 41e that are press-fitted to the roller rotary shaft 41d abut against the lowest one of the tags 1D in the cartridge 40B.

The tag feed motor 41b is mounted on a side surface of the tag feed portion 41′. The gear 41c of the tag feed roller 41a meshes with a rotary shaft of the tag feed motor 41b. Owing to this configuration, based on the rotation of the tag feed motor 41b, the tag feed roller 41a rotates a predetermined number of times to feed out the tags 1D stored in the cartridge 40B one by one starting from the lowest one. It should be noted that as the tag feed motor 41b, for example, a stepping motor is used.

The tag feed portion 41′ is further provided with a tag feed guide 42. This tag feed guide 42 functions as one example of a guide portion, to guide the tag 1D fed by the tag feed portion 41′. The tag feed guide 42 is provided with left-side and right-side guide flaps 42a which are one example of first and second curving members, respectively, working pins 42b which are one example of first and second working members, respectively, swing shafts 42d, and links 42e and 42f. The links 42e and 42f constitute one example of first link members. Further, the links 42e and 42f constitute one example of second link members.

The left-side and right-side guide flaps 42a constitute one example of the first and second curving members, respectively and mounted in such a manner that they can be opened and closed. In this example, a shape of the guide flaps 42a is the shape of a curved plate. The links 42e are provided on an upper wall face of the guide flaps 42a, while the links 42f are fitted to the links 42e at their one ends at predetermined angles. At positions where the links 42e and 42f are coupled with each other, the swing shafts 42d are mounted. Further, at forward ends of the links 42f, the working pins 42b are mounted. Further, at the links 42e, tension-spring pins 42g are mounted and at the tension-spring pins 42g, a tension spring 42h (see FIG. 42B) is mounted. This tension spring 42h pulls the respective links 42e of the left-side and right-side guide flaps 42a in such a manner that they face each other. The guide flaps 42a shown in FIG. 41A are in their closed state. In this state, the guide flaps 42a guide the tag fed by the tag feed portion 41′ along the shape of the curved plate.

Further, as shown in FIG. 41B, a reflection-type tag sensor 109 is embedded and mounted in a front face of the tag feed portion 41′. This tag sensor 109 detects whether the tag 1D has been fed out by the tag feed roller 41a.

The guide flaps 42a shown in FIG. 41B are in their open state. To open the guide flaps 42a from each other, the working pins 42b are pushed out in a direction of an arrow Q3 shown in FIG. 41B (the same direction as that of the arrow Q3 shown in FIG. 38). If the working pins 42b are pushed out in the direction of the arrow Q3, the left-side and right-side guide flaps 42a move around the swing shafts 42d in such a manner as to separate from each other. In this case, the left-side and right-side guide flaps 42a have been pulled by the tension spring 42h in such a manner as to approach each other. Therefore, if the working pins 42b pushed in the direction of the arrow Q3 are released, the left-side and right-side guide flaps 42a are approximated to each other by means of force of the tension spring 42h, thereby returning to their closed state shown in FIG. 41A. In such a manner, the left-side and right-side guide flaps 42a are opened from each other and closed to each other.

The curl guide 30B shown in FIG. 42A is placed to the home position HP shown in FIG. 37. In this case, the guide flaps 42a of the tag feed guide 42 in the tag transfer mechanism 4A′ are in the closed state. In this closed state, the left-side and right-side links 42e are pulled in such a manner as to face each other by the tension spring 42h (see FIG. 42B) attached to the tension-spring pins 42g of the links 42e of the left-side and right-side guide flaps 42a. Further, the working pins 42b which operate the left-side and right-side guide flaps 42a are respectively put into left-side and right-side concave portions 30g in the curl guide 30B.

The left-side and right-side guide flaps 42a shown in FIG. 42B are in a state where the curl guide 30B has shifted from the home position HP to the bind position P1 shown in FIG. 38 and also they have shifted from their closed state to their open state. In such a manner, to permit the guide flaps 42a to shift into their open state, the curl guide 30B slides and (moves forward) to drive the working pins 42b dropped into the concave portions 30g in the curl guide 30B in such a manner that they are pushed forward and also pushed up. This causes the left-side and right-side guide flaps 42a to be opened from each other as swinging around the swing shafts 42d via the links 42f and 42e each fitted with the working pin 42b, thereby moving the curl guide 30B forward. In this case, the links 42e of the left-side and right-side guide flaps 42a are pulled so as to face each other by the tension spring 42h fitted to the tension-spring pins 42g of the links 42e of the left-side and right-side guide flaps 42a.

If the curl guide 30B shown in FIG. 42B has retreated and returned to the position shown in FIG.42A, the working pins 42b drop into the concave portions 30g in the curl guide 30B and pushed back again. This causes the left-side and right-side guide flaps 42a to be closed to each other as swinging around the swing shafts 42d via the links 42f and 42e fitted with the working pins 42b. In such a manner, the left-side and right-side guide flaps 42a are opened and closed by interlocking with the sliding movement of the curl guide 30B.

In the cartridge 40B of the tag transfer mechanism 4A′ shown in FIG. 43A, a plurality of the tags 1D is stored in a condition where they are stacked. The cartridge 30B has a tag take-out hole 40a formed in its front bottom face. This tag take-out hole 40a is formed to be opened such an extent that the mounting portion 11D of the tag 1D may appear from it when storing the tags.

The cartridge 40B is pushed in an oblique direction of an arrow Q4 with respect to the tag feed portion 41′ and then mounted in the tag feed portion 41′ as inclined in a condition where a locking hole 40b in the cartridge 40B is hooked by a lock claw 41f of the tag feed portion 41′. If the cartridge 40B is mounted in the tag feed portion 41′, the mounting portion 11D of the tag 1D appearing from the tag take-out hole 40a in the cartridge 40B abuts against the roller rings 41e of the tag feed roller 41a of the tag feed portion 41′.

In this abutting state, the tag feed roller 41a is rotated. If the tag feed roller 41a is rotated, the lowest one of the tags 1D in the cartridge 40B is fed out as shown in FIG. 43B. In this case, the concave portions 12n of the tag 1C shown in FIG. 7A are formed so that a total sum of an angle θ1 between the side 10Ca of the concave portion 12n on the side of the information-showing portion 10C and the side 12Ca of the concave portion 12n on the side of the coupling portion 12C and an angle θ2 between the side 11Ae of the concave portion 12n on the side of the mounting portion 11D and the side 12Ca of the concave portion 12n on the side of the coupling portion 12C may be greater than 180 degrees. Accordingly, when one of the tags 1D stacked in the cartridge 40B is fed out using the tag feed roller 41a and if the respective sides 10Ca of the concave portions 12n in that tag 1D intersect with the sides 11Ae, 11Ad and come in contact with them, it slides obliquely without engaging the sides 10Ca with the sides 11Ae and 11Ad (see FIG. 6).

The fed-out tag 1D is guided along the shape of the curved plate of the guide flaps 42a. In this case, the guide flaps 42a guide the tag 1D in such a manner that the mounting portion 11D of the tag 1D may face substantially perpendicularly and then stops feeding-out the tag 1D at a position where the concave portions 12n in the tag 1D may appear above the tag feed portion 41′. In such a manner, the tags 1D stored in the cartridge 40B of the tag transfer mechanism 4A′ are fed out and guided.

The tag transfer mechanism 4A′ shown in FIG. 44A is in a condition where the curl guide 30B is disposed on the tag 1D which is guided so that the mounting portion 11D of the tag 1D may face substantially perpendicularly by the guide flaps 42a of the tag feed guide 42 in the tag transfer mechanism 4A′ shown in FIG. 43B. In this example, the tag mounting portion 11D of the tag 1D is guided among an L-shaped tag support 30e mounted on a front of the curl guide 30B and the tag latching claw portions 30b of the curl guide 30B. That is, the concave portions 12n formed in the lower part of the tag 1D's mounting portion 11D are disposed so as to face the tag latching claw portions 30b of the curl guide 30B.

In a condition where the concave portions 12n in the tag 1D are disposed so as to face the tag latching claw portions 30b of the curl guide 30B, the curl guide 30B slides and (moves forward) as shown in FIG. 44B. This causes the concave portions 12n in the tag 1D to be hooked by the tag latching claw portions 30b of the curl guide 30B and also the mounting portion 11D of the tag 1D to be supported by the tag support 30e. Further, as the curl guide 30B moves forward, the working pins 42b dropped into the concave portions 30g in the curl guide 30B are pushed forward and also pushed up so that the left-side and right-side guide flaps 42a maybe opened from each other as swinging. Accordingly, the tag 1D held on the curl guide 30B can pass through the opening in the left-side and right-side guide flaps 42a.

In such a manner, in the left-side and right-side guide flaps 42a, when the curl guide 30B moves from the home position HP shown in FIG. 37 with holding the tag 1D, the left-side and right-side guide flaps 42a are opened as shown in FIG. 44B. Further, in the guide flaps 42a, when the curl guide 30B releases the tag 1D held on it and returns to the home position HP, the left-side and right-side guide flaps 42a are closed as shown in FIG. 44A.

Thus, the guide flaps 42a do not interfere with the tag 1D when it is moved, thereby enabling the tag 1D to move smoothly. Moreover, since the curl guide 30B can moved linearly, the curl guide 30B need not accompany waste motion, thus improving the processing efficiency of this binding machine 2A′.

Next, a description will be given of a configuration and a function example of the cartridge 40B with reference to FIGS. 45A to 48B. The cartridge 40B shown in FIG. 45A is a view of the cartridge 40B viewed from the bottom thereof. The cartridge 40B shown in FIG. 45B is a view of the cartridge 40B viewed from the top thereof. The cartridge 40B is provided with a body portion 40p, a tag position adjustment portion 40c, and tag position restriction portions 40d. The tag position restriction portions 40d are provided on a front side of the body portion 40p and restrict the delivery-directional front and rear positions of a plurality of the tags 1D stored in the cartridge 40B. In this example, the tag position restriction portions 40d performs the restriction by holding the peripheral sides 11Aa to 11Ae that form the outline of the mounting portion 11D of the tag 1D shown in FIG. 7A. For example, the tag position restriction portions 40d are provided with tag latching protrusions 40k having predetermined shapes and constituting one example of the protrusion and so supports the sides 11Ad and 11Ae by engaging the tag latching protrusions 40k with the concave portions 12n in the tag 1D, thus restricting the front and rear positions of the tags 1D.

Further, the sides 11Ab, 11Ac are held by protrusions 40k′, 40k′ and also the side 11Aa is held by a wall face 40k″. Accordingly, the peripheral sides 11Aa to 11Ac of the tag 1D's mounting portion 11D are supported by the tag latching protrusions 40k and 40k′ and the wall face 40k″, thereby restricting the delivery-directional front and rear positions of the tags 1D.

It should be noted that in the case of disposing the cartridge 40B obliquely as in the present embodiment, among the tag latching protrusions 40k and 40k′ and the wall face 40k″, any one which presents on the lower side of the inclination in the cartridge 40B may be important, so that in the case of disposing it so that the rear end side is positioned on the lower side like the present embodiment, the tag latching protrusions 40k may be the most important site in position restriction.

The tag position restrictions 40d are formed integrally into the frame (body portion 40p) of the cartridge 40B. This body portion 40p is formed, for example, by applying an injection pressure to thermoplastic resin heated to its softening temperature and pushing it into a mold. A shape of the body portion 40p is a shape of a substantially rectangular solid, and its top and rear faces thereof are opened and its front and bottom faces are opened partially.

The tag position adjustment portion 40c is provided on the rear side of the body portion 40p and adjusts the right and left positions of a plurality of the tags 1D whose front and rear positions have been restricted by the tag position restriction portion 40d. In this example, the tag position adjustment portion 40c is provided with left-side and right-side tag width adjustment plates 40i and a tag width adjustment mechanism 40n. The left-side and right-side tag width adjustment plates 40i are one example of first and second alignment members and so adjust the right and left positions of the tags 1D. The tag width adjustment mechanism 40n functions as one example of an adjustment mechanism and is disposed between the left-side and right-side tag width adjustment plates 40i to adjust the positions of these left-side and right-side tag width adjustment plates 40i. This tag width adjustment mechanism 40n is provided with a tag width adjustment dial 40e which is one example of the rotary member, pins 40f, long holes 40g, slits 40h, and two links 40j (see FIGS. 47A and 47B) which are one example of the first and second coupling members.

The two slits 40h and the long holes 40g are formed in the latitudinal direction of the bottom face of the body portion 40p. Into the slits 40h, two sheets of the L-shaped tag width adjustment plates 40i each constituted of a bent iron plate are fitted slidably.

To each of predetermined positions of these tag width adjustment plates 40i, one end of each of the links 40j of FIGS. 47A and 47B is linked with the pin 40f rotatably. In this case, this pin 40f is inserted into the long hole 40g. The other end of each link 40j is linked to the bottom portion of the tag width adjustment dial 40e rotatably.

Owing to this configuration, if the tag width adjustment dial 40e is rotated in one direction, the tag width adjustment mechanism 40n adjusts spacing between the left-side and right-side tag width adjustment plates 40i so as to be decreased and, if the tag width adjustment dial 40e is rotated in the other direction, it adjusts spacing between the left-side and right-side tag width adjustment plates 40i so as to be increased. Therefore, the left-side and right-side tag width adjustment plates 40i move in such a direction as to get close to or go away from each other along the slits 40h.

FIG. 46A is a view when the cartridge 40B is viewed obliquely and FIG. 46B is a view when the cartridge 40B is viewed from the top. In the cartridge 40B shown in FIGS. 46A and 46B, a plurality of the tags 1D is mounted and stored in a condition where they are stacked. When mounting the tags 1D into the cartridge 40B, they are mounted with the mounting portions 11D of the tags 1D being fitted into the tag position restriction portions 40d of the cartridge 40B.

In the condition where the mounted tags 1D are stacked, the tag position restriction portions 40d performs the restriction by holding the peripheral sides constituting the outline of the mounting portions 11D of the tags 1D. In this example, as shown in FIG. 43A, the cartridge 40B is mounted to the tag feed portion 41′ as inclined, so that due to the own weight of the tags 1D, the sides 11Ad and 11Ae of the mounting portions 11D of the tags 1D are caught by the tag latching protrusions 40k of the tag position restriction portions 40d to be engaged therewith. Thus, the front and rear positions of the tags 1D are restricted.

Further, as the tag width adjustment dial 40e shown in FIG. 45A is rotated, the tag position adjustment portion 40c moves in such a direction that the tag width adjustment plates 40i separated from each other may get close to each other. The tag position adjustment portion 40c adjusts the width of the tags 1D by sandwiching both side ends 10a between the face portions of the tag width adjustment plates 40i of this tag 1D. By thus adjusting the right and left positions of the tags 1D whose front and rear positions are restricted, these tags 1D can be stored in a condition where they are aligned. Accordingly, when storing a plurality of the tags 1D, only the right and left positions thereof need to be adjusted, thereby enabling the tags 1D to be easily aligned and stored. Moreover, since the front and rear positions of the tags 1D have been restricted, the tags 1D can be prevented from slipping down even if the tag storage portion is inclined.

FIG. 47A is a view when the tag position adjustment portion 40c is viewed obliquely and FIG. 47B is a view when the tag position adjustment portion 40c is viewed from the top. On a broken-line circumference R of the bottom face of the tag width adjustment dial 40e shown in FIG. 47B, one end of each of the two links 40j is attached rotatably with the pin 40m in such a manner that the ends may face each other. The other ends of the links 40j are mounted rotatably to predetermined positions on the left-side and right-side tag width adjustment plates 40i by means of the pins 40f. If the tag width adjustment dial 40e is rotated clockwise, the left-side and right-side tag width adjustment plates 40i move in such a direction as to separate from each other, and if the tag width adjustment dial 40e is rotated counterclockwise, the left-side and right-side tag width adjustment plates 40i move in such a direction as to get close to each other.

FIG. 48A is a view when the tag position adjustment portion 40c is viewed obliquely and FIG. 48B is a view when the tag position adjustment portion 40c is viewed from the top. If the tag width adjustment dial 40e of the tag position adjustment portion 40c shown in FIGS. 47A and 47B is rotated counterclockwise, the pins 40m rotate which are set on the broken-line circumference R of the tag width adjustment dial 40e shown in FIGS. 47A and 47B. Due to this rotation, the two links 40j attached by the pins 40m are pulled toward the tag width adjustment dial 40e. In this case, the left-side and right-side tag width adjustment plates 40i attached to these links 40j are also pulled toward the tag width adjustment dial 40e, so that the left-side and right-side tag width adjustment plates 40i get close to each other. In such a manner, by rotating the tag width adjustment dial 40e, the left-side and right-side tag width adjustment plates 40i get close to each other or get away from each other.

Next, a description will be given of an example of functions of the cartridge 40B at the time of storing the tags 1H with reference to FIGS. 49A and 49B. In the cartridge 40B shown in FIGS. 49A and 49B, a plurality of the tags 1H is mounted and stored in a condition where they are stacked. When mounting the tags 1H into the cartridge 40B, they are mounted with the mounting portions 11H of the tags 1H being fitted into the tag position restriction portion 40d of the cartridge 40B.

In the condition where the mounted tags 1H are stacked, the tag position restriction portion 40d performs the restriction by holding the peripheral sides constituting the outline of the mounting portions 11H of the tags 1H. In this example, as shown in FIG. 43B, the cartridge 40B is mounted to the tag feed portion 41′ as inclined. Therefore, due to the own weight of the tags 1H, the engagement portions 12q in the mounting portions 11H of the tags 1H are caught by the tag latching portions 40k of the tag position restriction portion 40d on both sides to be engaged therewith. Thus, the front and rear positions of the tags 1H are restricted.

Further, as the tag width adjustment dial 40e shown in FIG. 45A is rotated, the tag position adjustment portion 40c moves in such a direction that the tag width adjustment plates 40i separated from each other may get close to each other. In this case, the width of the tags 1H is adjusted by sandwiching both side ends 10b of the tags 1H between the face portions of the tag width adjustment plates 40i.

By thus adjusting the right and left positions of the tags 1H whose front and rear positions are restricted, these tags 1H can be stored in a condition where they are aligned. Accordingly, when storing a plurality of the tags 1H, only the right and left positions thereof need to be adjusted, thereby enabling the tags 1H to be easily aligned and stored. Moreover, since the front and rear positions of the tags 1H have been restricted already, the tags 1H can be prevented from slipping down even if the tag storage portion is inclined.

Next, a description will be given of a function example of a cartridge 40C with reference to FIGS. 50A and 50B. In the cartridge 40C shown in FIGS. 50A and 50B, a plurality of the tags 1I is mounted and stored in a condition where they are stacked.

When mounting the tags 1I into the cartridge 40C, first the mounting portions 11I of the tags 1I are fitted into the tag position restriction portions 40d on both side of the cartridge 40C in a condition where the L-shaped tag width adjustment plates 400i of the tag position adjustment portion 400c are separated from each other. Further, the information-showing portions 10I are mounted by fitting them into the tag width adjustment plates 400i on both sides. In the condition where the mounted tags 1I are mounted, the tag position restriction portions 40d restrict the sides that form an angle of the mounting portions 11I of the tags 1I.

Next, a tag with adjustment dial, not shown in FIG. 50A or 50B, which has almost the same configuration as that of the tag width adjustment dial 40e shown in FIG. 45A, is rotated to move the tag width adjustment plates 400i separated from each other in such a direction that they may get close to each other. In this case, the width of the tags 1I is adjusted by sandwiching both side ends 10c of the tags 1I between side face portions 401 of the tag width adjustment plates 400i. Furthermore, the bottom portions 10d of the tags 1I are supported by bottom face portions 402 of the tag width adjustment plates 400i.

In this example, as shown in FIG. 43B, the cartridge 40C is mounted to the tag feed portion 41′ as inclined, so that due to the own weight of the tags 1I, the bottom portions 10d of the tags 1I are aligned on the bottom face portions 402 of the tag width adjustment plates 400i.

A description will be given of a function example of a cartridge 40D with reference to FIGS. 51A and 51B. In the cartridge 40D shown in FIGS. 51A and 51B, a plurality of the tags 1J is mounted and stored in a condition where they are stacked.

When mounting the tags 1J into the cartridge 40D, they are mounted with the mounting portions 11J of the tags 1J being fitted into the tag position restriction portions 40d of the cartridge 40D. In this case, the protrusions 12s on both horizontal ends of the mounting portion 11J are fitted into the concave portions 400k in the tag position adjustment portions 40d on both sides.

In the condition where the tags 1J are mounted, the tag position restriction portions 40d performs the restriction by holding the peripheral sides constituting the outline of the mounting portions 11J of the tags 1J. In this example, as shown in FIG. 43B, the cartridge 40D is mounted to the tag feed portion 41′ as inclined. Therefore, due to the own weight of the tags 1J, the protrusions 12s of the mounting portions 11J of the tags 1J are caught by the concave portions 400k in the tag position adjustment portions 40d on both sides. Thus, the front and rear positions of the tags 1J are restricted.

Further, as the tag width adjustment dial 40e shown in FIG. 45A is rotated, the tag position adjustment portion 40c moves in such a direction that the tag width adjustment plates 40i separated from each other may get close to each other. In this case, the width of the tags 1J is adjusted by sandwiching both side ends 10e of the tags 1J between the face portions of the tag width adjustment plates 40i. By thus adjusting the right and left positions of the tags 1J whose front and rear positions are restricted, these tags 1J can be stored in a condition where they are aligned. Accordingly, when storing a plurality of the tags 1J, only the right and left positions thereof need to be adjusted, thereby enabling the tags 1J to be easily aligned and stored. Moreover, since the front and rear positions of the tags 1J have been restricted already, it is possible to prevent the tags 1J from slipping down even if the tag storage portion is inclined and to eliminate the necessity of the bottom face portions 402 of the tag width adjustment plates 400i shown in FIGS. 50A and 50B.

Next, a description will be given of a configuration example of the curl guide 30B in the tag hold mechanism 3A′ with reference to FIG. 52. The tag hold mechanism 3A′ shown in FIG. 52 has the curl guide 30B.

The curl guide 30B has a body portion 301 constituting a T-shaped block in such a configuration that at a lower part of the front face of this body portion 301, a pair of tag latching claw portions 30b, 30b which function as a claw portion is mounted so as to hook, for example, the mounting portion 11D formed on the tag 1D.

Besides, the curl guide 30B has the curving guide protrusion 30a′ on the front face of the body portion 301 and in the curving guide protrusion 30a′, a groove-shaped binder passage 303 is formed. At an upper part of the front face of the curl guide 30B, hood-shaped protrusions 30d, 30d are formed so that the mounting portion 11D of the tag 1D is fitted between the tag latching claw portions 30b, 30b and the hood-shaped protrusions 30d, 30d at the upper part. It is configured so that by the curl guide 30B, the binder passage 303 and the catching holes 11p, 11p in the tag 1D are self-aligned with each other and the binder 13 is passed from one of the catching holes 11p to the other catching hole 11p. The binder passage 303 has its front side open.

To a predetermined site extending from the upper part of the curl guide 30B to the binder passage 303, the tag support member 30e which constitutes the tag hold mechanism 3A′ is mounted, to support the upper end of the tag 1D when transferring it. As the tag support member 30e, a metal- or resin-made component is used which is obtained by processing the body of the member into an L-shape. In this example, a concave portion 304 for tag support attachment is formed at the upper part of the leading end of the curl guide 30B so that the tag support member 30e is attached into this concave portion 304 and fixed with a screw 302. The L-shaped site of the tag support member 30e is mounted in such a posture as to face the tags approaching direction. This is for the purpose of blocking the rotation of the tag 1D at the leading end of the L-shaped site of the tag support member 30e.

A description will be given of a configuration example of the curl guide 30B at the time of tag support attachment with reference to FIG. 53.

According to the curl guide 30B shown in FIG. 53, assuming an angle at which the member body is formed on the tag support member 30e to be θ and an allowance angle to be α, the angle θ is set to θ=90°+α. Such a curl guide 30B enables supporting this tag 1D with a good reproducibility. The allowance angle α is provided to make the tag 1D easy to be pulled out of the curl guide 30B after the binding thereof. The allowance angle a is set to, for example, about 5-45°.

A description will be given of a comparative example (whether supported or not) about the tag support member 30e in the curl guide 30B with reference to FIG. 54.

The curl guide 30B shown in FIG. 54 is in a case where the tag support member 30e is equipped (the tag support member 30e is provided). In this case, the tag 1D is held at three points of the pair of tag latching claw portions 30b, 30b and the tag support member 30e. By thus constituting the tag hold mechanism 3A′, the rotation of the tag 1D around the tag latching claw portions 30b, 30b is blocked.

In this example, the tag support member 30e is mounted on the concave portion 304 for tag support attachment formed at the upper part of the leading end of the curl guide 30B in such a manner that the L-shaped site thereof faces downward.

Thus, in the case of using the two catching holes 11p, 11p provided in the tag 1D to bind the tape-shaped cut-off binder 13′ around the bag 14 at its folded top and attaching this tag 1D to the folded top of the bag 14, the tag support member 30e is mounted to the upper part of the leading end of the curl guide 30B so that it functions as hooking the upper part of the tag.

It becomes thus possible to block the rotation of the tag 1D around the tag latching claw portions 30b, 30b. Accordingly, it is possible to prevent the tag 1D from dropping due to the rotation of the tag in contrast to the case where the tag support member 30e is not mounted. Further, it is possible to pull the binder 13 inserted into one catching hole 11p of the tag 1D out of the other catching hole 11p with good reproducibility. Moreover, the tag 1D can be pulled out of the transfer passage 4A′ smoothly after the binding thereof, thereby providing the binding machine 2A′ with high reliability.

A description will be given of a configuration example of the curl guide 30C with reference to FIG. 55. The curl guide 30C shown in FIG. 55 is applied to a case of holding the tag 1H shown in FIGS. 10A and 10B and has the tag latching claw portions 300c which are different from the tag latching claw portions 30b of the curl guide 30B shown in FIG. 52 in a structure thereof. It should be noted that identical reference numerals are given to identical components of the curl guide 30B shown in FIG. 52, a detailed description of which will be omitted.

The curl guide 30C has a body portion 301c constituting a T-shaped block in such a configuration that at both ends of the lower part of the front face of this body portion 301c, a pair of tag latching claw portions 300c, 300c which function as a claw portion is mounted. These tag latching claw portions 300c are arranged to engage with the engagement portions 12q of the mounting portion 11H formed on the tag 1H shown in FIGS. 10A and 10B.

Besides, the curl guide 30C has the curving guide protrusion 30a′ on the front face of the body portion 301c and in the curving guide protrusion 30a′, a groove-shaped binder passage 303 is formed. At the upper part of the front face of the curl guide 30C, the hood-shaped protrusions 30d, 30d are formed so that the mounting portion 11H of the tag 1H is fitted between the tag latching claw portions 300c, 300c and the hood-shaped protrusions 30d, 30d at the upper part. It is configured so that by the curl guide 30C, the binder passage 303 and the catching holes 11u, 11u in the tag 1H are aligned by each of the tag latching claw portions 300c and the binder 13 is passed from one of the catching holes 11u to the other catching hole 11u.

A description will be given of an example of holding the tag 1H in the curl guide 30C with reference to FIG. 56. In this example, the tag 1H shown in FIG. 56 is transferred by the tag transfer mechanism 4A′ shown in FIG. 43B so that the mounting portion 11H of the tag 1H may be positioned in a front of the curl guide 30C. In this state, the curl guide 30C moves forward so as to hold the tag 1H.

In this case, the mounting portion 11H of the tag 1H is fitted to a portion surrounded by the protrusions 30d, 30d and the tag latching claw portions 300c, 300c on the curl guide 30C. In this state, the tag latching claw portions 300c on the curl guide 30C each engage with each of the engagement portions 12q of the tag 1H to support this tag 1H. It is thus possible to hold the tag 1H.

Further, the tag 1H is positioned by the cooperation of each of the engagement portions 12q and each of the tag latching claw portions 300c on the curl guide 30C, respectively. Accordingly, the positions of the catching holes 11u, 11u and the gateways of the binder passage 303 in the curl guide 30C can be aligned with each other, thereby interconnecting the two catching holes 11u by using this binder passage 303.

A description will be given of an example of holding the tag 1K in the curl guide 30C with reference to FIG. 57. In this example, the tag 1K shown in FIG. 57 is transferred by the tag transfer mechanism 4A′ shown in FIG. 43B so that the mounting portion 11K of the tag 1K may be positioned in a front of the curl guide 30C. In this state, the curl guide 30C moves forward so as to hold the tag 1K.

In this case, the mounting portion 11K of the tag 1K is fitted to a portion surrounded by the protrusions 30d, 30d and the tag latching claw portions 300c, 300c of the curl guide 30C. In this state, the tag latching claw portions 300c of the curl guide 30C each engage with each of the engagement portions 12t of the tag 1K to support this tag 1K. It is thus possible to hold the tag 1K.

Further, the tag 1K is positioned by the cooperation of each of the engagement portions 12t and each of the tag latching claw portions 300c of the curl guide 30C. Accordingly, the positions of the catching holes 11u, 11u and the gateways of the binder passage 303 in the curl guide 30C can be aligned with each other, thereby interconnecting the two catching holes 11u by this binder passage 303.

A description will be given of a configuration example of a curl guide 30D with reference to FIG. 58. The curl guide 30D shown in FIG. 58 is applied to the case of holding the tag 1I shown in FIGS. 11A and 11B and has the tag latching claw portions 300d which are different from the tag latching claw portions 300c from the curl guide 30C shown in FIG. 55 in a structure thereof. It should be noted that identical reference numerals are given to identical components of the curl guide 30C shown in FIG. 55, a detailed description of which will be omitted.

The curl guide 30D shown in FIG. 58 has a body portion 301d constituting a T-shaped block in such a configuration that near the middle of the lower part of the front face of this body portion 301d, a pair of tag latching claw portions 300d, 300d which constitute function of a claw portion is mounted. These tag latching claw portions 300d are arranged to be hooked by inserting them into the engagement portions 12r of the mounting portion 11I formed, for example, on the tag 1I shown in FIGS. 11A and 11B.

Besides, the curl guide 30D has the curving guide protrusion 30a′ on the front face of the body portion 301d and in the curving guide protrusion 30a′, a groove-shaped binder passage 303 is formed. At the upper part of the front face of the curl guide 30D, the hood-shaped protrusions 30d, 30d are formed so that the mounting portion 11I of the tag 1I is fitted between the tag latching claw portions 300d, 300d and the hood-shaped protrusions 30d, 30d at the upper part. It is configured so that by the curl guide 30D, the binder passage 303 and the catching holes 11u, 11u in the tag 1H are aligned by each of the tag latching claw portions 300d and the binder 13 is passed from one of the catching holes 11u to the other catching hole 11u.

A description will be given of an example of holding the tag 1I in the curl guide 30D with reference to FIG. 59. In this example, the tag 1I shown in FIG. 59 is transferred by the tag transfer mechanism 4A′ shown in FIG. 43B so that the mounting portion 11I of the tag 1I may be positioned in a front of the curl guide 30D. In this state, the curl guide 30D moves forward so as to hold the tag 1I.

In this case, the mounting portion 11I of the tag 1I is positioned below the protrusions 30d, 30d and above the tag latching claw portions 300d, 300d on the curl guide 30D. Into the engagement portion 12r of the tag 1I, the tag latching claw portions 300d, 300d on the curl guide 30D are inserted so that the tag 1I may be supported by each of the tag latching claw portions 300d. It is thus possible to hold the tag 1I.

Further, the tag 1I is positioned by the cooperation of the engagement portion 12r and the tag latching claw portions 300d of the curl guide 30D. Accordingly, the positions of the catching holes 11u, 11u and the gateways of the binder passage 303 in the curl guide 30D can be aligned with each other, thereby interconnecting the two catching holes 11u by this binder passage 303.

A description will be given of an example of holding the tag 1J in the curl guide 30D with reference to FIG. 60. The tag 1J shown in FIG. 60 is transferred by the tag transfer mechanism 4A′ shown in FIG. 43B so that the mounting portion 11I of the tag 1J is positioned in a front of the curl guide 30D. In this state, the curl guide 30D moves forward so as to hold the tag 1J.

In this case, the mounting portion 11J of the tag 1J is positioned below the protrusions 30d, 30d and above the tag latching claw portions 300d, 300d on the curl guide 30D. Into the engagement portion 12r of the tag 1J, the tag latching claw portions 300d, 300d of the curl guide 30D are inserted so that the tag 1J is supported by each of the tag latching claw portions 300d. It is thus possible to hold the tag 1J.

Further, the tag 1J is positioned by the cooperation of the engagement portion 12r and the tag latching claw portions 300d of the curl guide 30D. Accordingly, the positions of the catching holes 11u, 11u and the gateways of the binder passage 303 in the curl guide 30D can be aligned with each other, thereby interconnecting the two catching holes 11u by this binder passage 303. It should be noted that the protrusions 12s on both horizontal ends of the mounting portion 11J have been fitted into the concave portions 400k in the cartridge 40D shown in FIG. 51A so as to restrict the front and rear positions of the tags 1J, but they do not act on the curl guide 30D at all.

A description will be given of an example of holding the tag 1L in the curl guide 30D with reference to FIG. 61. In this example, the tag 1L shown in FIG. 61 is transferred by the tag transfer mechanism 4A′ shown in FIG. 43B so that the mounting portion 11L of the tag 1L is positioned in a front of the curl guide 30D. In this state, the curl guide 30D moves forward so as to hold the tag 1L.

In this case, the mounting portion 11L of the tag 1L is positioned below the protrusions 30d, 30d and above the tag latching claw portions 300d, 300d on the curl guide 30D. Into the engagement portions 12u, 12u of the tag 1L, the tag latching claw portions 300d, 300d of the curl guide 30D are inserted so that the tag 1L is supported by each of the tag latching claw portions 300d. It is thus possible to hold the tag 1L.

Further, the tag 1L is positioned by the cooperation of each of the engagement portions 12u and each of the tag latching claw portions 300d of the curl guide 30D. Accordingly, the positions of the catching holes 11u, 11u and the gateways of the binder passage 303 in the curl guide 30D can be aligned with each other, thereby interconnecting the two catching holes 11u by this binder passage 303.

Next, a description will be given of a configuration and a function example of the bobbin 52′ of the binding machine 2A′ with reference to FIG. 62. At a core 52a of the bobbin 52′ shown in FIG. 62, an opening 52b is provided. On an installation table 90 of the binding machine 2A′, a rotary shaft rod 90a is mounted perpendicularly. In order to fit the rotary shaft rod 90a of the installation table 90 to the opening 52b in the bobbin 52′, the rotary shaft rod 90a is designed to have a diameter a little smaller than that of the opening 52b.

In the case of mounting this bobbin 52′ on the installation table 90 of the binding machine 2A′, a user mounts it rotatably by fitting into the opening 52b in the core 52a of the bobbin 52′ the rotary shaft rod 90a of the installation table 90 provided horizontally with respect to the ground. In this example, the bobbin 52′ is mounted in such a manner that the core 52a of the bobbin 52′ may be substantially perpendicular to the installation table 90. Accordingly, when the binder 13 is pulled out and the bobbin 52′ rotates, friction occurs between an installation face 90b of the installation table 90 and the bobbin 52′ contacting this installation face 90b.

After the installation, the user pulls out the binder 13 wound around the bobbin 52′ and stretches this binder 13 over between the driven rollers 50b and 50c. Then, the user rotates a lever 50d to widen the gap between the driven roller 50f (see FIG. 37) and the binder feed roller 50a so that the binder 13 may pass through it, thus setting the front end of this binder 13 to the position of the cutter 62″ shown in FIG. 37.

In this case, the core 52a which the binder 13 is wound around has been set on the installation table perpendicularly. Accordingly, if the binder 13 is made of a covered iron core, in a step of pulling this binder 13 and then binding it, the binder 13 can be bound to the bag 14 in a condition where the posture of this binder 13 is kept as pulled out. This prevents the covered binder 13 from being twisted so that the movements of this binder 13 may be eased in the machine, thereby improving the performance of this binding machine 2A′.

A description will be given of a configuration example of a control system of the binding machine 2A′ with reference to FIG. 63. The control system shown in FIG. 63 is provided with a control section 110 and motor drive sections 141b, 193, 150i, and 170c. This control section 110 is comprised of a CPU 114, an RAM 112, an EEPROM 113, an I/O interface 111, and a system bus 115. It should be noted that an approach motor 93 shown in FIG. 63 is identical to the approach motor 93 shown in FIG. 37 and a tag feed motor 41b shown in FIG. 63 is identical to the tag feed motor 41b shown in FIGS. 41A and 41B.

The Electrically Erasable Programmable Read-Only Memory (EEPROM) 113 in the control section 110 is connected to the Central Processing Unit (CPU) 114 via the system bus 115. This EEPROM 113 saves a control program for the binding machine 2A′. This control program allows to be performed the processing of detecting the setting of the bag 14 to the binding opening 103, then transferring the tag 1D to feed out the binder 13, cutting off this binder 13 passed through the tag 1D and twisting it.

The Random Access Memory (RAM) 112 is connected to the CPU 114 via the system bus 115. If a power supply of the binding machine 2A′ is actuated, the control program saved in the EEPROM 113 is developed by the CPU 114.

The CPU 114 is connected to the tag sensor 109 via the Input/Output (I/O) interface 111, so that if the tag 1D is being transferred, transfer data D8 indicating that the tag 1D is being transferred is input from the tag sensor 109. If the tag is not being transferred, the CPU 114 inputs the transfer data D8 indicating that the tag 1D is not being transferred from the tag sensor 109. Based on this transfer data D8, the CPU 114 outputs control data D2 for rotating the tag feed motor 41b to the motor drive section 141b.

Further, the CPU 114 is connected to an operation section 106 via the I/O interface 111 and inputs operation data D1 indicating a type of the tag 1D from the operation section 106. Based on this operation data D1, the CPU 114 varies a feed amount of the tag 1D.

Further, the CPU 114 is connected to a bag sensor 108 via the I/O interface 111. This bag sensor 108 detects whether the bag 14 is disposed to the binding opening 103 by the arm 121 (see FIG. 62) mounted in the vicinity of the binding opening 103. The CPU 114 inputs bag detection data D7 detected by this bang sensor 108.

Further, the CPU 114 is connected to the guide plate sensor 107 via the I/O interface 111 and inputs detection data D6 detected by the guide plate sensor 107.

After inputting the detection data D6 from this guide plate sensor 107, the CPU 114 outputs the control data D3 to control the approach motor 93 to the motor drive section 193. The motor drive section 193 generates a control signal S3 based on this control data D3 and outputs it to the approach motor 93. The approach motor 93 rotates based on this control signal S3 and causes the working plate 32′ screwed to the ball screw shaft 94 shown in FIG. 38 so that it is slidable to be slid and moved in the direction of the arrow Q2 via gears 93a and 94a, thereby moving the curl guide 30B from the home position HP thereof to the binding position P1 thereof.

After the working plate 32′ has been slid and moved, the CPU 114 outputs the control data D4 to control the binder feed motor 50i to the motor drive section 150i. The motor drive section 150i generates a control signal S4 based on this control data D4 and outputs it to the binder feed motor 50i. The binder feed motor 50i rotates the binder feed roller 50a shown in FIG. 38 based on this control signal S4, thereby pulling out the binder 13 from the bobbin 52′ and feeding it out to the transfer passage 50e.

After the binder 13 has been fed out to the transfer passage 50e, the CPU 114 outputs the control data D3 to control the approach motor 93 again to the motor drive section 193. The motor drive section 193 generates the control signal S3 based on this control data D3 and outputs it to the approach motor 93. The approach motor 93 rotates based on this control signal S3 and causes the working plate 32′ shown in FIG. 38 to be further slid and moved in the direction of the arrow Q2. The approach motor 93 uses the roller arm 101 mounted to the lower end of this working plate 32′ to push the rink roller 97 so that the cutter 62″ and the approach arms 60′ and 60″ are driven.

After the cutter 62″ and the approach arms 60′ and 60″ have been driven, the CPU 114 outputs control data D5 to control the torsion motor 70c to the motor drive section 170c. The motor drive section 170c generates a control signal S5 based on this control data D5 and outputs it to the torsion motor 70c. The torsion motor 70c rotates the torsion arm 70 shown in FIG. 38 based on this control signal S5.

After the torsion arm 70 has been rotated, the CPU 114 outputs the control data D3 to rotate the approach motor 93 reversely to the motor drive section 193. The motor drive section 193 generates the control signal S3 based on this control data D3 and outputs it to the approach motor 93. The approach motor 93 rotates reversely based on this control signal S3 and causes the working plate 32′ shown in FIG. 38 to be slid and moved in the direction of the arrow Q3 opposite to the above-described arrow Q2, thereby moving the curl guide 30B from the binding position P1 thereof back to the home position HP thereof.

After having moved the curl guide 30B back to the home position HP thereof, the CPU 114 outputs to the motor drive section 141b the control data D2 to rotate the tag feed motor 41b. In this example, the CPU 114 inputs the operation data D1 from the operation section 106 and, based on this operation data D1, determines a tag feed amount (number of rotations) of the tag feed motor 41b and then, based on a result of the determination, controls the tag feed amount by the tag feed motor 41b. For example, if inputting the operation data D1 indicating that the tag has a large entire length, the CPU 114 outputs to the motor drive section 141b the control data D2 to increase the tag feed amount. On the other hand, if inputting the operation data D1 indicating that the tag has a small entire length, the CPU 114 outputs to the motor drive section 141b the control data D2 to decrease the tag feed amount (for the ordinary tags 1D). The motor drive section 141b generates the control signal S2 based on this control data D2 and outputs it to the tag feed motor 41b. The tag feed motor 41b rotates based on this control signal S2 to rotate the tag feed roller 41a shown in FIG. 41A, thereby feeding out the lowest one of the tags 1Ds stored in the cartridge 40B.

In this example, in a case of the control data D2 indicating a long tag, based on a difference between control data D2 for the long tags and control data D2 for the ordinary tags 1D, control is conducted so that by rotating the tag feed roller 41a after the binder 13 has been transferred, the rear end of the information-showing portion of the long tag left in the cartridge 40B is fed out.

It should be noted that besides the method for controlling a tag feed amount by inputting the operation data D1 from the operation section 106, a method may be thought of for controlling the tag feed amount by detecting the entire length of the tag. For example, to a position where a portion that determines the entire length of the tag (tag that protrudes from the rear end of the cartridge 40B), a reflection-type tag entire length sensor 116 is mounted which functions as one example of detection means which detects the entire length of a tag which is transferred by the binder transfer mechanism 5A′. This tag entire length sensor 116 detects a portion which relates to the rear end of a long tag that has the entire length longer than that of the tag 1D. The CPU 114 inputs detection data D9 from this tag entire length sensor 116 and, based on this operation data D9, determines a tag feed amount (number of rotations) of the tag feed motor 41b and then, based on a result of the determination, controls the tag feed amount by the tag feed motor 41b.

In this example, if having detected the rear end of the long tag, the tag entire length sensor 116 outputs to the CPU 114 the detection data D9 indicating that the tag has a long entire length. If not having detected the rear end of the long tag, it outputs to the CPU 114 the detection data D9 indicating that the tag has a short entire length. If having input the detection data D9 indicating that the tag has the long entire length, the CPU 114 outputs to the motor drive section 141b the control data D2 to increase the tag feed amount (for long tags). On the other hand, if having input the detection data D9 indicating that the tag has the short entire length, the CPU 114 outputs to the motor drive section 141b the control data D2 to decrease the tag feed amount (for ordinary tags). The motor drive section 141b generates the control signal S2 based on this control data D2 and outputs it to the tag feed motor 41b. The tag feed motor 41b rotates based on this control signal S2 to rotate the tag feed roller 41a shown in FIG. 41A, thereby feeding out the lowest one of the tags 1Ds stored in the cartridge 40B.

In this example, in a case of the control data D2 indicating a long tag, based on a difference between control data D2 for the long tags and control data D2 for the ordinary tags 1D, control is conducted so that by rotating the tag feed roller 41a after the binder 13 has been transferred, the rear end of the information-showing portion of the long tag left in the cartridge 40B is fed out. It is thus possible to completely feed out the tag in accordance with the entire length of this tag.

After one of the tags 1D is fed out, the CPU 114 waits for the input of the bag detection data D7 detected by the bag sensor 108. Further, the CPU 114 waits also for the input of the operation data D1 from the operation section 106. In such a manner, the binding machine 2A′ is controlled by the control program saved in the EEPROM 113.

Next, a description will be given sequentially of a series of operations of a binding process with reference to FIGS. 64A and 64B. FIGS. 64A and 64B are flowcharts, which are indicated by dividing it into (parts 1 and 2), of an example of operations of the binding machine 2A′.

A state of the binding machine 2A′ is one where the front end of the binder 13 wound around the bobbin 52′ in the binding machine 2A′ is set to the position of the cutter 62″ shown in FIG. 37. Further, the tags 1D are stored in the cartridge 40B in a condition where they are stacked on one another, while the operation section 106 is switched to the tags 1D.

Under a condition that they are required in the binding process, at step ST1 shown in FIG. 64A, the CPU 114 determines whether the power supply for the binding machine 2A′ is turned ON. If the power supply for the binding machine 2A′ is turned ON, the CPU 114 reads the control program saved in the EEPROM 113 in the control section 110 shown in FIG. 63 and develops it in the RAM 112. If the power supply for the binding machine 2A′ is turned OFF, The CPU 114 waits until the power supply is turned ON. Subsequently, a process shifts to step ST2.

At the step ST2, the CPU 114 determines whether a tag has been transferred. For example, if inputting the transfer data D8 indicating that the tag 1D has not yet transferred from the tag sensor 109 shown in FIG. 63, the CPU 114 shifts to step ST3. On the other hand, if inputting the transfer data D8 indicating that the tag 1D has been transferred from the tag sensor 109, the CPU 114 shifts to step ST4.

At the step ST3, the CPU 114 conducts control so that the tag 1D is transferred. For example, the CPU 114 conducts control to rotate the tag feed roller 41a so that the lowest one of the tags 1D stored in the cartridge 40B may be fed out and then shifts to the step ST4.

At the step ST4, the CPU 114 determines whether or not the bag 14 is disposed to the binding opening 103 of the binding machine 2A′. For example, if the bag 14 is disposed by the user to the binding opening 103 shown in FIG. 37, the arm 121 shown in FIG. 62 is rotated, so that one end of this arm 121 is detected by the bag sensor 108. If inputting the bag detection data D7 from the bag sensor 108, the CPU 114 turns ON a main switch and shifts to step ST5. On the other hand, if inputting no bag detection data D7 from the bag sensor 108, the CPU 114 determines again whether or not the bag 14 is disposed.

At the step ST5, the CPU 114 determines whether or not the guide plate 95 is present at a home position. For example, if the bag 14 is disposed to the binding opening 103 by the user, the guide plate 95 shown in FIG. 37 is once pushed to be slid and moved. The CPU 114 determines whether or not the guide plate 95 once pushed has returned to an original position thereof. For example, the CPU 114 determines whether or not the guide plate 95 has returned to the original position thereof based on high level or low level in the detection data D6 which is output from the transmission-type guide plate sensor 107 mounted to the rear end portion of the guide plate 95.

In this example, if the guide plate sensor 107 is shielded from light, the CPU 114 inputs the low level of the detection data D6. On the other hand, if the guide plate sensor 107 is not shielded from light, the CPU 114 inputs the high level of the detection data D6.

Therefore, if the guide plate 95 is not returned to the original position thereof, that is, if the bag 14 sticks out of the guide plate 95 so that the guide plate 95 may be kept in the pushed-down state, the guide plate sensor 107 is shielded from light and so outputs the low level of the detection signal D6. In such a manner, if inputting no high level of the detection data D6 after having input the low level of the detection data D6, the CPU 114 determines that the bag 14 sticks out of the guide plate 95 and will not shift to the operations of the next step. In this case, if inputting no high level of the detection data D6 even after a period of time of, for example, seven through ten seconds elapses, the CPU 114 might as well give a warning to the user with a beep sound. If inputting the high level of the detection data D6, that is, if the guide plate 95 is returned to the original position thereof, the process shifts to step ST6.

At the step ST6, the CPU 114 determines which the ordinary tag 1D or the long tag has been set by the operation section 106. For example, if inputting the operation data D1 indicating the ordinary tag 1D from the operation section 106, the CPU 114 shifts to step ST7.

At the step ST7, the CPU 114 causes the curl guide 30B to be moved. For example, the CPU 114 causes the approach motor 93 to rotate so that the working plate 32′ shown in FIG. 38 is slid and moved in the direction of the arrow Q2, thereby moving the curl guide 30B from the home position HP to the binding position P1 and shifting to step ST8.

At the step ST8, the CPU 114 causes the binder 13 to be transferred. For example, the CPU 114 causes the binder feed motor 50i to rotate so that the binder 13 is pulled out of the bobbin 52′ and fed to the transfer passage 50e, thereby shifting to step ST9.

At the step ST9, the CPU 114 conducts control so that the binder 13 is cut off and the front and rear ends of the binder 13′ cut off from this binder 13 are approached to be faced to each other. For example, the CPU 114 causes the approach motor 93 again to rotate so that the working plate 32′ shown in FIG. 38 is further slid and moved in the direction of the arrow Q2. By the roller arm 101 mounted to the lower end of this working plate 32′, the link roller 97 is pushed and the cutter 62″ and the approach arms 60′ and 60″ which are linked to this link roller 97 are driven. The binder 13 is cut off by the cutter 62″ and the approach arms 60′ and 60″ are brought close to each other so that the front and rear ends of the binder 13′ cut off from this binder 13 may face each other, thereby shifting to step ST10 shown in FIG. 64B.

At the step ST10, the CPU 114 conducts control so that the binder 13 is twisted. For example, the CPU 114 causes the torsion motor 70c to rotate and the torsion arm 70 shown in FIG. 38 to rotate, thereby twisting the binder 13′ whose front and rear ends are held by this torsion arm 70. It should be noted that in this case, the guide plate 95 is locked by a cam plate, not shown, fitted to the torsion arm 70. This is because, if the guide plate 95 retreats, it pushes the tag 1D so that this tag 1D may be deformed or a bound product may not easily be drawn out. Subsequently, the process shifts to step ST11.

At the step ST11, the CPU 114 conducts control so that the curl guide 30B, the approach arms, and the cutter 62″ are returned to the original positions thereof. For example, the CPU 114 rotates the approach motor 93 reversely so that the working plate 32′ shown in FIG. 38 is slid and moved in the direction of the arrow Q3 opposite to the above-described arrow Q2, thereby returning the curl guide 30B from the binding position P1 thereof to the home position HP thereof. In this case, the roller arm 101 and the link roller 97 mounted to the lower end of the working plate 32′ are released from the mutual abutting condition. A tension spring 122 constantly urging the link roller 97 toward a side of the catching shaft 97′ is stretched over between the link roller 97 and the catching shaft 97′. If the roller arm 101 and the link roller 97 are released from the mutual abutting condition, the link roller 97 moves in the direction of the arrow Q3. Owing to the movement of the link roller 97 in the Q3 direction, the cutter 62″ link-connected to this link roller 97 retreats from the transfer passage 50e for the binder 13.

Simultaneously with the retreating processing of this cutter 62″, the left-side and right-side approach arms 60″ and 60′ engaging with the link roller 97 return to the original positions thereof, thereby constituting part of the transfer passage 50e again, and shifting to step ST12.

At the step ST12, the CPU 114 determines whether or not the bag 14 has been pulled out. For example, the bag sensor 108 detects whether or not the arm 121 rotated forwardly due to abutment of the bag 14 at the above-described step ST4 is rotated reversely and returned to the original position by a fact that the bag 14 has been pulled out. If inputting from this bag sensor 108 the bag detection data D7 indicating that the arm 121 is returned to the original position, the CPU 114 turns OFF the main switch 120 and shifts to step ST13. On the other hand, if inputting from the bag sensor 108 the bag detection data D7 indicating that the arm. 121 is not returned to the original position, the CPU 114 determines again whether or not the bag 14 has been pulled out.

At the step ST13, the CPU 114 conducts control so as to release the guide plate 95 locked at the step ST10 from the locked state thereof. For example, the CPU 114 causes the torsion motor 70c to make a half-turn and the torsion arm 70 shown in FIG. 40 to make a half-turn so that the guide plate 95 locked by the cam plate, not shown, fitted to the torsion arm 70 is released, thereby shifting to step ST14.

At the step ST14, the CPU 114 conducts control so as to transfer the tags 1D. For example, the CPU 114 causes the tag feed roller 41a to rotate so that the lowest one of the tags 1D stored in the cartridge 40B is fed out and then the process shifts to step ST15.

At the step ST15, the CPU 114 determines whether or not the power supply has been turned OFF. If the power supply is not turned OFF, the process returns to the step ST2. If the power supply is turned OFF, it ends the binding processing.

It should be noted that if the CPU 114 inputs the operation data D1 indicating a long tag from the operation section 106 at step ST6, the process shifts to step ST16. At the step ST16, the CPU 114 moves the curl guide 30B and also feeds out the long tag. For example, the CPU 114 causes the approach motor 93 to rotate so that the working plate 32′ shown in FIG. 38 is slid and moved in the direction of the arrow Q2, thereby moving the curl guide 30B from the home position HP thereof to the binding position P1 thereof. In this case, simultaneously with the progressing of the curl guide 30B, the CPU 114 conducts control so that the tag feed roller 41a shown in FIG. 43B rotates and the rear end of the information-showing portion of the long tag left in the cartridge 40B is fed out, thereby shifting to step ST17.

At the step ST17, the CPU 114 causes the binder 13 to be transferred. For example, the CPU 114 causes the binder feed motor 50i to rotate so that the binder 13 is pulled out of the bobbin 52′ and fed out to the transfer passage 50e, thereby shifting to step ST18.

At the step ST18, the CPU 114 conducts control so that the binder 13 is cut off, the front and rear ends of the binder 13′ cut off from this binder 13 are brought close to each other to face each other and the tag 1D is further fed out. For example, the CPU 114 causes the approach motor 93 again to rotate so that the working plate 32′ shown in FIG. 38 is further slid and moved in the direction of the arrow Q2. By the roller arm 101 mounted to the lower end of this working plate 32′, the link roller 97 is pushed and the cutter 62″ and the approach arms 60′ and 60″ which are linked to this link roller 97 are driven. The control is conducted so that by the cutter 62″, the binder 13 is cut off and by the approach arms 60′ and 60″, the front and rear ends of the binder 13′ cut off from this binder 13 are brought close to each other to face each other. In this case, the CPU 114 causes the working plate 32′ to further be slid and moved in the direction of the arrow Q2 and, at the same time, causes the tag feed roller 41a again to rotate so that the rear end of the information-showing portion 10C of the long tag that is left in the cartridge 40B is completely fed out and then, the process shifts to the above-described step ST10 where the binder 13′ is twisted and bound.

Thus, according to the binding machine 2A′ relating to the present invention, in a case of attaching the tag 1D having the catching holes 11p to the bag 14 with the binder 13 passing through the catching holes 11p of the tag 1D, the cartridge 40B storing the tags 1D in a condition where they are stacked on one another contains the tag position restriction portion 40d having a predetermined shape that restricts the delivery-directional front and rear positions of a plurality of the tags 1D and the tag position adjustment portion 40c that adjusts the right and left positions of the plurality of tags 1D whose front and rear positions have been restricted. By the tag width adjustment mechanism 40n of this tag position adjustment portion 40c, the position of the tag width adjustment plate 40i is adjusted, thereby aligning the right and left positions of the tags 1D.

Therefore, when storing a plurality of tags 1D by adjusting the right and left positions of the tags 1D whose front and rear positions have been restricted, only the right and left positions thereof need to be adjusted, thus easily storing the tags 1D in a condition where they are aligned. Moreover, since the front and rear positions of the tags 1D are restricted already, the tags 1D can be prevented from slipping down even if the cartridge 40B is inclined.

Further, by this binding machine 2A′, the curl guide 30B which moves in a condition where the tags 1D are held on it drives the two working pins 42b on the tag feed guide 42 which guides the tag 1D. The left-side working pin 42b opens and closes the left-side guide flap 42a around the swing shaft 42d and the right-side working pin 42b opens and closes the right-side guide flap 42a around the swing shaft 42d.

Therefore, when the curl guide 30B is moved in a condition where the guided tag 1D is held on it, the right-side and left side guide flaps 42a of the tag feed guide 42 can be opened from each other, and when the guide 30B is returned in a condition where the tag 1D is released from it, the right-side and left side guide flaps 42a can be closed to each other. Accordingly, the guide flaps 42a do not interfere with the tag 1D when it moves, so that the tag 1D can move smoothly. Moreover, since the curl guide 30B can move only linearly, the curl guide 30B need not accompany waste motion, thus improving the processing efficiency of this binding machine 2A′.

Further, by this binding machine 2A′, the bobbin 52′ is mounted on the horizontally established installation table 90 in such a manner that the rod-shaped core 52a of this bobbin 52′ may be substantially perpendicular.

Therefore, when the binder 13 is pulled out of the bobbin 52′ and this bobbin 52′ rotates, friction occurs between the installation face 90b of the installation table 90 and a rib 52e of the bobbin 52′ coming in contact with this installation face 90b. This applies a brake on the bobbin 52′, thus enabling preventing the bobbin 52′ from rotating in excess of a pull-out amount of the binder 13. It is thus possible to achieve a brake application mechanism with a simple configuration at the time of pulling out the binder 13.

Further, the core 52a around which the binder 13 is wound has been set perpendicularly to the installation table 90, so that if the binder 13 is made of a covered iron core etc., in the step of pulling this binder 13 and then binding it, the binder 13 can be bound to the bag 14 in a condition where the posture of this binder 13 is kept as pulled out. This prevents the covered binder 13 from being twisted so as to ease the movements of this binder 13 in the machine so that it can be bound with a good reproducibility, thereby improving the performance of this binding machine 2A′.

Further, by the binding machine 2A′, the CPU 114 inputs the operation data D1 from the operation section 106 which is used to set a feed amount for the tag 1D or the long tag and determines the tag feed amount by the tag transfer mechanism 4A′ based on this operation data D1 and then, based on a result of the determination, controls the tag feed amount.

Further, by the binding machine 2A′, the CPU 114 inputs the detection data D9 from the tag entire length sensor 116 which detects the rear end of the tag and, based on this operation data D9, determines a tag feed amount by the tag transfer mechanism 4A′ and then, based on a result of the determination, controls the tag feed amount.

Therefore, the tag can be fed out completely in accordance with the entire length of the tag. It is thus possible to handle any tags having different entire lengths.

Further, the concave portions 12n of the tag 1C are formed so that the total sum of an angle θ1 between the side 10Ca of the concave portion 12n on the side of the information-showing portion 10C and the side 12Ca of the concave portion 12n on the side of the coupling portion 12C and an angle θ2 between the side 11Ae of the concave portion 12n on the side of the mounting portion 11D and the side 12Ca of the concave portion 12n on the side of the coupling portion 12C is greater than 180 degrees.

Accordingly, when feeding out one of the tags 1D stacked in the cartridge 40B by the tag feed portion 41′ and if the side 10Ca of the concave portion 12n of the tag 1D and the side 11Ae or 11Ad intersect and come in sliding contact with each other, the sides 10Ca and 11Ae or 11Ad may slide obliquely without engaging with each other.

Further, by the tag 1H etc. of the present invention, the positioning thereof is carried out by the cooperation of the tag latching claw portions 300c of the curl guide 30C and the engagement portions 12q of this tag 1H, so that the mounting of the tags by use of the binder 13 can be mechanized highly precisely.

Next, a description will be given of a configuration example of a tag spring support mechanism 125 of a binding machine 200 according to a second embodiment with reference to FIG. 65.

At the binding machine 200 shown in FIG. 65, the tag spring support mechanism 125 is provided. The tag spring support mechanism 125 is provided with a pair of torsion spring members 21 and 22 which constitute one example of a bracing member. This tag spring support mechanism 125 operates to brace both side ends of the tag 1D from both sides which is being transferred from a tag transfer mechanism 4A′ via a tag hold mechanism 3A′ to a binder formation mechanism 6A which is adjacent to a binder-fastening mechanism 7A′.

In this example, a tag support member 30e mounted to a predetermined site extending from the upper part of the tag hold mechanism 3A′ to a binder passage 303 holds the upper end of the tag 1D and also the torsion spring members 21 and 22 brace both side ends of the tag 1D from both sides. The torsion spring members 21 and 22 used are constituted of a spring member such as a SUS wire, a copper wire, a high-carbon steel wire, or a piano wire that is twisted into a coil shape.

For example, the torsion spring member 21 is mounted on an intermediate chassis portion 92a on the front side of the working plate 32′. The torsion spring member 21 has a hollow spiral coil portion 21a and two spring leg portions (hereinafter referred to as a movable leg portion 21b and a fixed leg portion 21c) that extend in different directions, forming predetermined opened angles with respect to this spiral coil portion 21a.

The spiral coil portion 21a is axially supported by the intermediate chassis 92a. For example, it is axially supported rotatably to a shat portion 911 erected on the intermediate chassis portion 92a. The one movable leg portion 21b has its leading end curled into a circle shape to ease its abutment against the tag 1D when it abuts against the tag 1D at a position where its one side end is held. The other fixed leg portion 21c is fixed to a formation mechanism mounting board 92i above the intermediate chassis 92a. For example, an end of the board 92i is folded to form a protrusion 912 so that it may be fixed inside this protrusion 912.

Further, the torsion spring member 22 is mounted on the intermediate chassis portion 92a on the tag transfer mechanism 4A′ sandwiching the tag hold mechanism 3A′. The torsion spring member 22 also has a hollow spiral coil portion 22a and two spring leg portions (hereinafter referred to as a movable leg portion 22b and a fixed leg portion 22c) that extend in different directions, forming predetermined opened angles with respect to this spiral coil portion 22a.

The spiral coil portion 22a is axially supported by the intermediate chassis 92a on the tag transfer mechanism 4A′. For example, it is axially supported rotatably to a shat portion 913 erected between the two intermediate chassis portion 92a and 92′. The one movable leg portion 22b has its leading end curled into a circle shape to ease its abutment against the tag 1D when it abuts against the tag 1D at a position where the other side end thereof is held. The other fixed leg portion 22c is fixed to an engagement pin 914 erected between the intermediate chassis portion 92a and 92a′. As the engagement pin 914, for example, a space reserving convex pin (dowel) erected between the intermediate chassis portion 92a and 92a′ may be used. The fixed leg portion 22c may be, for example, fixed in a condition where it might be wound around the engagement pin 914. Thus, the tag spring support mechanism 125 is constituted.

A description will be given of a function example of the tag spring support mechanism 125 of the binding machine 200 with reference to FIGS. 66A to 67B.

According to the standby state of the tag spring support mechanism 125 shown in FIG. 66A, a gap is given among the movable leg portion 21b of the torsion spring member 21, the movable leg portion 22b of the torsion spring member 22 and a curving guide protrusion 30a′ of the curl guide 30B. This facilitates the attachment of the leading end of a tag to the tag latching claw portions 30b, 30b or the tag support member 30e when mounting the tag. When the tag hold mechanism 3A′ and the tag spring support mechanism 125 are in the standby state, the tag hold mechanism 4A′ is operated so as to pull out the tag 1D from a cartridge 40B and hold it at the tag latching claw portions 30b, 30b of the curl guide 30B.

Here, assuming an angle between the movable leg portion 21b and the fixed leg portion 21c to be an opened angle θ4, the opened angle is, for example, about 90 degrees (θ4=90 degrees). Also, assuming an angle between the movable leg portion 22b and the fixed leg portion 22c to be an opened angle θ5, the opened angle is, for example, about 230 degrees (θ5=230 degrees). These opened angles θ4 and θ5 maintain the postures of the torsion spring members 21 and 22 in the standby state thereof.

By the tag spring support mechanism 125 shown in FIG. 66B, if the tag hold mechanism 3A′ progresses toward the binder formation mechanism 6A′ from the standby state shown in FIG. 66A, the leading ends of the curl guide 30B abuts against the leading ends of the torsion spring members 21 and 22. At this point of time, the torsion spring members 21 and 22 are still kept in the standby state postures.

According to a deformation operation example of the tag spring support mechanism 125 shown in FIG. 67A, if the tag hold mechanism 3A′ further progresses to the binder formation mechanism 6A′ from the state shown in FIG. 66B in which the leading end of the curl guide 30B is abutting against the tag spring support mechanism 125, the leading end of the curl guide 30B gets over the urging force of the torsion spring members 21 and 22, thus getting close toward the binder formation mechanism 6A′ in a condition where the leading end hereof is kept to be abutting against the mechanism.

At this point of time, the opened angle θ4 of the torsion spring member 21 and the opened angle θ5 of the torsion spring member 22 alter. In this example, the opened angle θ4 of the torsion spring member 21 pushed by the curl guide 30B changes from an initial angle θ4=90 degrees to θ4=70 degrees. Also, similarly, the opened angle θ5 of the torsion spring member 22 changes from an initial angle θ5=230 degrees to θ5=195 degrees (initial phase deformation).

As this tag hold mechanism 3A′ moves, the leading ends of this curl guide 30B come to abut against the leading ends of the torsion spring members 21 and 22 via the tag 1D. That is, the tag 1D is sandwiched between the torsion spring members 21 and 22 and the curl guide 30B, thus enabling preventing the tag 1D from dropping. Then, the tag 1D is moved to a mounting space portion 92b in this state (see FIG. 65).

According to a deformation operation example of the tag spring support mechanism 125 shown in FIG. 67B, the operation is further continued so that the tag hold mechanism 3A′ progresses to reach the binder formation mechanism 6A′. In this state, the tag spring support mechanism 125 is deformed which is caused to abut against the leading ends of the curl guide 30B shown in FIG. 67A. In this case, the curl guide 30B stops in front of the binder formation mechanism 6A′ with the leading end thereof getting over the additional urging force of the torsion spring members 21 and 22 in a condition where its leading end is abutting against the mechanism. At this point of time, the transfer of the tag 1D to the mounting space portion 92b is completed.

It should be noted that at this arrival point of time, the opened angle θ4 of the torsion spring member 21 is further changed from the opened angle θ4 of the torsion spring member 21 shown in FIG. 67A. Similarly, the opened angle θ5 of the torsion spring member 22 at the arrival point of time is further changed from the opened angle θ5 of the torsion spring member 22.

In this example, the opened angle θ4 of the torsion spring member 21 pushed by the curl guide 30B is changed from the initial angle θ4=90 degrees to θ4=20 degrees. Also, similarly, the opened angle θ5 of the torsion spring member 22 is changed from the initial angle θ5=230 degrees to θ5=150 degrees (later phase deformation).

It should be noted that although the description has performed using the binder 13, the present invention is not limited to the binder 13 obtained by covering a core wire member, such as an ordinary wire with a tape-shaped covering material; the present invention may be applied also to the case of using as the binder 13 a covered wire whose cross section is substantially circular. Further, it can be applied also to the case of using as the binder 13 an uncovered wire, a covered wire having a resin-made core, a linear or tape-shaped member made of a resin only, etc.

### INDUSTRIAL APPLICABILITY

The present invention is applied to a tag which is attached to a bag containing confections or vegetables and on which advertising sentences and information, such as producers and cooking recipes are written. Further, it can be applied also to a tag which is attached to stacked wires and on which wiring information etc. are written as well as to an identification tag used in an agricultural field such as young tree growing.

1. A tag characterized in that the tag comprises:
an information-showing portion on which information is written;
a mounting portion that has at two positions catching portions which catch a linear binder which is fasted by being wound around a mounted target and that is bound to the mounted target together with the binder by fastening the binder passed through the catching portions at the two positions to the mounted target; and
a coupling portion that is made by forming a concave portion by notching part of a side of the information-showing portion and that integrally couples the mounting portion and the information-showing portion to each other through its width smaller than that of the information-showing portion.

2. The tag according to claim 1, characterized in that the catching portions are formed as holes that penetrate the mounting portion.

3. The tag according to claim 1, characterized in that the catching portions are formed as groove portions which are opened partially.

4. The tag according to claim 1, characterized in that the tag is formed in such a manner that a total sum of an angle between a side of the concave portion on a side of the information-showing portion and a side of the concave portion on a side of the coupling portion and an angle between a side of the concave portion on a side of the mounting portion and a side of the concave portion on a side of the coupling portion is greater than 180 degrees.

5. The tag according to claim 1, characterized in that each of the catching portions at the two positions has a shape of a long hole that extends in a direction in which the mounting portion extends.

6. The tag according to claim 1, characterized in that the tag is used in a binding machine comprising:
tag guide means that has a claw portion into which the concave portion is fitted and also that has a binder passage which interconnects the catching portions at the two positions positioned by fitting the concave portion into the claw portion and through which the binder passes;
binder-transferring means that causes the binder to pass through the catching portions at the two positions positioned by the tag guide means;
binder-forming means that forms the binder passed through the catching portions at the two positions; and
binder-fastening means that fastens the binder formed by being passed through the catching portions at the two positions by twisting it.

7. The tag according to claim 1, characterized in that the tag is formed in such a manner that of an angle between the side of the concave portion on the side of the information-showing portion and a side of the concave portion on a side of the coupling portion and an angle between a side of the concave portion on a side of the mounting portion and the side of the concave portion on the side of the coupling portion, an angle on a side positioned at a rear side along a tag feeding direction has an obtuse angle.

8. A method for manufacturing a tag characterized in that the method comprises the steps of:
forming a mold for a tag comprising an information-showing portion on which information is written, a mounting portion that is coupled to the information-showing portion, that has at two positions catching portions each having a slit which catch a linear binder which is fasted by being wound around a mounted target, and that is bound to the mounted target together with the binder by fastening the binder passed through the catching portions at the two positions to the mounted target; and
punching out the tag from an original fabric sheet which provides a material for the tag, by using the formed mold for the tag.

9. A tag characterized in that the tag comprises:
an information-showing portion on which information is written;
a mounting portion that has at two positions catching portions which catch a linear binder which is fasted by being wound around a mounted target and that is bound to the mounted target together with the binder by fastening the binder passed through the catching portions at the two positions to the mounted target;
a coupling portion that integrally couples the mounting portion and the information-showing portion to each other; and
an engagement portion that engages with tag guide means of a binding machine which contains a claw portion as well as a binder passage through which the binder passes, the engagement portion performing positioning in cooperation with the claw portion, the binder passage interconnecting between the catching portions at the two positions, and which twists and fastens the binder formed by passing it through the catching portions at the two positions.

10. The tag according to claim 9, characterized in that the catching portions are formed as holes that penetrate the mounting portion.

11. The tag according to claim 9, characterized in that each of the catching portions at the two positions has a shape of a long hole that extends in a direction in which the mounting portion extends and a portion that the catching portions face each other has a perpendicular portion formed substantially perpendicularly with respect to the direction in which the mounting portion extends.

12. The tag according to claim 9, characterized in that assuming that a longitudinal direction of the tag is a vertical direction and a lateral direction of the tag is a horizontal direction,
the mounting portion has a horizontal width that is formed so as to be greater than the horizontal width of the information-showing portion, thereby bring both of horizontal ends thereof sticking out of both of the horizontal ends of the information-showing portion; and
as the engagement portion, both of the horizontal ends of the mounting portion are used.

13. The tag according to claim 9, characterized in that assuming that a longitudinal direction of the tag is a vertical direction and a lateral direction of the tag is a horizontal direction,
the coupling portion has a horizontal width that is formed so as to be greater than the horizontal width of the information-showing portion, thereby bring both of horizontal ends thereof sticking out of both of the horizontal ends of the information-showing portion, respectively; and
as the engagement portion, both of the horizontal ends of the coupling portion are used.

14. The tag according to claim 9, characterized in that the engagement portion is formed by opening a predetermined portion of a body of the tag.

15. The tag according to claim 9, characterized in that the tag further comprises a protrusion for positioning that is fitted into a concave portion formed in a tag storage member which stores the tags.

16. The tag according to claim 9, characterized in that the tag is used in a binding machine comprising:
binder-transferring means that causes the binder to pass through the catching portions at the two positions positioned by the tag guide means;
binder-forming means that forms the binder passed through the catching portions at the two positions; and
binder-fastening means that fastens the binder formed by being passed through the catching portions at the two positions by twisting it.
